(19) United States
(12) Patent Application Publication
(10) Pub. No.: US 2004/0038142 A1
(43) Pub. Date: Feb. 26, 2004

(54) Developer, and image forming method and process cartridge using such developer

(76) Inventors: Satoshi Yoshida, Tokyo (JP); Hirohide Tanikawa, Shizuoka (JP)

Correspondence Address: FITZPATRICK CELLA HARPER & SCINTO, 30 ROCKEFELLER PLAZA, NEW YORK, NY, 10112, US

(21) Appl. No.: 10/158,519

(22) Filed: May 30, 2002

(51) Int. Cl. G03G 9/097

(52) U.S. Cl. 430/108.6; 430/110.4; 430/108.1; 430/111.41; 430/108.3; 430/108.7; 430/126; 399/252; 430/122

(57) ABSTRACT

A developer comprising toner particles containing at least a binder resin and a colorant, an inorganic fine powder whose primary particles have a number-average particle diameter of from 4 nm to 50 nm, and a conductive fine powder whose primary particles have a number-average particle diameter of from 50 nm to 500 nm. The conductive fine powder contains an agglomerated matter of the primary particles. The developer comprises 15% to 60% by number of particles having particle diameters in the range of from 1.00 μm, inclusive, to 2.00 μm, exclusive, and 15% to 70% by number of particles having particle diameters in the range of from 3.00 μm, inclusive, to 8.96 μm, exclusive, in number-based particle size distribution of particles having particle diameters in the range of from 0.60 μm, inclusive, to 159.21 μm, exclusive. Also, an image forming method and a process cartridge are disclosed which make use of the developer.

### BACKGROUND OF THE INVENTION

1. Field of the Invention

The present invention relates to a developer for various recording apparatuses and machines, such as those based on electrophotography, electrostatic recording, and electrostatic recording, and an image forming method using such a developer.

In addition, the present invention relates to a process cartridge that can be loaded into and unloaded from image forming apparatuses such as copiers, printers, facsimiles and plotters, in which a toner image is formed on an image-bearing member and the toner image is transferred onto a recording medium to form a final image.

2. Related Background Art

Conventionally, a number of image forming techniques are known, such as electrophotographic techniques, electrostatic recording techniques, electrostatic recording techniques and toner jet techniques. For example, an electrophotographic technique generally uses a photosensitive member with a photoconductive material as a latent image-bearing member on which an electrical latent image is formed by various methods. The latent image is developed with a toner into a visible image. A toner-based image is transferred onto a recording medium (transfer material) such as paper, when required. Thereafter, a toner image is fixed on the recording medium by means of applying heat or pressure to obtain an image.

Various methods are known that form a visible image with a toner. For example, known methods to visualize an electrical latent image include cascade development, pressure development, and magnetic brush development that uses a two-component developer formed of a carrier and a toner. Other examples include non-contact one-component development in which the toner is made to fly from a toner-carrying member to a latent image-bearing member without any contact between the toner-carrying member and the latent image-bearing member; magnetic one-component development method that uses a magnetic toner, which is made to fly by an electric field in a space between a photosensitive member and a rotating sleeve with a magnetic pole at the center thereof; and contact one-component development that causes the toner to move by an electric field with the toner-carrying member in contact with the latent image-bearing member.

Furthermore, as the developers that are used to produce latent images, two-component developers and one-component developers are known. A two-component developer is formed of a carrier and a toner while a one-component developer does not require any carrier (magnetic toner, non-magnetic toner). With the two-component developer, the toner is typically charged electrostatically through friction between the carrier and the toner. On the other hand, with the one-component developer, the toner is typically charged electrostatically through friction with a charge-imparting member.

As to the toner, regardless of whether it is a two-component or one-component toner, it is proposed to add an inorganic fine powder as an externally-added additive to toner particles for the purpose of improving various properties of the toner such as flow properties and charging properties. This approach has widely been used.

Japanese Patent Application Laid-Open Nos. 5-66608, and 4-9860 disclose a process in which an inorganic fine powder having been treated with a hydrophobizing agent is added or an inorganic fine powder having been treated with a hydrophobizing agent and with, for example, silicone oil is added. Alternatively, Japanese Patent Application Laid-Open Nos. 61-249059, 4-264453, and 5-346682 disclose a process in which an inorganic fine powder having been treated with a hydrophobizing agent is added along with an inorganic fine powder having been treated with silicone oil.

A number of methods and approaches have been proposed to add a conductive fine powder as an externally-added additive to a developer. For example, it has widely been known that carbon black is deposited or fixed onto the surface of toner as the conductive fine powder for the purpose of giving conductivity to the toner or controlling excessive charging of the toner to provide uniform triboelectrical charge distribution. In addition, Japanese Patent Application Laid-Open Nos. 57-151952, 59-168458, and 60-69660 disclose external addition of tin oxide, zinc oxide, and titanium oxide, respectively, to a magnetic toner with high resistivity. Furthermore, Japanese Patent Application Laid-Open No. 56-142540 proposes a developer that provides both developabilities and transferabilities by means of adding conductive magnetic particles such as iron oxide, iron powder and ferrite to a magnetic toner with high resistivity, thereby causing conductive magnetic particles to enhance induction of charge on the magnetic toner. Moreover, Japanese Patent Application Laid-Open No. 61-275864, Japanese Patent Application Laid-Open No. 62-258472 (corresponding to U.S. Patent No. 4,804,609), and Japanese Patent Application Laid-Open Nos. 61-141452 and 02-120865 disclose addition of graphite, magnetite, polypyrrole conductive particles and polyaniline conductive particles to the toner. Besides the above, it has been known to add a diversity of a conductive fine powder to the toner.

It has been proposed to externally add conductive particles with a specified average particle diameter. For example, Japanese Patent Application Laid-Open No. 4-124678 proposes a toner to which zinc oxide fine particles are added, the zinc oxide having a volume-resistivity of 10⁰ to 10⁸ Ω·cm and an average primary particle diameter of 0.1 to 0.5 μm. However, there is no disclosure about a possible configuration or formation of the zinc oxide fine particles. The specification describes the necessity for the zinc oxide fine particles to effectively surround the toner. Japanese Patent Application Laid-Open No. 9-146293 proposes a toner in which fine powder A having an average particle diameter 5 to 50 nm and fine powder B having an average particle diameter 0.1 to 3 μm are used as externally-added additives, which are firmly deposited more strongly than specified on toner main particles of 4 to 12 μm. However, there is no disclosure about a possible configuration or formation of the fine powder B. It aims to reduce the amount of the fine powder B that is separated from the toner main particles, though the powder particles escape at any rate. Japanese Patent Application Laid-Open No. 11-95479 proposes a toner comprising conductive silica particles with a specified particle diameter and an hydrophobic inorganic oxide. However, silica fine powder, the particles of which are covered with a mixture of tin oxide and antimony is the only example of the conductive silica particles given therein. This toner is intended to leak the electric charges accumulated excessively in the toner to outside through the use of the conductive silica particles.

Furthermore, various proposals have been made that specify particle size distribution and the shape of a toner. In recent years, some proposals specify particle size distribution and circularity measured using a flow particle image analyzer, as disclosed in Japanese Patent No. 2862827. Other proposals specify particle size distribution and the shape of a toner while taking any influence of external additives into consideration. For example, Japanese Patent Application Laid-Open No. 11-174731 proposes a toner comprising inorganic fine powder A and a non-spherical inorganic fine powder B. The inorganic fine powder A exists on the toner in the state of primary or secondary particles with a specified circularity and has an average major axis length of 10 to 400 nm. The non-spherical inorganic fine powder B is formed after aggregation of a plurality of particles. In the disclosure, the resistivity of the non-spherical inorganic fine powder B is not taken into consideration. Instead, it is intended to control immersion of the inorganic fine powder A into a toner body through a spacer effect achieved by the non-spherical inorganic fine powder B. Japanese Patent Application Laid-Open No. 11-202557 also specifies particle size distribution and circularity but nothing is mentioned about a possible form of external additive particles. It is intended to control tailing by means of increasing the density of the toner particles that have been developed as a toner image and to improve storage stability of the toner in a high temperature and high humidity environment.

Japanese Patent Application Laid-Open No. 11-194530 proposes a toner with a specified particle size distribution that comprises external additive fine particles A of 0.6 to 4 μm and an inorganic fine powder B. There is no disclosure about a possible form of the fine particles. It is intended to prevent any deterioration of the toner by embedding the inorganic fine powder B into the toner main particles through the intervention of the external additive fine particles A. The resistivity of the external additive fine particles A is not taken into consideration. Japanese Patent Application Laid-Open No. 10-83096 proposes a toner in which conductive fine particles and silica fine particles are added to the surface of spherical resin fine particles encapsulating colorant. There is a list of the conductive fine particles in the specification but nothing is mentioned about a possible form of the listed conductive fine particles. It is directed, by adding the above-mentioned particles, to charge the surface of the toner particles as well as to speed up transportation and exchange of the charges between the toner particles, thereby to improve charge uniformity.

Various methods are known to form a latent image on an image-bearing member such as an electrophotographic photosensitive member and an electrostatic recording dielectric material. For example, typical electrophotographic approach involves uniformly charging the surface of a photosensitive member using a photoconductive material as a latent image-bearing member to have desired polarity and potential and then exposing an image pattern on the photosensitive member to form an electrical latent image.

Conventionally, non-contact corona chargers (corona dischargers) are often used as a charging device for uniformly charging (including charge removal) a latent image-baring member to have desired polarity and potential.

In recent years, many contact charging devices have been proposed and commercialized as a charging device for a charged member such as a latent image-bearing member. Contact charging devices generate a smaller quantity of ozone and consume lower power than corona chargers.

A contact charging device comprises a conductive charging member (also referred to as a contact charging member or a contact charger) in the form of a roller (charge roller), a fur brush, a magnetic brush or a blade. The conductive charging member is brought into contact with a member to be charged (hereinafter called often “charged member”) such as an image-bearing member and a predetermined charge bias is applied to the contact charging member to charge the surface of the charged member electrostatically to have a predetermined polarity and potential.

A mechanism (principle) of charging during the contact charging may be classified two types: a discharge-charging mechanism and a direct injection charging mechanism. Characteristics and properties are determined depending on which one is predominant.

(1) Discharge-Charging Mechanism

This is to charge the surface of a charged member electrostatically by means of discharge in a small gap between a contact charging member and the charged member.

With this discharge-charging mechanism, it is necessary to apply a voltage of at least certain threshold level (higher than a charge potential) to the contact charging member for direct charging to start, because it depends on discharge from the contact charging member to the charged member. In addition, the principle inevitably results in production of certain discharge products, though the amount is significantly smaller as compared with the case of a corona charger. Adverse effects due to active ions such as ozone are unavoidable accordingly.

(2) Direct Injection Charging Mechanism

This is to charge the surface of a charged member electrostatically by means of direct injection of charges from a contact charging member to the charged member. This mechanism is also referred to as direct charging, injection charging or charge-injection charging.

More specifically, the contact charging member of a medium resistivity is brought into contact with the surface of the charged member to directly inject charges to the charged member without discharge. Accordingly, the charged member can be charged electrostatically to a potential corresponding to an applied voltage even when the applied voltage to the contact charging member is not higher than a discharge threshold level. This charge mechanism does not involve production of ions and results in no adverse effect which otherwise would occurs. However, charging properties are significantly varied depending on contact properties of the contact charging member with the charged member because of reliance on the direct injection charging. Thus, the contact charging member is required to have more densified contact points and a larger moving speed relative to the charged member in order to increase the chance or frequency of the contact charging member to contact the charged member.

Of the contact charging devices, the roller charging method that uses a conductive roller (charge roller) as the contact charging member, is more preferable for charging stability and is thus widely used.

In the conventional charge mechanisms based on the roller charging, the discharge-charging mechanism indicated as (1) is used more frequently.

A charge roller is formed of a conductive or medium resistivity rubber or foam material, which may optionally be laminated to provide desired characteristics.

Such a charge roller has elasticity to ensure a certain level of contact with a charged member. This causes a large frictional resistance. In many cases, the charge roller moves following the movement of the charged member or moved with a small speed difference. This means that an attempt of direct injection charging inevitably results in lowering of absolute charging performance, contact irregularities due to insufficient contact or a shape of a roller, and uneven charging due to attachments or extraneous matters to the charged member.

FIG. 3 is a graphical representation of charging efficiencies during contact charging in an electrophotographic technique. The abscissa represents a bias that was applied to the contact charging member and the ordinate represents a charge potential of the charged member (hereinafter, referred to as a photosensitive member) obtained at that time. The line A shows a charging property obtained during the roller charging. The photosensitive member starts to increase in surface potential when a voltage exceeds a discharge threshold value of about −500 V. The surface potential of the photosensitive member increases linearly with the voltage at an inclination of unity thereafter. This threshold voltage is hereinafter referred to as a charge-starting voltage Vth. Therefore, in order to make the surface of the photosensitive member have a charge potential of −500 V, a DC voltage of −1000 V is applied or a DC voltage of −500 V is applied in superposition of an AC voltage at a peak-to-peak voltage of, e.g., 1200 V, so as to keep a potential difference not smaller than the discharge threshold value, thereby causing the charged photosensitive member potential to be converged to a predetermined charge potential.

In order to secure a surface potential Vd on the photosensitive member that is required for the electrophotographies, the charge roller needs a higher DC voltage of Vd+Vth. Such a charging scheme of applying only a DC voltage to a contact charging member may be termed a “DC charging scheme”.

However, it was difficult to keep a desired potential on the photosensitive member because resistivity of the contact charging member fluctuates by, for example, change in environmental conditions and because variations in film thickness that are caused by breakdown of the photosensitive member alter the Vth.

In order to further uniformize charging, an AC charging scheme is proposed, as disclosed in Japanese Patent Application Laid-Open No. 63-149669. With this scheme, an AC component having a voltage of at least twice as high as Vth between the peaks is added to the DC voltage corresponding to the desired Vd level, and the totaled voltage is applied to the contact charging member. This is aimed at leveling the potential by the AC voltage. The potential on the charged member tends to converge to Vd as the central voltage between the AC voltage peaks and is not affected by external disturbances such as environmental changes.

The above-mentioned contact charging device also basically depends on the mechanism of discharge from the contact charging member to the photosensitive member. As described above, a voltage to be applied to the contact charging member should be higher than a potential on the surface of the photosensitive member. A small amount of ozone will be produced accordingly. Addition of an AC voltage to uniformize charging involves new problems, such as production of much ozone, generation of vibration and noise (AC charging noise) of the contact charging member and the photosensitive member by the AC electric field, and deterioration of the surface of the photosensitive member by additional discharging by the AC voltage.

With the fur brush charging, a member having a conductive fiber brush (fur brush charger) is used as the contact charging member. The conductive fiber brush is brought into contact with the photosensitive member that serves as the charged member. A predetermined charge bias is applied to the conductive fiber brush to charge the surface of the photosensitive member elestrostatically to a predetermined polarity and potential. The fur brush charging also basically depends on the above-mentioned discharge-charging mechanism (1).

There are two types of fur brush chargers available for commercial use: fixed type and roll-aided type. The fixed brush charger comprises fibers of medium resistivity. The fibers are knitted and tufted into a backing fabric to form piles, which is deposited on an electrode. The roll-aided brush charger is formed by wrapping piles around a metallic core. A typical pile fiber density is 100 fiber/mm². This density, however, does not provide sufficient contact between the fur brush charger and the photosensitive member and only insufficient level of charge uniformity is provided on the surface of the photosensitive member by the direct injection. In order to provide more uniform charging by the direct injection, an incredibly large speed difference is required between the fur brush charger and the photosensitive member. It is almost impossible to achieve such a large difference with a mechanical structure and is not practical.

The line B in FIG. 3 shows a charging property that is obtained when a DC voltage is applied during the fur brush charging. Thus, the fur brush charging often uses a high charge bias to cause the discharge, both in the fixed and roll-aided types.

On the other hand, magnetic brush charging uses a member having a magnetic brush (magnetic brush charger) as the contact charging member. The magnetic brush is formed by means of confining conductive magnetic particles on, for example, a magnetic roll. The magnetic brush is brought into contact with the photosensitive member that serves as the charged member. A predetermined charge bias is applied to the magnetic brush to charge the surface of the photosensitive member electrostatically to a predetermined polarity and potential.

The magnetic brush charging may depend on the above-mentioned direct injection charging mechanism (2).

Uniform charging with the direction injection may be achieved by means of using conductive magnetic particles having a particle diameter 5 to 50 μm to form the magnetic brush and providing a sufficient difference in speed relative to the photosensitive member.

The line C in FIG. 3 shows a charging property that is obtained when a DC voltage is applied during the magnetic brush charging. As apparent from FIG. 3, it is possible to obtain a charge potential that is approximately in proportion to the applied bias.

The magnetic brush charging involves its own disadvantages, such as a complex mechanical configuration and possible deposition of the conductive magnetic particles of the magnetic brush on the photosensitive member.

As apparent from the above, there is a demand for a simple and stable charging device that is capable of charging electrostatically the charged member in a uniform state with a low applied voltage, by using the direct injection charging mechanism, without the formation of substantial discharge products such as ozone.

There is also a demand for an image forming technique that produces no waste toner for disposal, from the standpoint of saving resources, reducing waste products and effectively using the toner.

Conventionally, a typical image forming technique uses a toner to develop a latent image into a visible image. A toner image is transferred onto a recording medium such as paper. A portion of the toner that is not used for the transfer of an image onto the recording medium and left on a latent image-bearing member is removed in a cleaning process and is discarded as a waste toner in a waste toner container. In the image forming method, the step of forming images through the cleaning step is repeated.

The cleaning process has been achieved by several techniques such as blade cleaning, fur brush cleaning and roller cleaning. Each of these techniques mechanically removes the residual toner by, for example, scratching or collecting it in a waste toner container. Recent strong sentiment towards resource saving and environment conservation results in an increasing demand for a system that collects the waste toner in a waste toner container and reuses or discards it. In response to this, a so-called toner recycling system is in practical use, wherein the toner is collected in the cleaning process, recycled into the developer for reuse. However, pressing the cleaning member to the surface of the latent image-bearing member invariably causes problems, such as wear and reduced serviceability of the latent image-bearing member when the cleaning member is strongly pressed. The toner recycling system and the cleaning device increase the size of the image forming device, and bottleneck size reduction.

With respect to the above, some techniques have been proposed that release no waste toner such as cleaning-at-development techniques and techniques to dispense with the cleaner (cleanerless techniques).

Many conventional cleaning-at-development and cleanerless techniques are basically as disclosed in Japanese Patent Application Laid-Open No. 5-2287. Such techniques are designed to reduce or eliminate positive or negative memories caused by the residual toner. However, recent growth in electrophotographies has led to an increasing demand for transferring a toner image on various recording media. These types of conventional cleaning-at-development and cleanerless techniques are far from satisfactory in this regard.

Other techniques are disclosed in, for example, Japanese Patent Application Laid-Open Nos. 59-133573, 62-203182, 63-133179, 64-20587, 2-302772, 5-2289, 5-53482 and 5-61383. These prior arts, however, do not disclose a desired image forming method and formation of the toner.

As a development method suitably applicable to a cleanerless technique or a cleaning-at-development technique that dispenses with a cleaning device, scraping of the surface of an latent image-bearing member with a toner and a toner-carrying member has been considered essential. This has led to much more studies and researches about contact development techniques wherein the toner or the developer is brought into contact with the latent image-bearing member. A major reason of this lies in the fact that scraping the latent image-bearing member with the toner or the developer has been considered advantageous to collect transfer-residual toner particles by developing means. However, such a cleaning-at-development or cleanerless process is liable to cause problems such as degradation of the toner, deterioration or wear of the surface of the toner-carrying member and/or of the photosensitive member. Thus, no sufficient solution has been given to durability problems and a cleaning-at-development method that is based on non-contact development has been desired.

Now, an application of the contact charging to such a cleaning-at-development method or a cleanerless image forming method, is considered

The cleaning-at-development method or the cleanerless image forming method does not use a cleaning member. The transfer-residual toner particles remaining on the photosensitive member are brought into contact with the contact charging member. The particles are deposited on or incorporated into the contact charging member. When the charging scheme used is achieved mainly by using the discharge-charging mechanism, deposition to the charging member is badly affected due to degradation of the toner by discharge energy. Adhesion or incorporation of typical insulative toner on or into the contact charging member causes deterioration in charging properties of the charged member.

The deterioration in charging properties of the charged member suddenly occurs at or around the resistivity level where the toner layer on the surface of the charging member inhibits the discharge, when the charging is achieved mainly by using the discharge-based mechanism. On the other hand, when the charging is achieved by using the direct injection charging mechanism, adhered or incorporated transfer-residual toner particles reduce the chance of the contact charging member surface to be brought into contact with the charged member. This results in deterioration in charging properties of the charged member.

Such inherent reduction in uniform charging properties of the charged member lowers contrast and uniformity of electrostatic latent images after exposure of the images, reducing the image density or increasing undesirable fog.

In the cleaning-at-development method and the cleanerless image forming method, it is critical to control the charge polarity and amount of charging of the transfer-residual toner particles on the photosensitive member to collect the transfer-residual toner particles in a stable manner during the developing step without causing any side effect on the development properties by the collected toner. To this end, the charging member is designed to control the charge polarity and the amount of charging of the transfer-residual toner particles.

This is more specifically described with respect to an ordinary laser beam printer as an example. In the case of reversal development that uses a charging member adapted to apply a negative voltage, a photosensitive member having a negative charging properties and a negatively chargeable toner, a visualized toner-based image is transferred onto a recording medium in the transferring step by means of a transfer member applying a positive voltage. In this case, the residual toner has various charge polarities ranging from a positive polarity to a negative polarity depending on the type of the recording medium (thickness, resistivity, dielectric constant, etc.) and an image area thereon. However, even when the residual toner is caused to have a positive charge after the transferring step, the charge polarity of the transfer-residual toner particles can be uniformed to a negative polarity along with the photosensitive member by the charging member applied with a negative voltage for negatively charging the photosensitive member. Consequently, in the case of the reversal development, the negatively charged residual toner remains on the light portion potential areas that are going to be developed with the toner. The transfer-residual toner particles are attracted towards the toner-carrying member by the electric field on the areas with a dark portion potential that should not be developed with the toner. The transfer-residual toner particles are collected completely without being left on the photosensitive member having the dark portion potential. As apparent from the above, the cleaning-at-development and cleanerless image forming methods are achieved by means of controlling the charging on the photosensitive member and the charge polarity of the residual toner by the charging member.

If the transfer-residual toner particles are adhered to or incorporated into the contact charging member in excess of the control capacity of the contact charging member on the toner charge polarity, it becomes difficult to uniformize the charge polarity of the transfer-residual toner particles. This in turn makes it difficult to collect the toner during the developing step. In addition, even when the transfer-residual toner particles are collected on the toner-carrying member through a mechanical force such as friction, the charging properties of the toner on the toner-carrying member are badly affected unless the charge of the transfer-residual toner particles is uniform. This leads to deterioration in development properties.

In the cleaning-at-development and cleanerless image forming methods, durability and image quality are very closely related to charge control, adhesion and incorporation of the transfer-residual toner particles on and into the charging member when they are passed through the charging member.

In the cleaning-at-development image forming method, the cleaning-at-development properties can be improved by means of improving the charge control of the transfer-residual toner particles when they are passed through the charging member. For example, Japanese Patent Application Laid-Open No. 11-15206 proposes an image forming method that uses a toner comprising toner particles and an inorganic fine powder, the toner particles containing a certain carbon black and a certain azo-based iron compound. Furthermore, in the cleaning-at-development image forming method, it has also been proposed to reduce the amount of the transfer-residual toner particles by using a toner with a specified shape factor which is capable of providing an excellent transfer efficiency, thereby to improve cleaning-at-development performance. These proposals may be effective in combination with the contact development process. However, collection efficiencies of the transfer-residual toner particles in the development step need more improvement when combined with the non-contact development process. The contact charging used here also depends on the discharge-charging mechanism, not the direct injection charging mechanism. Therefore, the above-mentioned problems due to the discharge occur. The proposal in question may be successful in controlling possible deterioration of the charging properties of the charged member caused by the transfer-residual toner particles on the contact charging member. However, no positive effect on improving the charging properties can be expected.

Some commercially available electrophotographic printers employ a cleaning-at-development image forming apparatus with a roller member that abuts the photosensitive member between the transferring step and the charging step to assist or control collection of the transfer-residual toner particles during development. Such image forming apparatuses exhibit good cleaning-at-development properties by using the contact development process and contribute to significant reduction in amount of the waste toner. On the other hand, it is not cost-effective and reduces the advantage of the cleaning-at-development step in terms of size reduction.

In order to prevent fluctuation of charging on the charged member and provide stable and uniform charging, Japanese Patent Publication No. 7-99442 discloses a configuration with a powder applied over the surface of the contact charging member that contacts with the charged member. However, the contact charging member (charge roller) moves following the charged member (photosensitive member) (without speed differential driving). This configuration generates a much smaller quantity of ozone products than corona discharger such as those based on scorotron but it depends on the discharge-charging mechanism as in the case of the above-mentioned roller charging. In particular, in order to provide a more stable charge uniformity, an AC voltage is superposed to the DC voltage and the superposed voltage is applied. Accordingly, more ozone products are produced through discharge. Continuous use of the apparatus for a long period of time often results in harmful side effects, such as blurring, by the ozone products. When the above-mentioned configuration is applied to a cleanerless image forming apparatus, incorporation of the transfer-residual toner particles makes it difficult to deposit the applied powder uniformly on the charging member. The effect of uniformly charging the charged member electrostatically would thus be reduced.

Japanese Patent Application Laid-Open No. 5-150539 discloses a developer comprising at least image-developing particles and conductive particles having an average particle diameter smaller than that of the image-developing particles, in order to avoid the inhibition of charging which otherwise occurs as a result of deposition and accumulation of the toner particles and silica fine particles that could not be removed with a blade on the charging means during repeated formation of images for a long period of time according to a image forming method based on the contact charging. The charging member is, however, disposed in contact with or in close vicinity to the charged member and the charging is achieved by using the discharge-charging mechanism rather than the direct injection charging mechanism. Accordingly, there remain the above-mentioned problems associated with the discharge. Furthermore, when the developer is applied to a cleanerless image forming apparatus, a significantly larger amount of transfer-residual toner particles is subjected to the charging step as compared with the cases where a cleaning mechanism is provided. This causes deterioration of charging properties of the charged member. The transfer-residual toner particles are collected at an unsatisfactory level in the developing step. The collected transfer-residual toner particles may affect badly development properties of the developer. These possible problems are not considered in this prior art document. On the other hand, when the direct injection charging mechanism is applied to the contact charging, the conductive fine particles are supplied to the contact charging member only in an insufficient amount, and faulty charging may occur due to the influence of the transfer-residual toner particles.

When the charging member is disposed in close vicinity to the charged member, it is difficult to uniformly charge electrostatically the photosensitive member by using a large amount of transfer-residual toner particles. No leveling effect is achieved on patterns of the transfer-residual toner particles. Exposure of pattern images of the transfer-residual toner particles is intercepted. This results in generation of a pattern ghost. Furthermore, sudden interruption of the power supply or jamming of paper during formation of an image causes significant pollution within the device by the developer.

In order to avoid such problems, Japanese Patent Application Laid-Open No. 10-307456 discloses an image forming apparatus, in which a developer that comprises toner particles and conductive electrification accelerating particles having a particle diameter at least two times smaller than the diameter of the toner particles is applied to a cleaning-at-development image forming method using the direct injection charging mechanism. This proposal provides a cost-effective and downsizing-oriented cleaning-at-development image forming apparatus with which the amount of waste toner can be reduced significantly without the presence of discharge products. Consequently, a good image can be obtained without any faulty charging, interception of the image exposure, and diffusion.

Japanese Patent Application Laid-Open No. 10-307421 discloses an image forming apparatus, in which a developer that comprises conductive particles whose particle diameter is fifty times to two times smaller than the diameter of toner particles is applied to a cleaning-at-development image forming method using the direct injection charging mechanism to provide transfer accelerating effects of the conductive particles.

Japanese Patent Application Laid-Open No. 10-307455 describes that the particle diameter of conductive fine powder is defined to be not larger than the size of a single constituting pixel and that the particle diameter of the conductive fine powder is defined within a range of 10 nm to 50 μm in order to achieve better charge uniformity.

Japanese Patent Application Laid-Open No. 10-307457 describes conductive particles having a particle diameter of approximately 5 μm or smaller, preferably 20 nm to 5 μm, in order to avoid clear appearance of an effect of faulty charging on an image that a person can recognize, while human visual characteristics are taken into consideration.

Japanese Patent Application Laid-Open No. 10-307458 discloses that using a conductive fine powder having a particle diameter not larger than the particle diameter of toner particles prevents the problem of interception of development with the toner and the problem of leakage of the development bias through the conductive fine powder, which eliminates a defect of an image. The disclosure also includes a cleaning-at-development image forming method using the direct injection charging mechanism, in which the particle diameter of the conductive fine powder is defined to be larger than 0.1 μm. This solves the problem of interception or obstruction of light beams for exposure by the embedded conductive fine powder in the image-bearing member and achieves excellent image recording.

Japanese Patent Application Laid-Open No. 10-307456 discloses a cleaning-at-development image forming apparatus with which a good image can be obtained without faulty charging and interception of image exposure, in which a conductive fine powder is externally added to a toner, and the conductive fine powder contained in the toner is deposited on an image-bearing member during a developing step and remain on the image-bearing member after a transferring step at least where a flexible contact charging member abuts an image-bearing member.

The above-mentioned proposal describes to a certain extent a preferable range of the particle diameter of the conductive fine powder. However, there is disclosure neither about a possible configuration or form of the conductive fine powder nor about a preferable form of the toner particles. This suggests that further improvements are required to achieve a stable performance.

As apparent from the above, in the developers that are intended to be used in a cleaning-at-development image forming method or a cleanerless image forming technique, externally-added additives have not been studied well. The existing proposals for a developer containing an externally-added additive also have not been studied well from the viewpoint of applying them to a cleaning-at-development image forming method or a cleanerless image forming technique. This indicates that further improvements are required.

### SUMMARY OF THE INVENTION

An object of the present invention is to solve the above-mentioned problems and to provide a developer that allows good cleaning-at-development formation of images.

Another object of the present invention is to provide a developer that allows simple and stable uniform charging by using a direct injection charging mechanism with which the uniform charging can be achieved at a low applied voltage, without the presence of substantial discharge products such as ozone.

Another object of the present invention is to provide a cost-effective and downsizing-oriented cleaning-at-development image forming method with which the amount of waste toner can be reduced significantly.

Another object of the present invention is to provide an image forming method that allows simple and stable uniform charging by using a direct injection charging mechanism with which the uniform charging can be achieved at a low applied voltage, without the presence of substantial discharge products such as ozone, and that provides a good image without faulty charging after the repeated use for a long period of time.

In addition, another object of the present invention is to provide an apparatus and a process cartridge with which cleanerless formation of images can be achieved that provides good charging properties in a stable manner.

Furthermore, another object of the present invention is to provide an apparatus and a process cartridge with which cleaning-at-development formation of images can be achieved while collecting transfer-residual toner particles at a satisfactory level.

Moreover, an object of the present invention is to provide a developer comprising a conductive fine powder that allows simple and stable uniform charging by using a direct injection charging mechanism, or that allows good collection of transfer-residual toner particles, in which the developer can be applied to a cleaning-at-development image forming method to produce an image of high density having less fog.

An object of the present invention is to provide a developer comprising at least: (i) toner particles containing at least a binder resin and a colorant, (ii) an inorganic fine powder whose primary particles have a number-average particle diameter of from 4 nm to 50 nm, and (iii) a conductive fine powder whose primary particles have a number-average particle diameter of from 50 nm to 500 nm, the conductive fine powder containing an agglomerated matter of the primary particles, wherein the developer comprises 15% to 60% by number of particles having particle diameters in the range of from 1.00 μm, inclusive, to 2.00 μm, exclusive, and comprises 15% to 70% by number of particles having particle diameters in the range of from 3.00 μm, inclusive, to 8.96 μm, exclusive, in number-based particle size distribution of particles having particle diameters in the range of from 0.60 μm, inclusive, to 159.21 μm, exclusive.

An object of the present invention is to provide an image forming method comprising a repeated cycle of the following steps to form an image: a charging step for charging electrostatically an image-bearing member; a latent image forming step for writing image information as an electrostatic latent image on a charged surface of the image-bearing member that is charged in the charging step; a developing step for visualizing the electrostatic latent image as a toner image with a developer; and a transferring step for transferring the toner image to a transfer material, the developer comprising at least: (i) toner particles containing at least a binder resin and a colorant, (ii) an inorganic fine powder whose primary particles have a number-average particle diameter of from 4 nm to 50 nm, and (iii) a conductive fine powder whose primary particles have a number-average particle diameter of 50 to 500 nm, the conductive fine powder containing an agglomerated matter of the primary particles, the developer comprising 15% to 60% by number of particles having particle diameters in the range of from 1.00 μm, inclusive, to 2.00 μm, exclusive, and comprising 15% to 70% by number of particles having particle diameters in the range of from 3.00 μm, inclusive, to 8.96 μm, exclusive, in number-based particle size distribution of particles having particle diameters in the range of from 0.60 μm, inclusive, to 159.21 μm, exclusive, wherein the charging step is a step of charging electrostatically the image-bearing member by means of applying a voltage to a charging member in the presence of a component of the developer that comprises at least the conductive fine powder at a position where the image-bearing member abuts the charging member that is in contact with the image-bearing member.

Another object of the present invention is to provide an image forming method comprising a repeated cycle of the following steps to form an image: a charging step for charging electrostatically an image-bearing member; a latent image forming step for writing image information as an electrostatic latent image on a charged surface of the image-bearing member that is charged in the charging step; a developing step for visualizing the electrostatic latent image as a toner image with a developer; and a transferring step for transferring the toner image to a transfer material, the developer comprising at least: (i) toner particles containing at least a binder resin and a colorant, (ii) an inorganic fine powder whose primary particles have a number-average particle diameter of from 4 nm to 50 nm, and (iii) a conductive fine powder whose primary particles have a number-average particle diameter of from 50 nm to 500 nm, the conductive fine powder containing an agglomerated matter of the primary particles, the developer comprising 15% to 60% by number of particles having particle diameters in the range of from 1.00 μm, inclusive, to 2.00 μm, exclusive, and comprising 15% to 70% by number of particles having particle diameters in the range of from 3.00 μm, inclusive, to 8.96 μm, exclusive, in number-based particle size distribution of particles having particle diameters in the range of from 0.60 μm, inclusive, to 159.21 μm, exclusive, wherein the developing step is a step of visualizing the electrostatic latent image and collecting the developer that remains on the image-bearing member after the transfer of the toner image to the transfer material.

An object of the present invention is to provide a process cartridge comprising at least: an image-bearing member for bearing an electrostatic latent image; charging means for charging electrostatically the image-bearing member; and developing means for developing the electrostatic latent image formed on the image-bearing member with a developer to form a toner image, wherein the process cartridge is adapted to be loaded into and unloaded from an image forming apparatus, the image forming apparatus is for visualizing the electrostatic latent image formed on the image-bearing member with a developer and transferring the visualized toner image to a transfer material to form an image, the developer comprising at least: (i) toner particles containing at least a binder resin and a colorant, (ii) an inorganic fine powder whose primary particles have a number-average particle diameter of from 4 nm to 50 nm, and (iii) a conductive fine powder whose primary particles have a number-average particle diameter of from 50 nm to 500 nm, the conductive fine powder containing an agglomerated matter of the primary particles, the developer comprising 15% to 60% by number of particles having particle diameters in the range of from 1.00 μm, inclusive, to 2.00 μm, exclusive, and comprising 15% to 70% by number of particles having particle diameters in the range of from 3.00 μm, inclusive, to 8.96 μm, exclusive, in number-based particle size distribution of particles having particle diameters in the range of from 0.60 μm, inclusive, to 159.21 μm, exclusive, and wherein the charging means is means for charging electrostatically the image-bearing member by means of applying a voltage to a charging member in the presence of a component of the developer that remains on the image-bearing member after the deposition on the image-bearing member by the developing means and the transfer by the transferring means and that contains at least the conductive fine powder at a position where the image-bearing member abuts the charging member that is in contact with the image-bearing member.

Another object of the present invention is a process cartridge comprising at least: an image-bearing member for bearing an electrostatic latent image; and developing means for developing the electrostatic latent image formed on the image-bearing member with a developer to form a toner image, wherein the process cartridge is adapted to be loaded into and unloaded from an image forming apparatus, the image forming apparatus is for visualizing the electrostatic latent image formed on the image-bearing member with a developer and transferring the visualized toner image to a transfer material to form an image, the developer comprising at least: (i) toner particles containing at least a binder resin and a colorant, (ii) an inorganic fine powder whose primary particles have a number-average particle diameter of from 4 nm to 50 nm, and (iii) a conductive fine powder whose primary particles have a number-average particle diameter of from 50 nm to 500 nm, the conductive fine powder containing an agglomerated matter of the primary particles, the developer comprising 15% to 60% by number of particles having particle diameters in the range of from 1.00 μm, inclusive, to 2.00 μm, exclusive, and comprising 15% to 70% by number of particles having particle diameters in the range of from 3.00 μm, inclusive, to 8.96 μm, exclusive, in number-based particle size distribution of particles having particle diameters in the range of from 0.60 μm, inclusive, to 159.21 μm, exclusive, and wherein the developing means is means for forming the toner image and for collecting the developer that remains on the image-bearing member after the toner image is transferred to the transfer material.

### BRIEF DESCRIPTION OF THE DRAWINGS

FIG. 1 is a schematic view of an image forming apparatus used in Examples of the present invention;

FIG. 2 is a schematic view of another image forming apparatus used in Examples of the present invention;

FIG. 3 is a graphical representation of charging properties of charging members;

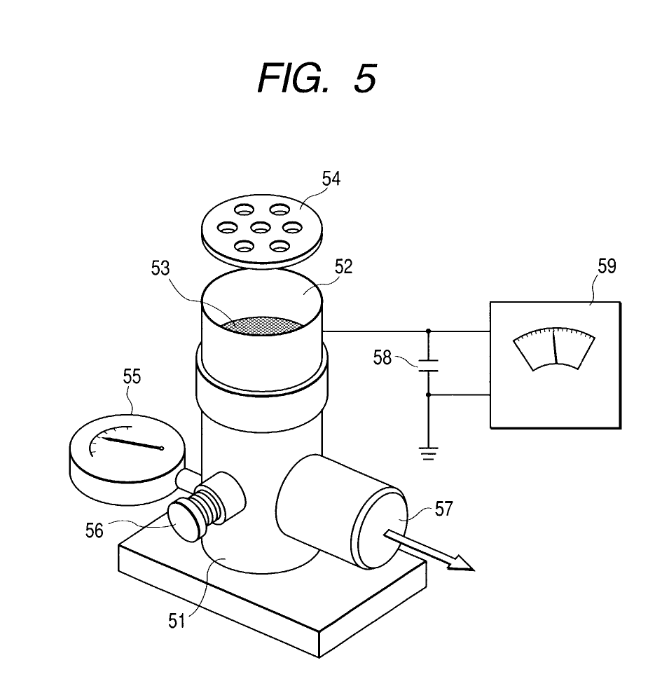

FIG. 4 is a graphical representation of human visual characteristics in spatial frequencies;

FIG. 5 is a schematic view of a developer charge measurement system that is used in the present invention;

FIG. 6 is a schematic view showing layers of a photosensitive member that serves as an image-bearing member of the present invention;

FIG. 7 is a schematic view of a toner particle spherizer that is used in Examples of the present invention;

FIG. 8 is a schematic view of a processing unit of a toner particle spherizer that is used in Examples of the present invention;

FIGS. 9A, 9B, 9C, 9D and 9E show number-based particle size distribution over the particle diameter range of from 0.60 μm, inclusive, to 159.21 μm, exclusive, of developers in Examples and Comparative Examples of the present invention, in which the number-based particle size distribution is measured by a flow-type particle size distribution analyzer; and

FIGS. 10A, 10B, 10C, 10D and 10E show number-based particle size distribution over the particle diameter range of from 0.60 μm, inclusive, to 159.21 μm, exclusive, of developers in Examples and Comparative Examples of the present invention, in which the number-based particle size distribution is measured by a flow-type particle size distribution analyzer.

### DESCRIPTION OF THE PREFERRED EMBODIMENTS

Embodiments of the present invention are described below.

<Developer>

A developer of the present invention is characterized by comprising at least toner particles containing at least a binder resin and a colorant, an inorganic fine powder whose primary particles have a number-average particle diameter of 4 to 50 nm, and a conductive fine powder whose primary particles have a number-average particle diameter of 50 to 500 nm, the conductive fine powder containing an agglomerated matter of the primary particles, wherein the developer comprises 15% to 60% by number of particles having the particle diameter range of from 1.00 μm, inclusive, to 2.00 μm, exclusive, and comprises 15% to 70% by number of particles having the particle diameter range of from 3.00 μm, inclusive, to 8.96 μm, exclusive, in number-based particle size distribution over the particle diameter range of from 0.60 μm, inclusive, to 159.21 μm, exclusive.

Using the developer of the present invention, it is possible to provide an image forming method that allows a simple configuration to achieve uniform charging by using a direct injection charging mechanism with which the uniform charging of the image-bearing member can be achieved at a low applied voltage, without the formation of substantial discharge products such as ozone, and that provides a good image without faulty charging after the repeated use for a long period of time. In addition, using the developer of the present invention, even when a large amount of developer components is deposited on or incorporated into the contact charging member, deterioration of the uniform charging properties is inhibited. Accordingly, it is possible to provide an image forming method based on the contact charging while controlling the formation of faulty images due to faulty charging.

The developer of the present invention makes it possible to obtain a developer that exhibits stable and good triboelectric charging properties in combination with a cleaning-at-development image forming method. A good image can be obtained without any defect of images which otherwise would occur due to interception of formation of a latent image or uniform charging, or due to insufficient collection of transfer-residual toner particles during and after repeated use of the developer for a long period of time. Thus, it is possible to provide a cost-effective and downsizing-oriented cleaning-at-development image forming method with which the amount of waste toner can be reduced significantly.

The developer of the present invention comprises toner particles containing at least a binder resin and a colorant, an inorganic fine powder whose primary particles have a number-average particle diameter of 4 to 50 nm, and conductive fine powder whose primary particles have a number-average particle diameter of 50 to 500 nm, the conductive fine powder containing an agglomerated matter of the primary particles. A proper amount of the conductive fine powder contained in the developer moves from the developer-carrying member to the image-bearing member along with the toner particles when the electrostatic latent image formed on the image-bearing member is developed. The development of the electrostatic latent image causes the toner image formed on the image-bearing member to move to transfer material such as paper in a transferring step. In this step, some conductive fine powder on the image-bearing member are deposited on the transfer material. The remainders are left on the image-bearing member. When a transfer bias to be applied for the transfer has a polarity opposite to the triboelectric charge polarity of the toner particles, toner particles are attracted towards the transfer material and move easily. On the other hand, the conductive fine powder on the image-bearing member hardly move to the transfer material because of their conductivity. Accordingly, most conductive fine powder are deposited and held on the image-bearing member though some of them are deposited on the transfer material.

When images are formed repeatedly on the image-bearing member according to an image forming method that does not include a step of removing the conductive fine powder that is deposited and left on the image-bearing member, as in a cleaning step between the transferring step and a charging step, the toner particles that are left on the surface of the image-bearing member after the transfer (hereinafter, referred to as “transfer-residual toner particles”), and the above-mentioned remaining conductive fine powder is brought to a charging part along with the movement of the surface of the image-bearing member on which an image is carried (hereinafter, referred to as an “image-bearing surface”).

When a contact charging member is used in the charging step, the conductive fine powder are brought into the charging portion where the image-bearing member abuts or is in contact with the contact charging member. The conductive fine powder is then deposited on and incorporated into the contact charging member. Consequently, the contact charging of the image-bearing member is performed with the conductive fine powder being present at the above-mentioned abutting part.

By depositing and incorporating the conductive fine powder on and into the contact charging member so that the conductive fine powder is present in the charging part, the resistivity of the contact charging member can be kept though the contact charging member is polluted due to the deposition and incorporation of the transfer-residual toner particles. Accordingly, it is possible to charge electrostatically the image-bearing member by using the contact charging member at a satisfactory level. If only an insufficient amount of conductive fine powder is present in the charging part of the contact charging member, the charging of the image-bearing member may easily be deteriorated due to the deposition and incorporation of the transfer-residual toner particles on and into the contact charging member. This results in a stain of an image.

Furthermore, by positively bringing the conductive fine powder into the abutting part between the image-bearing member and the contact charging member, very close contact and a contact resistivity can be kept between the contact charging member and the image-bearing member. This facilitates good direct injection-based charging of the image-bearing member by the contact charging member.

The transfer-residual toner particles pass through the charging part or gradually swept out of the contact charging member to the image-bearing member. They are brought into a development part along with the movement of the image-bearing surface, and cleaning-at-development step is performed in the developing step, that is, the transfer-residual toner particles are collected. After the transferring step, the conductive fine powder staying on the image-bearing member is brought into the development part along with the movement of the image-bearing surface as in the transfer-residual toner particles. In other words, the conductive fine powder is present on the image-bearing member along with the transfer-residual toner particles. In the developing step, the transfer-residual toner particles are collected. When the collection of the transfer-residual toner particles in the developing step is performed by using a development bias electric field, the transfer-residual toner particles are collected under the development bias electric field while the conductive fine powder on the image-bearing member is hardly collected because of their conductivity. Accordingly, most conductive fine powder particles are deposited and held on the image-bearing member though some of them are collected. The studies made by the present inventors revealed that the presence of the conductive fine powder on the image-bearing member that is hardly collected in the developing step makes improves collectability of the transfer-residual toner particles on the image-bearing member. More specifically, the conductive fine powder on the image-bearing member serves as a collection aid for the transfer-residual toner particles on the image-bearing member, which ensures collection of the transfer-residual toner particles in the developing step. Thus, it is possible to effectively prevent a defect of images such as positive ghost and fog caused as a result of insufficient collection of the transfer-residual toner particles.

Conventionally, a conductive fine powder is externally added to a developer mainly for the purpose of depositing the conductive fine powder on the surface of toner particles to control triboelectric charging properties of the toner particles. A portion of the conductive fine powder released or liberated from the toner particles is considered to be responsible for alteration or deterioration of developer characteristics or for degradation of an image-bearing member. On the contrary, the developer of the present invention positively releases the conductive fine powder from the surface of the toner particles. This is quite different from the external addition of the conductive fine powder to the developer that has been studied extensively.

The conductive fine powder in the developer of the present invention is easily liberated from the surface of the toner particles. The conductive fine powder is brought into the charging part, i.e., the abutting part in which the image-bearing member and the contact charging member are in contact, through the image-bearing member after the transfer. In this way, the charging properties of the image-bearing member by the charging means are improved to prevent a defect of images which otherwise would occur as a result of deterioration of the charging properties. Thus, stable and uniform charging can be achieved. In the developing step, the conductive fine powder are present on the image-bearing member. Accordingly, the conductive fine powder serves as a collection aid for the transfer-residual toner particles on the image-bearing member, which ensures collection of the transfer-residual toner particles in the developing step. Thus, it is possible to effectively prevent a defect of images such as positive ghost and fog caused as a result of insufficient collection of the transfer-residual toner particles.

In the present invention, the conductive fine powder that is deposited on the surface of the toner particles and behave along with the toner particles do not contribute to improvement and enhancement of the charging properties and cleaning-at-development performances of the image-bearing member as obtained by the developer of the present invention. The toner particles with the conductive fine powder deposited on the surface thereof experience deterioration of triboelectric charging properties, developability, transfer-residual toner particles collectability during the cleaning-at-development step, and transferability. Such deterioration increases the amount of the transfer-residual toner particles, causing inhibition of uniform charging or formation of a latent image.

As to the conductive fine powder contained in the developer of the present invention, during repeated formation of images, the conductive fine powder that is left on the image-bearing surface in the developing step and the conductive fine powder that additionally comes into the image-bearing surface are brought into the charging part in the transferring step along with the movement of the image-bearing surface. Therefore, the conductive fine powder is continuously and successively supplied to the charging part. When the conductive fine powder is decreased due to, for example, removal in the charging part or when the capability of the conductive fine powder to enhance the uniform charging properties is deteriorated, the conductive fine powder is continuously supplied to the charging part. Accordingly, it is possible to prevent deterioration of the charging properties of the image-bearing member even after repeated use of the device for a long period of time. Good uniform charging can be kept in a stable manner.

According to the studies by the present inventors on effects of the particle diameter of the conductive fine powder added to the developer on the enhancement of charging properties and cleaning-at-development properties of the image-bearing member, the conductive fine powder having a very small particle diameter (e.g., about 0.1 μm or smaller) tends to deposit firmly on the surface of the toner particles. It is difficult to supply a sufficient amount of conductive fine powder to the image-bearing surface in the developing step. The conductive fine powder is hardly liberated from the surface of the toner particles in the transferring step. It is difficult to positively leave the conductive fine powder on the image-bearing member after the transfer. It is also difficult -to positively supply the conductive fine powder to the charging part.

Accordingly, an effect of improving the charging properties of the image-bearing member cannot be obtained. When the transfer-residual toner particles are deposited on the contact charging member, a defect of images often occurs due to the deterioration of the charging properties of the image-bearing member. In the cleaning-at-development step, no effect of improving the collectability of the transfer-residual toner particles can be achieved because the conductive fine powder cannot be supplied to the image-bearing member, and because the particle diameter is too small even if they can be supplied to the image-bearing member. Thus, it is impossible to effectively prevent a defect of images such as the positive ghost and the fog resulting from insufficient collection of the transfer-residual toner particles.

When the conductive fine powder is brought into the charging part and deposited on and incorporated into the contact charging member with being deposited firmly onto the surface of the toner particles, inhibition of charging of the image-bearing member by the toner particles cannot be controlled by using the conductive fine powder that is firmly deposited on the surface of the toner particles. A sufficient effect of improving the charging properties of the image-bearing member cannot be obtained. In the cleaning-at-development step, the conductive fine powder that is firmly deposited on the surface of the toner particles cannot improve the collectability of the toner particles. A defect of images due to the insufficient collection of the transfer-residual toner particles is readily caused.

The conductive fine powder having a too large particle diameter (e.g., about 4 μm or larger) cannot achieve uniform enhancement of the charging properties of the image-bearing member even when it is supplied to the charging part due to its larger particle diameter. The conductive fine powder is apt to be liberated from the charging member. This means that it is difficult to continuously and stably provide a sufficient number of the conductive fine powder to the charging part. Furthermore, the proportion of the conductive fine powder per a unit weight is decreased. In order to provide a sufficient proportion of conductive fine powder to the charging part to achieve an sufficient effect of enhancing the uniform charging of the image-bearing member, it is inevitably necessary to increase the amount of the conductive fine powder added. However, an excessive amount of the conductive fine powder added deteriorates triboelectric chargeability and developability of the developer as a whole, causing reduction in image density and scattering of the toner.

A larger particle diameter of the conductive fine powder particles prevents the transfer-residual toner particles from exhibiting a sufficient effect as a collection aid in the cleaning-at-development step. In order to collect more transfer-residual toner particles, the amount of the conductive fine powder may be increased. However, too much conductive fine powder on the image-bearing member result in an adverse effect on the latent image forming step, such as a defect of images caused by the interception of the exposure of the images, because of such a larger particle diameter.

The present inventors have made thorough studies on particle diameters of the conductive fine powder, particle size distribution of the developer containing an externally-added additive that is directly associated with the actual behavior of the developer, and forms of the conductive fine powder. In particular, the present inventors have made studies on the conductive fine powder that comprise agglomerated matters of primary particles. As a result of such thorough and extensive studies, the present invention was thus accomplished.

It has been found that, by means of making the developer have a configuration comprising at least toner particles containing at least a binder resin and a colorant, an inorganic fine powder whose primary particles have a number-average particle diameter of 4 to 50 nm, and a conductive fine powder whose primary particles have a number-average particle diameter of 50 to 500 nm, the conductive fine powder containing an agglomerated matter of the primary particles, wherein the developer comprises 15% to 60% by number of particles having particle diameters in the range of from 1.00 μm, inclusive, to 2.00 μm, exclusive, and comprises 15% to 70% by number of particles having particle diameters in the range of from 3.00 μm, inclusive, to 8.96 μm, exclusive, in number-based particle size distribution of particles having particle diameters in the range of from 0.60 μm, inclusive, to 159.21 μm, exclusive, precision and uniformity of the uniform charging during the contact charging can be improved and faulty charging can be prevented completely. It has also been found that a larger number of the transfer-residual toner particles can be collected in the cleaning-at-development step and that the defects of images, such as the positive ghost and the fog due to the insufficient collection of the transfer-residual toner particles, can be avoided completely. The present invention was thus accomplished.

More specifically, the inorganic fine powder whose primary particles have a number-average particle diameter of 4 to 50 nm that is contained in the developer of the present invention is deposited on the surface of the toner particles and behaves along with the toner particles, thereby improving flowability of the developer and uniformize triboelectric charging of the toner particles. This improves transferability of the toner particles, reduces the amount of the transfer-residual toner particles incorporated into the contact charging member, prevents deterioration in charging properties of the image-bearing member, and reduces a load during the collection of the transfer-residual toner particles in the cleaning-at-development step.

Primary particles of the inorganic fine powder have a number-average particle diameter of as small as 4 to 50 nm. Even as an agglomerated matter that is deposited on the toner, a major portion of the inorganic fine powder has a number-average particle diameter of 0.1 μm or smaller. There is no substantial effect on the number-based particle size distribution in the particle diameter range of from 0.60 μm, inclusive, to 159.21 μm, exclusive of the developer.

On the other hand, as to the conductive fine powder contained in the developer of the present invention, the primary particles have a number-average particle diameter of 50 to 500 nm, and contains an agglomerated matter of primary particles, and contribute to a proportion of the particles in a particle diameter range of from 1.00 μm, inclusive, to 2.00 μm, exclusive in the number-based particle size distribution in the particle diameter range of from 0.60 μm, inclusive, to 159.21 μm, exclusive of the developer. More specifically, the conductive fine powder contained in the developer of the present invention should have a number-average particle diameter of primary particles of 50 to 500 nm, and comprise at least agglomerated matter particles of primary particles having the particle diameter range of from 1.00 μm, inclusive, to 2.00 μm, exclusive. The above-mentioned effects of the present invention can be achieved when the conductive fine powder is contained in the developer so that the content of the particles having the particle diameter range of from 1.00 μm, inclusive, to 2.00 μm, exclusive is within the above-mentioned range.

The studies made by the present inventors have revealed that significant effects can be obtained to prevent the faulty charging of the image-bearing member due to the deposition and incorporation of the transfer-residual toner particles on and into the contact charging member during the contact charging, to improve uniform charging properties of the image-bearing member during the direct injection-based charging, and to prevent effectively the problem of insufficient collection of the transfer-residual toner particles in the image forming method using the cleaning-at-development approach, when the developer comprises the conductive fine powder having the particle diameter range of from 1.00 μm, inclusive, to 2.00 μm, exclusive, and the conductive fine powder is comprised of an agglomerated matter whose primary particles have a number-average particle diameter of 50 to 500 nm.

The major reasons why the above-mentioned effects can be achieved are: the primary particles have a number-average particle diameter of 50 to 500 nm; the agglomerated matter particles of the conductive fine powder having a particle diameter of from 1.00 μm, inclusive, to 2.00 μm, exclusive are not often deposited firmly on the surface of the toner particles; a sufficient amount of the conductive fine powder can be supplied to the image-bearing member in the developing step; the conductive fine powder is liberated readily from the surface of the toner particles in the transferring step; the conductive fine powder is supplied efficiently to the charging part through the image-bearing member after the transfer and is uniformly distributed over the charging part; and the conductive fine powder is held on the charging part in a stable manner. Therefore, the present invention provides a significant effect of enhancing the charging of the image-bearing member. By allowing closer contact with the image-bearing member of the contact charging member, deterioration of the charging properties of the image-bearing member can be prevented and good uniform charging can be maintained in a stable manner even during the repeated use of the image forming device for a long period of time. When contamination of the charging member inevitably occurs by transfer residual toner particles, as in the cleaning-at-development image forming method where the contact charging member is used in the charging step, deterioration of the charging properties of the image-bearing member can be prevented and the collectability of the transfer-residual toner particles in the cleaning-at-development step can be improved significantly.

The present inventors have studied on the conductive fine powder having agglomerated matters of the primary particles, and found that, when the developer comprises the conductive fine powder having the agglomerated matters of the primary particles; the primary particles have a number-average particle diameter of 50 to 500 nm; and when the conductive fine powder is contained in the developer so that the particles having a particle diameter in the range of from 1.00 μm, inclusive, to 2.00 μm, exclusive are contained in the developer in an amount of 15% to 60% by number (in which the conductive fine powder comprises at least the agglomerated matter particles having a particle diameter of from 1.00 μm, inclusive, to 2.00 μm, exclusive), the particles of the conductive fine powder having the above-mentioned agglomerated matters are easily liberated from the surface of the toner particles; the conductive fine powder can be supplied to the image-bearing member in a more stable manner in the developing step; in the transferring step, the conductive fine powder is easily liberated from the surface of the toner particles; and the proportion of the conductive fine powder that is left on the image-bearing member after the transfer can be increased. It has also been found that closer contact between the contact charging member and the image-bearing member can be achieved through the conductive fine powder when the particles of the conductive fine powder having the above-mentioned agglomerated matters are deposited on and incorporated into the contact charging member, allowing more uniform charging of the image-bearing member. Furthermore, it has been found that the particles of the conductive fine powder having the above-mentioned agglomerated matters play an important role as a collection aid for the transfer-residual toner particles on the image-bearing member in the cleaning-at-development step, improving the collectability of the transfer-residual toner particles on the image-bearing member.

The following is a possible reason why particles of the conductive fine powder having the above-mentioned agglomerated matters are easily liberated from the surface of the toner particles.

As compared with conductive fine powder that has a primary particle with particle size distribution equivalent to that of the conductive fine powder having the above-mentioned agglomerated matters, but that contains substantially no agglomerated matter, the conductive fine powder having the above-mentioned agglomerated matters has a lower bulk density as powder because of its voids between the primary particles or their irregular shapes. In the case where the conductive fine powder is added to the toner particles together with the inorganic fine powder whose primary particles have a number-average particle diameter of 4 to 50 nm, they are less mixed when the conductive fine powder are the conductive fine powder having the above-mentioned agglomerated matters. As a result, a deposition force of the conductive fine powder to the surface of the toner particles is reduced.

Therefore, the particles of the conductive fine powder having the agglomerated matters as described above stand a better chance of being liberated from the toner particles and present in the developer as a liberated state, so that they can be supplied more stably to the image-bearing member in the developing step. The particles of the conductive fine powder having the above-mentioned agglomerated matters that are deposited on the surface of the toner particles are more easily liberated from the surface of the toner particles. Therefore, the proportion of the conductive fine powder that is left on the image-bearing member after the transfer can be increased.

Thus, when the contact charging of the image-bearing member is performed in the presence of the conductive fine powder and the transfer-residual toner particles in the charging part, interception of charging of the image-bearing member by the transfer-residual toner particles can further be controlled with an increasing percentage content of the conductive fine powder to the transfer-residual toner particles in the developer components that are deposited on or incorporated into the contact charging member. This improves the contact between the contact charging member and the image-bearing member. Alternatively, it is possible to control increase in contact resistivity of the contact charging member on which or into which the developer components are deposited or incorporated. The charging of the image-bearing member by the contact charging member becomes better.

By using the conductive fine powder having the agglomerated matters, in the presence of the conductive fine powder in the abutting part between the image-bearing member and the contact charging member, it is expected that the number of contact points between a single particle of the conductive fine powder and the image-bearing member is increased. With such an increase in number of the contact points, closer contact of the contact charging member to the image-bearing member can be achieved through the conductive fine powder as a result of the deposition or incorporation of the particles of the conductive fine powder having the agglomerated matters on or into the contact charging member.

Using the conductive fine powder without any agglomerated matter, it is difficult to achieve a significant divergence between 1 and the number of contact points with the image-bearing member per a single particle of the conductive fine powder in the abutting part between the image-bearing member and the contact charging member in the presence of the conductive fine powder, even when point contact and surface contact are taken into consideration. For example, using conductive fine powder of spherical form particles, even when there is an ideal single layer of true spherical conductive fine powder in a charging abutting-part, the number of contact points with the image-bearing member is 1 per a single particle of the conductive fine powder. Deformed conductive fine powder particles may be used in order to increase the number of contact points with the image-bearing member per a single particle of the conductive fine powder. However, such deformed particles often cause various problems such as a possible damage of the image-bearing member, deterioration of the conductive fine powder particles, and gradual change of the triboelectric charging properties of the toner particles.

On the other hand, for the conductive fine powder whose primary particles have a number-average particle diameter of 50 to 500 nm in which the conductive fine powder includes an agglomerated matter of the primary particles, two or more contact points are achieved readily with the image-bearing member per a single particle of the conductive fine powder (agglomerated matters). Thus, closer contact can be achieved with the image-bearing member. It becomes possible to provide uniform charging by using a more uniform direct injection charging mechanism.

Furthermore, as described above, using the conductive fine powder having the agglomerated matters, the proportion of the remaining conductive fine powder to the transfer-residual toner particles is increased on the image-bearing member after the transfer. As a result, the proportion of the conductive fine powder serving as a collection aid for the transfer-residual toner particles is increased also on the image-bearing member in the cleaning-at-development step to collect the transfer-residual toner particles. Therefore, the transfer-residual toner particles can be collected more reliably. In addition, the particles of the conductive fine powder having the above-mentioned agglomerated matters play a significantly important role as the collection aid for the transfer-residual toner particles on the image-bearing member in the cleaning-at-development step. They exhibit more remarkable effects of improving the collectability of the transfer-residual toner particles on the image-bearing member.

The primary particles of the conductive fine powder having the above-mentioned agglomerated matters should have a number-average particle diameter of 50 to 500 nm. The above-mentioned effects can be obtained when the number-average particle diameter of the primary particles of the conductive fine powder is within the above-mentioned range, and when the particles having particle diameters in the range of from 1.00 μm, inclusive, to 2.00 μm, exclusive are contained in the developer in an amount of 15% to 60% by number. When the number-average particle diameter of the primary particles of the conductive fine powder is excessively larger than the above-mentioned range, the above-mentioned effects of the conductive fine powder having the agglomerated matters are not so much exhibited. It is substantially identical to the case where the conductive fine powder containing no agglomerated matters is added to the developer. Only insufficient effects are obtained in enhancing the charging of the image-bearing member and improving the collectability of the transfer-residual toner particles upon the cleaning-at-development step. On the other hand, when the number-average particle diameter of the primary particles of the conductive fine powder is too smaller than the above-mentioned range, there are an increasing number of unagglomerated primary particles. Otherwise, the number of the primary particles is increased that are liberated from the agglomerated matters. Consequently, the triboelectric charging properties of the developer are significantly deteriorated or reduced.

Based on the studies made by the present inventors, it is necessary for the developer to comprise 15% to 60% by number of particles having particle diameters in the range of from 1.00 μm, inclusive, to 2.00 μm, exclusive, in number-based particle size distribution of particles having particle diameters in the range of from 0.60 μm. inclusive, to 159.21 μm, exclusive. It is possible to improve the uniform charging properties of the image-bearing member in the charging step by means of containing the above-mentioned amount of the particles having particle diameters in the range of from 1.00 μm, inclusive, to 2.00 μm, exclusive in the above-mentioned particle diameter measurement range. An appropriate amount of the conductive fine powder can be maintained in the charging part in a stable manner. Therefore, in a subsequent exposing step, it is possible to prevent faulty exposure which otherwise would occur because of an excessive amount of the conductive fine powder on the image-bearing member. When the developer comprises less than 15% by number of the particles having particle diameters in the range of from 1.00 μm, inclusive, to 2.00 μm, exclusive, it is impossible to improve the uniform charging properties of the image-bearing member by the contact charging. In addition, the problem of the insufficient collection of the transfer-residual toner particles during the cleaning-at-development step cannot be solved at a satisfactory level. On the other hand, when the developer comprises more than 60% by number of the particles having particle diameters in the range of from 1.00 μm, inclusive, to 2.00 μm, exclusive, an excessive amount of the conductive fine powder is supplied to the charging part. The conductive fine powder is liberated on the image-bearing member without being held by the charging part and obstructs exposure light beams. This causes a defect of images due to the faulty exposure. Alternatively, the conductive fine powder is often scattered and pollute inside the machine.

It is preferable that the developer comprises 20% to 50% by number, more preferably, 20% to 45% by number, of particles having particle diameters in the range of from 1.00 μm, inclusive, to 2.00 μm, exclusive, in number-based particle size distribution of particles having particle diameters in the range of from 0.60 μm, inclusive, to 159.21 μm, exclusive. The amount of the above-mentioned particles contained in the developer in this range improves the uniform charging properties of the image-bearing member by the contact charging and effectively prevents insufficient collection of the transfer-residual toner particles in the image forming method using the cleaning-at-development approach. Furthermore, it prevents the conductive fine powder from being supplied to the charging part in an excessive amount. Thus, a defect of images due to the faulty exposure can be controlled more reliably which otherwise would occur as a result of releasing of a large amount of conductive fine powder that cannot be held by the charging part to the image-bearing member.

In order to contain 15% to 60% by number of particles having particle diameters in the range of from 1.00 μm, inclusive, to 2.00 μm, exclusive, in number-based particle size distribution of particles having particle diameters in the range of from 0.60 μm, inclusive, to 159.21 μm, exclusive, in the developer of the present invention, it is preferable as described above that the developer contains the conductive fine powder so that the particles having particle diameters in the range of from 1.00 μm, inclusive, to 2.00 μm, exclusive are within the above-mentioned range. However, the particles contained in the developer with particle diameters in the range of from 1.00 μm, inclusive, to 2.00 μm, exclusive, in number-based particle size distribution of particles having particle diameters in the range of from 0.60 μm, inclusive, to 159.21 μm, exclusive, are not limited to the above-mentioned conductive fine powder. The toner particles and other particles added to the developer may be included.

The toner particles in the developer of the present invention may be obtained by means of a known production method. The amount of ultrafine particles of from 1.00 μm, inclusive, to 2.00 μm, exclusive varies depending on, for example, a toner production method and manufacturing conditions. However, the toner particles preferably comprise 0% to 15% by number of particles having particle diameters in the range of from 1.00 μm, inclusive, to 2.00 μm, exclusive in number-based particle size distribution of particles having particle diameters in the range of from 0.60 μm, inclusive, to 159.21 μm, exclusive, of the toner particles. It is more preferable that the toner particles comprise 0% to 10% by number of such particles. When the toner particles comprise particles having particle diameters in the range of from 1.00 μm, inclusive, to 2.00 μm, exclusive, in number-based particle size distribution of particles having particle diameters in the range of from 0.60 μm, inclusive, to 159.21 μm, exclusive in excess of the above-mentioned range, the triboelectric charging properties of the toner particles having such a particle diameter significantly differ from the triboelectric charging properties of the toner particles whose particle diameter is around the average particle diameter. This broadens the triboelectrical charge distribution and deteriorate developability of the toner, sometimes making the developer unsuitable for practical applications.

The developer of the present invention comprises 15% to 70% by number of particles having particle diameters in the range of from 3.00 μm, inclusive, to 8.96 μm, exclusive, in number-based particle size distribution of particles having particle diameters in the range of from 0.60 μm, inclusive, to 159.21 μm, exclusive.

In the developer of the present invention, the particles having the particle diameters in the range of from 3.00 μm, inclusive, to 8.96 μm, exclusive, are advantageous particles in terms of developing an electrostatic latent image formed on the image-bearing member to form a toner image and transferring it to the transfer material to form an image on the transfer material. Thus, a predetermined amount of such particles is required. More specifically, the particles having particle diameters in the range of from 3.00 μm, inclusive, to 8.96 μm, exclusive may have good triboelectric charging properties that are suitable for adhering electrostatically to the electrostatic latent image formed on the image-bearing member and developing the electrostatic latent image faithfully and exactly into the toner image.

The particles having a particle diameter of smaller than 3.00 μm would be a cause of excessive charging or excessive attenuation of the triboelectric charging. It is difficult for such particles to have stable triboelectric charging properties. Such particles are easily deposited in an excessive amount on the portion of the image-bearing member where no the electrostatic latent image is formed (white background). Faithful development of the electrostatic latent image can hardly be obtained accordingly. The particles having a particle diameter of smaller than 3.00 μm cannot provide a satisfactory transferability to a transfer material such as paper that has irregular surface formed of fibers. Consequently, the transfer-residual toner particles are increased. A large amount of the transfer-residual toner particles is deposited on the image-bearing member at the beginning of the charging step. Then, a large amount of the transfer-residual toner particles is deposited on and incorporated into the contact charging member. As a result, charging of the image-bearing member is obstructed. An effect of the present invention that improves the charging properties of the image-bearing member, as obtained from the contact charging member having a close contact with the image-bearing member through the conductive fine powder, cannot be achieved. With the transfer-residual toner particles having a smaller particle diameter, magnetic collective force becomes small when mechanical, electrostatical, or magnetic toner acts on the transfer-residual toner particles. A relative adhesion between the transfer-residual toner particles and the image-bearing member becomes large, which deteriorates collectability of the transfer-residual toner particles in the developing step. Consequently, a defect of images such as positive ghost and fog is brought about due to the insufficient collection of the transfer-residual toner particles.

With the particles having a particle diameter of 8.96 μm or larger, it is difficult to provide sufficiently high triboelectric charging properties to develop an electrostatic latent image exactly and faithfully into a toner image. The resulting resolving power typically becomes smaller as the particle diameter of the developer becomes larger. In the developer of the present invention that comprises the conductive fine powder so that the developer comprises the particles having particle diameters in the range of from 1.00 μm, inclusive, to 2.00 μm, exclusive in an amount within the predetermined range, the developer comprises many particles of the conductive fine powder. Triboelectric charging tends to be deteriorated particularly in the toner particles having a larger particle diameter. It is difficult for the particles having a particle diameter of 8.96 μm or larger to have high triboelectric charging properties that are enough to develop an electrostatic latent image exactly and faithfully into a toner image.

Taking the above into consideration, by means of making the content of the particles having particle diameters in the range of from 3.00 μm, inclusive, to 8.96 μm, exclusive, in number-based particle size distribution of particles having particle diameters in the range of from 0.60 μm, inclusive, to 159.21 μm, exclusive, be within the above-mentioned range, it is possible to provide the toner particles having the triboelectric charging properties that are suitable to develop an electrostatic latent image exactly and faithfully into a toner image. Using the developer of the present invention that comprises the conductive fine powder so that the developer comprises the particles having particle diameters in the range of from 1.00 μm, inclusive, to 2.00 μm, exclusive in an amount within the predetermined range, it becomes possible to provide an image that is superior in resolving power at a high image density.

In the present invention, when the developer comprises the particles having particle diameters in the range of from 3.00 μm, inclusive, to 8.96 μm, exclusive in an amount of less than 15% by number, it is difficult to provide the toner particles with the triboelectric charging properties that are suitable to develop an electrostatic latent image exactly and faithfully into a toner image. Consequently, the resulting images contain much fog at a low image density or low resolution.

When the developer comprises more than 70% by number of the particles having particle diameters in the range of from 3.00 μm, inclusive, to 8.96 μm, exclusive, it becomes difficult to contain the particles having the above-mentioned particle diameters in the range of from 1.00 μm, inclusive, to 2.00 μm, exclusive in the developer in an amount within the predetermined range. Even though the particles having particle diameters in the range of from 1.00 μm, inclusive, to 2.00 μm, exclusive are contained in the developer in an amount within the predetermined range, the amount of the particles having particle diameters in the range of from 1.00 μm, inclusive, to 2.00 μm, exclusive is insufficient relative to the amount of the particles having particle diameters in the range of from 3.00 μm, inclusive, to 8.96 μm, exclusive. Therefore, it is impossible to improve sufficiently the uniform charging properties of the image-bearing member by the contact charging. Only an inadequate effect is obtained against the insufficient collection of the transfer-residual toner particles in the cleaning-at-development step.

It is preferable that the developer of the present invention comprises 20% to 65% by number of particles having particle diameters in the range of from 3.00 μm, inclusive, to 8.96 μm, exclusive, in number-based particle size distribution of particles having particle diameters in the range of from 0.60 μm, inclusive, to 159.21 μm, exclusive. It is more preferable that the developer comprises 25% to 60% by number of such particles. The content of the above-mentioned particles within this range further improves the uniform charging properties of the image-bearing member by the contact charging, enhances an effect of advantageously preventing the insufficient collection of the transfer-residual toner particles in the image forming method using the cleaning-at-development approach, and provides an image that is superior in resolution at a high image density, with less or no fog.

As described above, in order to provide the particles with the triboelectric charging properties that are suitable to develop an electrostatic latent image exactly and faithfully into a toner image, and to obtain an image that is superior in resolution at a high image density, with less or no fog, the developer of the present invention comprises 15% to 70% by number of particles having particle diameters in the range of from 3.00 μm, inclusive, to 8.96 μm, exclusive, in number-based particle size distribution of particles having particle diameters in the range of from 0.60 μm, inclusive, to 159.21 μm, exclusive. Therefore, it is desirable that the toner particles be responsible for the content of the particles having particle diameters in the range of from 3.00 μm, inclusive, to 8.96 μm, exclusive in the developer. However, the particles contained in the developer with the particle diameters in the range of from 3.00 μm, inclusive, to 8.96 μm, exclusive, in number-based particle size distribution of particles having particle diameters in the range of from 0.60 μm, inclusive, to 159.21 μm, exclusive, are not limited to the toner particles. The conductive fine powder and other particles added to the developer may be included.

It is preferable that the developer of the present invention comprises 0% to 20% by number of the particles having a particle diameter of 8.96 μm or larger, in number-based particle size distribution of particles having particle diameters in the range of from 0.60 μm, inclusive, to 159.21 μm, exclusive.

As described above, it is difficult for the particles having a particle diameter of 8.96 μm or larger to have high triboelectric charging properties that are enough to develop an electrostatic latent image exactly and faithfully into a toner image in the developer comprising the conductive fine powder so that the developer comprises the particles having particle diameters in the range of from 1.00 μm, inclusive, to 2.00 μm, exclusive in an amount within the predetermined range, because the developer comprises a large number of particles of the conductive fine powder. When the developer comprises more than 20% by number of the particles having a particle diameter of 8.96 μm or larger in the above-mentioned particle diameter measurement range, it is difficult for the developer as a whole to have high triboelectric charging properties that are enough to develop an electrostatic latent image exactly and faithfully into a toner image. Resulting images have low resolution.

The toner particles having a large particle diameter often become a cause of faulty charging of the image-bearing member when brought into the charging part as the transfer-residual toner particles. These particles impair contact between the contact charging member and the image-bearing member. An effect of the present invention, which is obtained through the close contact between the contact charging member and the image-bearing member through the conductive fine powder, cannot be achieved accordingly. Furthermore, an attempt to collect the transfer-residual toner particles having a large particle diameter in the developing step often results in shutout of the exposure light beams in the latent image forming step. Thus, the transfer-residual toner particles having a large particle diameter are not collected and cause a defect of images.

As apparent from the above, it is preferable that the developer of the present invention comprises 0% to 20% by number, more preferably, 0% to 10% by number, and most preferably, 0% to 7% by number of the particles having a particle diameter of 8.96 μm or larger, in number-based particle size distribution of particles having particle diameters in the range of from 0.60 μm, inclusive, to 159.21 μm, exclusive. The content of the above-mentioned particles within this range produces an image that is superior in resolving power at a high image density, with less or no fog.

Let A be the content (% by number) of the particles having particle diameters in the range of from 1.00 μm, inclusive, to 2.00 μm, exclusive, in the developer and B be the content (% by number) of the particles having particle diameters in the range of from 2.00 μm, inclusive, to 3.00 μm, exclusive, in the developer, in number-based particle size distribution of particles having particle diameters in the range of from 0.60 μm, inclusive, to 159.21 μm, exclusive, then the developer of the present invention preferably satisfies the relationship:

A>B,

and more preferably, the developer satisfies the relationship:

A>2B.

It is preferable that the content B (% by number) of the particles having particle diameters in the range of from 2.00 μm, inclusive, to 3.00 μm, exclusive is less than the content A (% by number) of particles having particle diameters in the range of from 1.00 μm, inclusive, to 2.00 μm, exclusive. When the number-based particle size distribution of the developer of the present invention satisfies the above-mentioned relationship in the measured particle diameter range of from 0.60 μm, inclusive, to 159.21 μm, exclusive, the conductive fine powder is more uniformly distributed in the charging part. Closer contact with the image-bearing member can be obtained while overcoming the obstruction of charging of the image-bearing member due to the transfer-residual toner particles in the charging part. Accordingly, good uniform charging properties can be achieved. An effect of the conductive fine powder on the image-bearing member in the cleaning-at-development step as an transfer aid for the transfer-residual toner particles can be enhanced when the number-based particle size distribution of the developer in the above-mentioned measurement particle diameter range satisfies the above-mentioned relationship. When the content A (% by number) of the particles having particle diameters in the range of from 1.00 μm, inclusive, to 2.00 μm, exclusive in the developer is not higher than the content B (% by number) of the particles having particle diameters in the range of from 2.00 μm, inclusive, to 3.00 μm, exclusive, in the developer, uniform dispersibility of conductive fine powder (conductive fine powder in a charging region of the contact charging member when the conductive fine powder is deposited on or incorporated into the contact charging member) present in the charging part is deteriorated to cause possible reduction in charge uniformizing effects and charging-accelerating effects of the image-bearing member. Accordingly, an effect of the conductive fine powder as a transfer aid for the transfer-residual toner particles cannot be improved.

From these points of view, it is preferable that the content A (% by number) of the particles having particle diameters in the range of from 1.00 μm,, inclusive, to 2.00 μm, exclusive is more than the content B (% by number) of the particles having particle diameters in the range of from 2.00 μm, inclusive, to 3.00 μm, exclusive. It is more preferable that the content A (% by number) of the particles having particle diameters in the range of from 1.00 μm, inclusive, to 2.00 μm, exclusive is at least twice as much as the content B (% by number) of the particles having particle diameters in the range of from 2.00 μm, inclusive, to 3.00 μm, exclusive.

The developer of the present invention has, in the particle diameter range of from 3.00 μm, inclusive, to 15.04 μm, exclusive, in number-based particle size distribution of particles having particle diameters in the range of from 0.60 μm, inclusive, to 159.21 μm, exclusive, a variation coefficient of number distribution, Kn of 5 to 40 given by the following equation:

Kn=(Sn/D1)×100

wherein, Sn represents a standard deviation of number distribution of particles having particle diameters in the range of from 3.00 μm, inclusive, to 15.04 μm, exclusive, and D1 represents a number-based average circle-corresponding diameter (μm) of particles having particle diameters in the range of from 3.00 μm, inclusive, to 15.04 μm, exclusive.

A standard deviation of number distribution, Sn can be given by the following equation:

Sn={Σ(dnᵢ−D1)²/n}^{1/2}

wherein, dnᵢ represents a circle-corresponding diameter of each particle in the particle diameter range of from 3.00 μm, inclusive, to 15.04 μm, exclusive, D1 represents a number-based average circle-corresponding diameter (μm) of particles having particle diameters in the range of from 3.00 μm, inclusive, to 15.04 μm, and n represents the number of total particles having particle diameters in the range of from 3.00 μm, inclusive, to 15.04 μm, exclusive.

With the above-mentioned variation coefficient Kn of 5 to 40, it becomes possible to provide more uniform mixability between the toner particles and the inorganic fine powder, and the charge distribution of the toner particles is narrowed. This reduces the amount of the toner particles that would be a cause of the fog. The transferability is improved and the number of the transfer-residual toner particles is reduced that are brought into the charging part. The obstruction of charging in the image-bearing member can be controlled in a more stable manner. The collection of the transfer-residual toner particles in the cleaning-at-development step also becomes stable, so that a defect of images due to insufficient collection can be controlled more reliably. In order to further narrow the charge distribution of the toner particles, it is more preferable that the above-mentioned variation coefficient Kn is 5 to 30.

In the developer of the present invention, it is preferable that the developer has a volume-average particle diameter of 4 to 10 μm when measured from volume-based particle size distribution of particles having particle diameters in the range of from 0.60 μm, inclusive, to 159.21 μm, exclusive. It is preferable that, in the particle diameter range of from 3.00 μm, inclusive, to 15.04 μm, exclusive, a variation coefficient of volume distribution, Kv is 10 to 30 given by the following equation:

Kv=(Sv/D3)×100

wherein Sv represents a standard deviation of volume distribution of particles having particle diameters in the range of from 3.00 μm, inclusive, to 15.04 μm, exclusive, and D3 represents a volume-based volume-average particle diameter (μm) of particles having particle diameters in the range of from 3.00 μm, inclusive, to 15.04 μm, exclusive.

A standard deviation of volume distribution, Sv can be given by the following equation:

Sv={Σ(dvᵢ−D3)²/n}^{1/2}

wherein, dvᵢ represents a volume diameter of each particle in the particle diameter range of from 3.00 μm, inclusive, to 15.04 μm, exclusive, D3 represents a volume-based volume-average particle diameter of particles having particle diameters in the range of from 3.00 μm, inclusive, to 15.04 μm, exclusive, and n represents the number of total particles in the particle diameter range of from 3.00 μm, inclusive, to 15.04 μm, exclusive.

When the developer has a volume-average particle diameter of smaller than 4 μm, uniform mixture is hardly obtained between the inorganic fine powder and the conductive fine powder. This means that a stable effect of enhancing the charging of the image-bearing member is hardly obtained. The collectability of the transfer-residual toner particles in the cleaning-at-development step tends to be deteriorated. When the developer has a volume-average particle diameter of larger than 10 μm, with the addition of the conductive fine powder in an amount that is necessary for obtaining a stable effect of enhancing the charging of the image-bearing member, a sufficient level of triboelectric charge on the developer cannot be obtained under a highly humid environment. Consequently, the image density may be degraded and the fog may be increased, adversely affecting the image quality. The amount of the transfer-residual toner particles may be significantly increased. This may obstruct the charging properties of the image-bearing member. Collection yields of the transfer-residual toner particles in the cleaning-at-development step tend to be decreased. From the above points of view, it is preferable that the developer has a volume-average particle diameter of 3.5 to 9 μm.

With the volume-based variation coefficient (Kv) of the developer being 10 to 30 over the particle diameter range of from 3.00 μm, inclusive, to 15.04 μm, exclusive, the charge distribution of the toner particles is narrowed over the particle diameter range of from 3.00 μm, inclusive, to 15.04 μm, exclusive. This reduces the amount of the toner particles and transfer-residual toner particles that would be a cause of the fog. The obstruction of charging in the image-bearing member can be controlled in a more stable manner. It is possible to increase collection yields of the transfer-residual toner particles in the cleaning-at-development step, thereby to effectively prevent a defect of images due to insufficient collection. It is more preferable that the above-mentioned variation coefficient Kv is 15 to 25.

It is preferable that the developer of the present invention comprises, in the particle diameter range of from 3.00 μm, inclusive, to 15.04 μm, exclusive, 90% to 100% by number of the particles having a circularity (a) of 0.90 or more as determined by the equation given below. It is more preferable that the developer comprises 93% to 100% by number of the particles having a circularity (a) of 0.90 or more in the particle diameter range of from 3.00 μm, inclusive, to 15.04 μm, exclusive.

Circularity (a)=L₀/L

wherein L₀ represents a circumferential length of a circle with the same area as a particle projection image, and L represents a circumferential length of a particle projection image.

Based on the studies made by the present inventors, the circularity (a) of the particles in the developer in the particle diameter range of from 3.00 μm, inclusive, to 15.04 μm, exclusive, is significantly associated with the supply of the conductive fine powder to the charging part. In the developer that comprises a larger amount of the particles having particle diameters in the range of from 3.00 μm, inclusive, to 15.04 μm, exclusive, and a high circularity, the conductive fine powder is easily liberated from the toner particles. Therefore, the conductive fine powder can be supplied more advantageously to the charging part, and it is possible to provide good uniform charging of the image-bearing member in a stable manner during the repeated use of the image forming device for a long period of time.

Of the particles having particle diameter in the range of from 3.00 μm, inclusive, to 15.04 μm, exclusive, some particles have a deformed shape. With such deformed particles, the conductive fine powder particles difficult to be liberated. Thus, in the developer comprising a higher ratio of the deformed particles having particle diameters in the range of from 3.00 μm, inclusive, to 15.04 μm, exclusive, less conductive fine powder particles are supplied to the charging part. An effect of enhancing the charge of the image-bearing member is deteriorated during the repeated use of the image forming device for a long period of time. It may become difficult to maintain good uniform charging in a stable manner. When the conductive fine powder is deposited on the deformed particles having particle diameters in the range of from 3.00 μm, inclusive, to 15.04 μm, exclusive, and is brought into the charging part, it is not stably kept in the charging part. Only a very slight effect of enhancing the charging of the image-bearing member can be obtained. It has been found that the conductive fine powder is supplied to the charging part smoothly and stably by means of reducing the number of the particles having a low circularity, of the particles in the developer having particle diameters in the range of from 3.00 μm, inclusive, to 15.04 μm, exclusive.

The particles having a high circularity in particle diameter range of from 3.00 μm, inclusive, to 15.04 μm, exclusive have smaller adhesion to the image-bearing member. They are superior in transferability and are also superior in collectability of the particles in the cleaning-at-development step. Furthermore, as described above, the conductive fine powder is easily liberated from the toner particles, so that the conductive fine powder liberated from the toner particles, which serves as the collection aid for the transfer-residual toner particles, is supplied to the image-bearing member more advantageously. From these points of view, collectability of the transfer-residual toner particles in the cleaning-at-development step can be increased. When the developer comprises a large number of particles having a high circularity, of the particles having particle diameters in the range of from 3.00 μm, inclusive, to 15.04 μm, exclusive, it is possible to control, in a more stable manner, a defect of images due to insufficient collection of the toner particles in the cleaning-at-development step.

With the toner particles having a particle diameter of smaller than 3 μm, there is only a weak interrelation between the shape of the toner particles and releasability of the conductive fine powder in the above-mentioned particle diameter range from the toner particles. The toner particles having a particle diameter of smaller than 3 μm are inferior in transferability regardless of the shape of the toner particles. They are often left on the image-bearing member as the transfer-residual toner particles.

As a result of further studies, when, of the particles of the developer having particle diameters in the range of from 3.00 μm, inclusive, to 15.04 μm, exclusive particles, the particles having a circularity (a) of 0.90 or more are contained in an amount of 90% to 100% by number, they are brought into the charging part, uniformly distributed, and kept in a stable manner. An effect of enhancing the charging of the image-bearing member is exhibited. The conductive fine powder having a particle diameter in a particle diameter range that provides a better effect of enhancing the collectability of the transfer-residual toner particles is easily liberated from the toner particles. It can be supplied to the charging part in a more stable manner. It is possible to maintain good uniform charging of the image-bearing member in a more stable manner during the repeated use of the image forming device for a long period of time. It has also been found that the obstruction of charging of the image-bearing member due to the transfer-residual toner particles can be controlled further. As to the collectability of the toner particles in the cleaning-at-development step, an effect as the collection aid for the transfer-residual toner particles is fully exhibited because the conductive fine powder is supplied to the image-bearing member more stably after the transferring step. Thus, it has been found that better transfer-residual toner particles collectability can be obtained.

It is preferable that the developer of the present invention comprises, in the particles of the developer over the particle diameter range of from 3.00 μm, inclusive, to 15.04 μm, exclusive, 93% to 100% by number of the particles having a circularity (a) of 0.90 or more. With 93% to 100% by number of the particles having the above-mentioned circularity (a) of 0.90 or more, the conductive fine powder is supplied more stably to the charging part. A better effect of enhancing the charging of the image-bearing member can be obtained. In the formation of the images based on a cleanerless technique, the collectability of the transfer-residual toner particles can be improved.

The particles in the developer having particle diameters in the range of from 3.00 μm, inclusive, to 15.04 μm, exclusive mainly comprise the toner particles. However, the particles in this range are not limited to the toner particles. A portion of the particles may be the conductive fine powder or other additives while providing similar tendency to the cases where the toner particles are used, in terms of the releasability of the conductive fine powder having a particle diameter with which an effect of the present invention relating to the particle shape can be obtained.

It is preferable that the developer of the present invention has, in the particle diameter range of from 3.00 μm, inclusive, to 15.04 μm, exclusive, a standard deviation SD of circularity distribution of not larger than 0.045 given by the following equation:

SD={Σ(aᵢ−aₘ)²/n}^{1/2}

wherein, aᵢ represents a circularity of each particle in the particle diameter range of from 3.00 μm, inclusive, to 15.04 μm, exclusive, am represents an average circularity of the particles in the particle diameter range of from 3.00 μm, inclusive, to 15.04 μm, and n represents the number of total particles in the particle diameter range of from 3.00 μm, inclusive, to 15.04 μm, exclusive.

With the developer having the above-mentioned standard deviation SD of circularity distribution not larger than 0.045, the conductive fine powder is liberated more stably from the toner particles, and the conductive fine powder is supplied to the image-bearing member more stably. Therefore, it is possible to control the obstruction of charging of the image-bearing member in a more stable manner. The toner particles can be collected more stably in the cleaning-at-development step.

In the present invention, the content of particles in a certain particle diameter range, a variation coefficient of particle size distribution in a certain particle diameter range, an average particle diameter, the content of particles having a certain circularity in a certain particle diameter range, and a standard deviation of circularity distribution in a certain particle diameter range, of the developer are measured by using particle size distribution and circularity distribution in the particle diameter range of from 0.60 μm, inclusive, to 159.21 μm, exclusive, in which the circle-corresponding diameter measured by using a flow type particle image analyzer FPIA-1000 (TOA Medical Electronics Co., Ltd., currently Sysmex Corporation) is defined as the “particle diameter”.

For measurements by using a flow type particle image analyzer, several drops of surfactant (preferably alkylbenzene sulfonate) are added to 50 ml of water from which solid impurities are removed in advance through a filter in such a manner that 20 or less particles in the measurement range (e.g., circle-corresponding diameter from 0.60 μm, inclusive, to 159.21 μm, exclusive) are contained in 10³ cm³ of water. An adequate amount (e.g., 2 to 50 mg) of sample to be measured is added and dispersed by means of an ultrasonic disperser for 3 minutes. Using a sample fluid dispersion containing 8,000 to 10,000 particles to be measured per 10³ cm³ (for the particles in the measured circle-corresponding diameter range), the particle size distribution and the circularity distribution are measured for the particles having a circle-corresponding diameter of from 0.60 μm, inclusive, to 159.21 μm, exclusive.

Details of the measurement are found in a technical brochure of FPIA-1000 published by TOA Medical Electronics Co., Ltd. in June, 1995, an operation manual of a measurement device, and Japanese Patent Application Laid-Open No. 8-136439. Briefly, the measurement is made as follows.

A sample fluid dispersion is passed through a flat and thin, transparent flow cell (thickness: approximately 200 μm) having a divergent flow path. A strobe and a CCD camera are disposed at mutually opposite positions with respect to the flow cell so as to form an optical path across the thickness of the flow cell. During the flow of the sample dispersion, the strobe is flashed at intervals of 1/30 seconds each to capture images of particles passing through the flow cell. As a result, each particle provides a two dimensional image having a certain area parallel to the flow cell. From the area of the two-dimensional image of each particle, a diameter of a circle with the same area is determined as a circle-corresponding diameter. From the two-dimensional image of each particle, a circumferential length of a circle with the same area as the particle projection image and a circumferential length of a particle image are determined. Calculation of a ratio of them provides a circularity of each particle. Measurements (frequency % and cumulative % of the particle size distribution and the circularity distribution) may be given for 226 channels (as shown in the following Table 1; one octave is divided into 30 channels) over the range of 0.06 to 400 μm. In practice, the particles are subjected to measurement over the range where the circle-corresponding diameter is from 0.60 μm, inclusive, to 159.21 μm, exclusive.

TABLE 1

| Particle | Particle | Particle | Particle |
|---|---|---|---|
| diameter | diameter | diameter | diameter |
| range (μm) | range (μm) | range (μm) | range (μm) |
| 0.60-0.61 | 3.09-3.18 | 15.93-16.40 | 82.15-84.55 |
| 0.61-0.63 | 3.18-3.27 | 16.40-16.88 | 84.55-87.01 |
| 0.63-0.65 | 3.27-3.37 | 16.88-17.37 | 87.01-89.55 |
| 0.65-0.67 | 3.37-3.46 | 17.37-17.88 | 89.55-92.17 |
| 0.67-0.69 | 3.46-3.57 | 17.88-18.40 | 92.17-94.86 |
| 0.69-0.71 | 3.57-3.67 | 18.40-18.94 | 94.86-97.63 |
| 0.71-0.73 | 3.67-3.78 | 18.94-19.49 | 97.63-100.48 |
| 0.73-0.75 | 3.78-3.89 | 19.49-20.06 | 100.48-103.41 |
| 0.75-0.77 | 3.89-4.00 | 20.06-20.65 | 103.41-106.43 |
| 0.77-0.80 | 4.00-4.12 | 20.65-21.25 | 106.43-109.53 |
| 0.80-0.82 | 4.12-4.24 | 21.25-21.87 | 109.53-112.73 |
| 0.82-0.84 | 4.24-4.36 | 21.87-22.51 | 112.73-116.02 |
| 0.84-0.87 | 4.36-4.49 | 22.51-23.16 | 116.02-119.41 |
| 0.87-0.89 | 4.49-4.62 | 23.16-23.84 | 119.41-122.89 |
| 0.89-0.92 | 4.62-4.76 | 23.84-24.54 | 122.89-126.48 |
| 0.92-0.95 | 4.76-4.90 | 24.54-25.25 | 126.48-130.17 |
| 0.95-0.97 | 4.90-5.04 | 25.25-25.99 | 130.17-133.97 |
| 0.97-1.00 | 5.04-5.19 | 25.99-26.75 | 133.97-137.88 |
| 1.00-1.03 | 5.19-5.34 | 26.75-27.53 | 137.88-141.90 |
| 1.03-1.06 | 5.34-5.49 | 27.53-28.33 | 141.90-146.05 |
| 1.06-1.09 | 5.49-5.65 | 28.33-29.16 | 146.05-150.31 |
| 1.09-1.12 | 5.65-5.82 | 29.16-30.01 | 150.31-154.70 |
| 1.12-1.16 | 5.82-5.99 | 30.01-30.89 | 154.70-159.21 |
| 1.16-1.19 | 5.99-6.16 | 30.89-31.79 | 159.21-163.86 |
| 1.19-1.23 | 6.16-6.34 | 31.79-32.72 | 163.86-168.64 |
| 1.23-1.28 | 6.34-6.53 | 32.72-33.67 | 168.64-173.56 |
| 1.28-1.30 | 6.53-6.72 | 33.67-34.65 | 173.56-178.63 |
| 1.30-1.34 | 6.72-6.92 | 34.65-35.67 | 178.63-183.84 |
| 1.34-1.38 | 6.92-7.12 | 35.67-36.71 | 183.84-189.21 |
| 1.38-1.42 | 7.12-7.33 | 36.71-37.78 | 189.21-194.73 |
| 1.42-1.46 | 7.33-7.54 | 37.78-38.88 | 194.73-200.41 |
| 1.46-1.50 | 7.54-7.76 | 38.88-40.02 | 200.41-206.26 |
| 1.50-1.55 | 7.76-7.99 | 40.02-41.18 | 206.26-212.28 |
| 1.55-1.59 | 7.99-8.22 | 41.18-42.39 | 212.28-218.48 |
| 1.59-1.64 | 8.22-8.46 | 42.39-43.62 | 218.48-224.86 |
| 1.64-1.69 | 8.46-8.71 | 43.62-44.90 | 224.86-231.42 |
| 1.69-1.73 | 8.71-8.96 | 44.90-46.21 | 231.42-238.17 |
| 1.73-1.79 | 8.96-9.22 | 46.21-47.56 | 238.17-245.12 |
| 1.79-1.84 | 9.22-9.49 | 47.56-48.94 | 245.12-252.28 |
| 1.84-1.89 | 9.49-9.77 | 48.94-50.37 | 252.28-259.64 |
| 1.89-1.95 | 9.77-10.05 | 50.37-51.84 | 259.64-267.22 |
| 1.95-2.00 | 10.05-10.35 | 51.84-53.36 | 267.22-275.02 |
| 2.00-2.08 | 10.35-10.65 | 53.36-54.91 | 275.02-283.05 |
| 2.08-2.12 | 10.65-10.96 | 54.91-56.52 | 283.05-291.31 |
| 2.12-2.18 | 10.96-11.28 | 56.52-58.17 | 291.31-299.81 |
| 2.18-2.25 | 11.28-11.61 | 58.17-59.86 | 299.81-308.56 |
| 2.25-2.31 | 11.61-11.95 | 59.86-61.61 | 308.56-317.56 |
| 2.31-2.38 | 11.95-12.30 | 61.61-63.41 | 317.56-326.83 |
| 2.38-2.45 | 12.30-12.66 | 63.41-65.26 | 326.83-336.37 |
| 2.45-2.52 | 12.66-13.03 | 65.26-67.16 | 336.37-346.19 |
| 2.52-2.60 | 13.03-13.41 | 67.16-69.12 | 346.19-356.29 |
| 2.60-2.67 | 13.41-13.80 | 69.12-71.14 | 356.29-366.69 |
| 2.67-2.75 | 13.80-14.20 | 71.14-73.22 | 366.69-377.40 |
| 2.75-2.83 | 14.20-14.62 | 73.22-75.36 | 377.40-388.41 |
| 2.83-2.91 | 14.62-15.04 | 75.36-77.56 | 388.41-400.00 |
| 2.91-3.00 | 15.04-15.48 | 77.56-79.82 | |
| 3.00-3.09 | 15.48-15.93 | 79.82-82.15 | |

*) Each particle diameter does not include the corresponding upper limit.

In the measurement device FPIA-1000 that is used in the present invention, the measured circularity of the individual particles is divided into 61 classes in the circularity range of from 0.40 to 1.00 after the calculation of the circularity of each particle in order to obtain an average circularity. A central value of circularity and frequency of particles are used to provide an average circularity. The average circularity value that is obtained according to this method is substantially identical to an average circularity value obtained as an arithmetic mean of circularity values for individual particles. A difference, if any, is substantially negligible. In the present invention, such a calculation method may be used by the considerations of handling of data in order to reduce calculation time or simplify arithmetic equations.

It is preferable that the developer of the present invention contains 5 to 300 particles of the conductive fine powder having a particle diameter of 0.6 to 3 μm per 100 toner particles. Such particles of the conductive fine powder having a particle diameter of 0.6 to 3 μm may readily be liberated from the toner particles. They are uniformly deposited on and stably retained by the charging member. Accordingly, with the developer comprising 5 to 300 particles of the conductive fine powder with a particle diameter of 0.6 to 3 μm per 100 toner particles, the supply of the conductive fine powder to the image-bearing member is further promoted in the developing step and the transferring step. The charging properties of the image-bearing member can thus be uniformed in a more stable manner. Furthermore, with the developer comprising 5 to 300 particles of the conductive fine powder with a particle diameter of 0.6 to 3 μm per 100 toner particles, the collectability of the transfer-residual toner particles can be stabilized further in the cleaning-at-development step.

When the particles of the conductive fine powder having a particle diameter of 0.6 to 3 μm are the particles of the conductive fine powder whose primary particles have a number-average particle diameter of 50 to 500 nm, and which contain an agglomerated matter of the primary particles, they are retained on the contact charging member more stably. Therefore, it is possible to further uniformize the charging properties of the image-bearing member. Charging of the transfer-residual toner particles that are deposited on or incorporated into the contact charging member can effectively be controlled in the charging part. As a result, collectability of the transfer-residual toner particles in the cleaning-at-development step is stabilized further.

When the developer comprises less than 5 particles of the conductive fine powder having a particle diameter of 0.6 to 3 μm per 100 toner particles, it becomes difficult to provide 15% to 60% by number of particles having the particle diameter range of from 1.00 μm, inclusive, to 2.00 μm, exclusive attributable to the conductive fine powder in the developer. In some cases, effects of the present invention, such as an effect of enhancing the charging of the image-bearing member and an effect of improving the collectability of the transfer-residual toner particles in the cleaning-at-development step, may be deteriorated significantly which otherwise would be obtained when the above-mentioned 15% to 60% by number of particles having the particle diameter range of from 1.00 μm, inclusive, to 2.00 μm, exclusive are contained. On the other hand, when the developer comprises more than 300 particles of the conductive fine powder having a particle diameter of 0.6 to 3 μm per 100 toner particles, the proportion of the particles of the conductive fine powder to the toner particles becomes too high, so that the triboelectric charging of the toner particles is obstructed and, developability and transferability as the developer are deteriorated. Furthermore, it results in reduction in image density, increase in fog, deterioration of uniform charging properties as a result of the increase of the transfer-residual toner particles, and possible occurrence of insufficient collection of transfer residuals. From this point of view, it is preferable that the developer comprises 5 to 300 particles, and more preferably, 10 to 100 particles, of the conductive fine powder having a particle diameter of 0.6 to 3 μm per 100 toner particles.

In the present invention, the number of the particles of the conductive fine powder having a particle diameter of 0.6 to 3 μm per 100 toner particles in the developer is based on values that are measured in the following manner. Comparison is made between a photograph of the developer taken in an enlarged form through a scanning electron microscope and a photograph of the developer that is mapped with elements contained in the conductive fine powder by using element analyzing means such as an X-ray microanalyzer (XMA) associated with the scanning electron microscope. The conductive fine powder, which is either deposited on the surface of the toner particles or is freely present, are specified per 100 toner particles. In this event, the images of the specified conductive fine powder are supplied to an image processor (e.g., image analyzer Model Luzex III, Nicolet Co.), through photographs (e.g., those obtained at a magnification of 3,000 to 5,000 obtained from “FE-SEMS-800”, available from Hitachi, Ltd.) of the developer taken in an enlarged form through a scanning electron microscope or through image information (at a magnification of 3,000 to 5,000) introduced via an interface from the scanning electron microscope. The photographs or image information are analyzed to count the number of the particles of the conductive fine powder having a circle-corresponding diameter of 0.6 to 3 μm per 100 toner particles.

It is preferable that the content of the conductive fine powder in the developer of the present invention is 1% to 10% by weight relative to the total weight of the developer. With the content of the conductive fine powder within the above-mentioned range, it is possible to supply to the charging part an adequate amount of conductive fine powder to enhance the charging of the image-bearing member. The conductive fine powder can be supplied to the image-bearing member in an amount necessary for improving the collectability of the transfer-residual toner particles in the cleaning-at-development step. When the developer comprises the conductive fine powder in an amount smaller than the above-mentioned range, the amount of the conductive fine powder to be supplied to the charging part tend to be shortened. This hardly results in stable effect of enhancing the charging of the image-bearing member. In the formation of images by using the cleaning-at-development technique, the amount of the conductive fine powder that is present on the image-bearing member together with the transfer-residual toner particles is liable to be insufficient. Thus, it is difficult to achieve an effect of improving the collectability of the transfer-residual toner particles. On the other hand, when the amount of the conductive fine powder in the developer is larger than the above-mentioned range, the excess conductive fine powder is liable to be supplied to the charging part, so that a large amount of the conductive fine powder not retainable at the charging part is more often discharged to the image-bearing member to cause faulty exposure. The triboelectric charging properties of the toner particles are often lowered or disordered. This may cause reduction in image density and increase in fog. From these points of view, the conductive fine powder is preferably contained in the developer in an amount of 1.2% to 5% by weight with respect to the developer.

It is preferable that the conductive fine powder has a resistivity of 10⁹ Ω·cm or lower, so as to provide the developer with the effect of enhancing the charging of the image-bearing member and the effect of improving the transfer-residual toner particles collectability. When the conductive fine powder has a resistivity higher than 10⁹ Ω·cm, the effect of achieving good charging properties of the image-bearing member becomes small, even in the circumstances where the conductive fine powder is present at the abutting part between the charging member and the image-bearing member or present in the charging region in the vicinity of the abutting part to maintain very close contact via the conductive fine powder between the contact charging member and the image-bearing member. In the cleaning-at-development step, the conductive fine powder is more easily charged to a polarity identical to that of the transfer-residual toner particles and often becomes collectable more easily. This may significantly lower the effect of improving the collectability of the transfer-residual toner particles because of the presence of the conductive fine powder on the image-bearing member that is less liable to be collected as the collection aid.

In order to sufficiently attain the effect of enhancing the charging of the image-bearing member owing to the conductive fine powder, and thereby stably achieve good uniform charging properties of the image-bearing member, it is preferred that the conductive fine powder has a resistivity lower than the resistivity at the surface of the contact charging member or at a contact with the image-bearing member. More preferably, the conductive fine powder has a resistivity 1/100 or below of the resistivity of the contact charging member.

It is further preferred that the conductive fine powder has a resistivity of 10⁶ Ω·cm or lower, so as to better effect the good charging of the image-bearing member by overcoming the obstruction of the charging to the contact charging member caused as a result of deposition or incorporation of the insulating transfer-residual toner particles. Such a resistivity is also preferable to stably attain the effect of improving the collectability of the transfer-residual toner particles in the cleaning-at-development step. The conductive fine powder preferably has a resistivity of 10⁻¹ to 10⁶ Ω·cm, in particular, 10⁰ to 10⁵ Ω·cm.

In the present invention, the resistivity of the conductive fine powder may be measured by “tableting” and normalization. More specifically, approximately 0.5 g of a powder sample is placed in a cylinder having a bottom area of 2.26 cm² and sandwiched between upper and lower electrodes under a load of 15 kg. Then, a voltage of 100 volts is applied between the electrodes to measure the resistivity. A specific resistivity is then calculated by normalization.

It is preferable that the conductive fine powder is a transparent, opaque/white or pale-colored conductive fine powder because it is not noticeable as the fog when transferred onto the transfer material. Such colors are also preferred in the sense of preventing the obstruction of exposure light beams in the latent image forming step. It is preferable that the conductive fine powder shows a transmittance of at least 30%, more preferably at least 35%, with respect to imagewise exposure light beams used for the formation of latent images.

How to measure the light transmittance of the conductive fine powder in the present invention is described below in conjunction with an example. The transmittance is measured with a single layer of conductive fine powder fixed on an adhesive layer of a transparent film on one side of the film. Light flux for measurement is incident to the sheet from the direction normal to the sheet. The light beams that are transmitted through to the backside of the film are condensed to measure the light intensity of the transmitted light. Based on a difference between the light intensities for the light beams that are passed only through the film and for the light beams that are passed through the film with the conductive fine powder deposited thereon, a light transmittance as a net light quantity is measured. In practice, measurement of the light intensity may be obtained by using a transmission densitometer, such as X-Rite Model 310T color transmission densitometer.

It is also preferable that the conductive fine powder is non-magnetic. Non-magnetic conductive materials often facilitate providing transparent, opaque/white or pale-colored conductive fine powder. On the contrary, magnetic conductive materials are difficult to be transparent, opaque/white or pale-colored due to their magnetic properties. Furthermore, in an image forming technique that uses a magnetic force for conveyance and retention of the developer, the magnetic conductive fine powder is not readily developed. Consequently, the supply of the conductive fine powder to the image-bearing member is often insufficient. Alternatively, the conductive fine powder is easily accumulated on the surface of the developer-carrying member, thus obstructing the development with the toner particles. Further, when the magnetic conductive fine powder is added to the magnetic toner particles, a magnetic agglomeration force tends to make it difficult to release the conductive fine powder from the toner particles. This may obstruct the supply of the conductive fine powder to the image-bearing member.

Examples of the conductive fine powder used in the present invention include carbon fine powder of, for example, carbon black and graphite; fine powder of metals, such as copper, gold, silver, aluminum and nickel; metal oxides, such as zinc oxide, titanium oxide, tin oxide, aluminum oxide, indium oxide, silicon oxide, magnesium oxide, barium oxide, molybdenum oxide, iron oxide, and tungsten oxide; metal compounds, such as molybdenum sulfide, cadmium sulfide, and potassium titanate; and complex oxides thereof. Of these, the conductive fine powder that includes primary particles having a number-average particle diameter of 50 to 500 nm and include agglomerated matters of the primary particles may be used. Preferably, those having the above-mentioned advantageous properties (e.g., resistivity, transmittance) are used. The conductive fine powder may be used after adjustment of the particle diameter and the particle size distribution for use as a developer.

As the conductive fine powder, it is preferable that the conductive fine powder comprises at least one oxide selected from zinc oxide, tin oxide and titanium oxide. These oxides are preferred from the viewpoint of avoiding their being noticeable as the fog when transferred onto the transfer material, because they provide, relatively easily, fine powder that contains primary particles having a number-average particle diameter of 50 to 500 nm and contains agglomerated matters of the primary particles and also provide non-magnetic and white or pale-colored fine powder with a low resistivity.

Fine particles comprising a metal oxide doped with an element such as antimony or aluminum and fine particles with a conductive material on the surface thereof may also be used as the conductive fine powder in order to control the resistivity of the conductive fine powder or for other purposes. For example, zinc oxide fine particles containing aluminum and tin oxide fine particles containing antimony may be used.

The conductive fine powder having the agglomerated matters may be obtained by means of physically or chemically agglomerating conductive particles whose primary particles have a number-average particle diameter of about 50 to 500 nm.

For example, zinc oxide whose primary particles have a number-average particle diameter of about 50 to 500 nm may be treated with an aqueous dispersion system in the presence of aluminum salt that serves as an activating agent and ammonium carbonate that serves as an erosive agent. The mixture may be dehydrated, dried and then sintered to obtain conductive zinc oxide. Such conductive zinc oxide is produced as an agglomerated matter by means of properly determining conditions for the production of it. A particle size may be adjusted as desired.

In the present invention, the number-average particle diameter of the primary particles of the conductive fine powder may be determined in the following manner. Comparison is made between a photograph of the developer taken in an enlarged form through a scanning electron microscope and a photograph of the developer that is mapped with elements contained in the conductive fine powder by using element analyzing means such as an X-ray microanalyzer (XMA) associated with the scanning electron microscope. Ten to fifty conductive fine powder, which are either deposited on the surface of the toner particles or are freely moved, are specified. The circle-corresponding diameter of the primary particles of the specified conductive fine powder is measured. The number-average particle diameter may be determined from the circle-corresponding diameters of 100 or more primary particles of the conductive fine powder.

It is preferable that the conductive fine powder has a volume-average particle diameter of 0.5 to 5 μm. When the volume-average particle diameter of the conductive fine powder exceeds the above-mentioned range, a ratio of the particles having the particle diameter range of from 1.00 μm. inclusive, to 2.00 μm, exclusive in the conductive fine powder is reduced. It becomes difficult to provide a developer comprising 15% to 60% by number of particles having the particle diameter range of from 1.00 μm, inclusive, to 2.00 μm, exclusive, in number-based particle size distribution of particles in the particle diameter range of from 0.60 μm, inclusive, to 159.21 μm, exclusive. This sometimes may result in complete failure of providing the effects of the present invention. With the developer comprising a larger content of the conductive fine powder in order to include 15% to 60% by number of particles having the particle diameter range of from 1.00 μm, inclusive, to 2.00 μm, exclusive, some problems may occur such as deterioration of developability, pollution within the apparatus by scattered conductive fine powder, shutout of the exposure light beams. This sometimes adversely affects qualities of images. From this point of view, the conductive fine powder preferably has a volume-average particle diameter of 0.8 to 3 μm.

The volume-average particle diameter of the above-mentioned conductive fine powder is measured by using an diffraction technique. An exemplified measurement using the diffraction technique is described. A minute amount of surfactant is added to 10 ml of pure water, to which 10 mg of sample conductive fine powder is added. The mixture is subjected to dispersion by using an ultrasonic disperser (ultrasonic homogenizer) for 10 minutes. A laser diffraction particle size distribution analyzer (Model LS-230, available from Coulter Electronics Inc.) is equipped with a liquid module, and the measurement is performed in a particle diameter range of 0.04 to 2,000 μm to obtain a volume-average particle diameter through a single measurement for 90 sec.

In the present invention, the particle diameter of the particles of the conductive fine powder is defined as a particle diameter of their agglomerated matters.

In the present invention, the developer is required to comprise an inorganic fine powder whose primary particles have a number-average particle diameter of 4 to 50 nm.

When the number-average particle diameter of the primary particles of the inorganic fine powder is larger than 50 nm, or when an inorganic fine powder whose primary particles have a number-average particle diameter within the above-mentioned range are not added, the conductive fine powder cannot be dispersed uniformly in the developer with respect to the toner particles. It becomes difficult to supply the conductive fine powder uniformly to the image-bearing member. The conductive fine powder containing the agglomerated matters of the primary particles that is used in the present invention is easily liberated from the toner particles. Besides, it is hardly dispersible uniformly in the developer. Taking the above into consideration, it has found that the conductive fine powder having the agglomerated matters of the primary particles can be dispersed uniformly in the developer when the conductive fine powder is combined with an inorganic fine powder which includes primary particles having a smaller number-average particle diameter and impart better flowability to the developer. The conductive fine powder that is not uniformly dispersed in the developer may often cause uneven supply of the conductive fine powder to the image-bearing member in the longitudinal direction. Such uneven supply to the contact charging member leads to faulty charging of the image-bearing member that is corresponding to the unevenness or irregularity of the supply of the conductive fine powder. In the cleaning-at-development step, the collectability of the transfer-residual toner particles is deteriorated in association with a reduced amount of the conductive fine powder on the image-bearing member, causing insufficient collection. Consequently, a stripe-shaped defect of image would appear. If the transfer-residual toner particles are deposited on the charging member, these particles tend to be fixed to the charging member. This means that stable and good charging properties of the image-bearing member are hardly achieved. In addition, good flowability of the developer cannot be obtained, which sometimes cause uneven or irregular charging of the toner particles. Therefore, some problems inevitably occur such as increase in fog, reduction in image density, and scattering of the toner.

When the number-average particle diameter of the primary particles of the inorganic fine powder is smaller than 4 nm, the inorganic fine powder has a higher cohesiveness. The inorganic fine powder often behaves as agglomerated matters rather than primary particles. Under such circumstances, the agglomerated matters have broad particle size distribution and have so high cohesiveness that they are hardly separated through disintegration. As a result, a defect of images frequently occurs, such as image dropout due to development with the agglomerated matters of the inorganic fine powder, and defects attributable to damages on the image-bearing member, the developer-carrying member or the contact charging member, by the agglomerates. From these points of view, the number-average particle diameter of the primary particles of the inorganic fine powder is required to be within 4 to 50 nm. More preferably this number-average particle diameter is 6 to 35 nm.

In the present invention, the inorganic fine powder is added not only for improving the flowability of the developer to uniformize the charge of the toner particles in the form of being deposited on the surface of the toner particles, but also for uniformly dispersing the conductive fine powder having the agglomerated matters relative to the toner particles in the developer, thereby uniformly supplying the conductive fine powder to the image-bearing member.

In the present invention, the number-average particle diameter of the primary particles of the inorganic fine powder may be determined in the following manner. Comparison is made between a photograph of the developer taken in an enlarged form through a scanning electron microscope and a photograph of the developer that is mapped with elements contained in the inorganic fine powder by using element analyzing means such as an X-ray microanalyzer (XMA) associated with the scanning electron microscope. Measurement is made on 100 or more primary particles of the inorganic fine powder which is either deposited on the surface of the toner particles or are freely moved to determine the number-average particle diameter.

The inorganic fine powder used in the present invention preferably comprises at least one compound that is selected from silica, titania and alumina and comprises primary particles having a number-average particle diameter of 4 to 50 nm. For example, silica fine powder may be either dry process silica (also called fumed silica) formed by vapor phase oxidation of a silicon halide or wet process silica that is typically formed from water glass. However, the fumed silica is preferable because of fewer silanol groups at the surface and inside of silica fine powder and also fewer production residues such as Na₂O and SO₃⁻. Alternatively, the fumed silica may be in the form of complex fine powder of silica and other metal oxide. Such complex fine powder can be obtained by means of combining silicon halide with other metal halide, such as aluminum chloride or titanium chloride, in the production process. Therefore, the complex fine powder of the fumed silica is also contemplated in the present invention.

It is preferable that the inorganic fine powder used in the present invention is hydrophobized. By hydrophobizing the inorganic fine powder, deterioration of charging properties of the inorganic fine powder in a high humidity environment is prevented. By improving the environmental stability of triboelectric charge of the toner particles on which the inorganic fine powder is deposited, the environmental stability of development properties, such as the image density and the fog, as the developer can further be enhanced. By controlling fluctuations of the charging properties of the inorganic fine powder that depends on the environment as well as the charge of the toner particles on which the inorganic fine powder is deposited, it is possible to prevent change in releasability of the conductive fine powder from the toner particles, thus stabilizing the supply of the conductive fine powder to the image-bearing member that depends on the environment. In addition, it is also possible to improve environmental stability of the image-bearing member charging properties and of the collectability of the transfer-residual toner particles.

As the treating agent for hydrophobization, it is possible to use silicone varnish, various modified silicone varnishes, silicone oil, various modified silicone oils, silane compounds, silane coupling agents, other organic silicon compounds and organic titanate compounds, alone or in combination. Among these, it is particularly preferable that the inorganic fine powder are treated with at least silicone oil. The treatment may be done through a known technique.

Preferably, the above-mentioned silicone oil has a viscosity at 25° C. of 10 to 200,000 mm²/s, more preferably 3,000 to 80,000 mm²/s. If the viscosity of the silicone oil is lower than 10 mm²/s, stable treatment of the inorganic fine powder cannot be performed. The silicone oil coating the inorganic fine powder for the treatment may often be separated, caused to move or deteriorated due to heat or mechanical stress, resulting in inferior image quality. On the other hand, when the viscosity is higher than 200,000 mm²/s, uniform treatment of the inorganic fine powder with the silicone oil may become difficult.

Examples of the silicone oil particularly preferable for the present invention include: dimethyl silicone oil, methylphenyl silicone oil, α-methylstyrene-modified silicone oil, chlorophenyl silicone oil, and fluorine-modified silicone oil.

The silicone oil treatment may be performed, for example, by direct blending of the inorganic fine powder that are treated with a silane compound with silicone oil or by using a blender such as a Henschel mixer; by spraying of silicone oil onto the inorganic fine powder. Alternatively, silicone oil may be dissolved or dispersed in an appropriate solvent and silica fine powder is added thereto before blending and removal of the solvent. In view of less by-production of the agglomerated matters of the inorganic fine powder, the spraying is particularly preferred.

The amount of the silicone oil is preferably 1 to 23 parts by weight, and more preferably, 5 to 20 parts by weight relative to 100 parts by weight of the inorganic fine powder. A lower amount of the silicone oil than the above-mentioned range cannot provide good hydrophobic properties while a larger amount may cause problems such as fog.

It is also preferable in the present invention that the inorganic fine powder is treated with at least a silane compound simultaneously with or in advance of the treatment with silicone oil. The treatment of the inorganic fine powder with a silane compound promotes the adhesion of the silicone oil onto the inorganic fine powder. This is preferable to further uniformize the hydrophobic properties and charging properties of the inorganic fine powder.

As to treatment conditions for the inorganic fine powder, silylation may be performed in a first stage reaction to remove a silanol group by chemical bonding, and then a thin hydrophobic film of silicone oil may be formed on the surface in a second stage reaction.

It is preferable that the developer of the present invention comprises the inorganic fine powder in an amount of 0.1% to 3.0% by weight relative to the total weight of developer. When the content of the inorganic fine powder is lower than 0.1% by weight, it is difficult to sufficiently attaint the effect of the inorganic fine powder. On the other hand, in excess of 3.0% by weight, the conductive fine powder is coated with excess inorganic fine powder for the toner particles. As a result, the developer behaves similarly to the case where the conductive fine powder has a high resistivity. Effects of the present invention may sometimes lost, e.g., the supply of the conductive fine powder to the image-bearing member is lowered, the effect of enhancing the charging of the image-bearing member is deteriorated, and collectability of the transfer-residual toner particles is also deteriorated. It is preferable that the content of the inorganic fine powder is 0.3% to 2.0% by weight, and more preferably, 0.5% to 1.5% by weight.

The inorganic fine powder having a number-average particle diameter of the primary particles of 4 to 50 nm that is used in the present invention preferably has a specific surface area of 40 to 300 m²/g, more preferably 60 to 250 m²/g, as measured by the nitrogen adsorption BET method. The specific surface area may be determined according to a BET multi-point method using a specific surface area analyzer Autosorb I (Yuasa Ionics) with nitrogen gas.

In the present invention, the toner particles are those comprising at least a binder resin and a colorant. It is preferable that the toner particles have a resistivity of at least 10¹⁰ Ω·cm, more preferably at least 10¹² Ω·cm. Unless the toner particles are substantially insulating, it is difficult to satisfy the developability and the transferability in combination. Charge injection to the toner particles under the developing electric field may often occur with the resistivity of lower than 10¹⁰ Ω·cm. This may cause disturbance of the developer charge, leading to fog.

In the present invention, the resistivity of the toner particles may be measured by “tableting” and normalization. More specifically, approximately 0.5 g of a powder sample is placed in a cylinder having a bottom area of 2.26 cm² and sandwiched between upper and lower electrodes under a load of 15 kg. Then, a voltage of 1,000 volts is applied between the electrodes to measure the resistivity. The resistivity of the toner particles is then calculated by normalization.

Examples of the binder resin contained in the toner particles used for the present invention include; styrene resins, styrene copolymer resins, polyester resins, polyvinyl chloride resin, phenolic resin, natural modified phenolic resin, natural resin-modified maleic resin, acrylic resin, methacrylic resin, polyvinyl acetate, silicone resin, polyurethane resin, polyamide resin, furan resin, epoxy resin, xylene resin, polyvinyl butyral, terpene resin, coumarone-indene resin, and petroleum resin.

Examples of a comonomer constituting a styrene copolymer together with a styrene monomer include styrene derivative, such as vinyl toluene; acrylic acid or acrylate esters, such as methyl acrylate, ethyl acrylate, butyl acrylate, dodecyl acrylate, octyl acrylate, 2-ethylhexyl acrylate, and phenyl acrylate; methacrylic acid; methacrylic acid or methacrylate esters, such as methyl methacrylate, ethyl methacrylate, butyl methacrylate and octyl methacrylate; maleic acid or dicarboxylic acid esters having a double bond, such as butyl maleate, methyl maleate and dimethyl maleate; acrylamide, acrylonitrile, methacrylonitrile, butadiene or vinyl esters, such as vinyl chloride, vinyl acetate, and vinyl benzoate; ethylenic olefins, such as ethylene, propylene and butylene; vinyl ketones, such as vinyl methyl ketone and vinyl hexyl ketone; and vinyl ethers, such as vinyl methyl ether, vinyl ethyl ether, and vinyl isobutyl ether. These vinyl monomers may be used alone or in combination of two or more of them.

A cross-linking agent may be used for the production of the binder resin. Typical cross-linking agents used for the purpose of the present invention are compounds that comprise two or more polymerizable double bonds. Examples thereof include: aromatic divinyl compounds, such as divinyl benzene, and divinyl naphthalene; carboxylic acid esters having two double bonds, such as ethylene glycol diacrylate, ethylene glycol dimethacrylate and 1,3-butanediol dimethacrylate; divinyl compounds, such as divinylaniline, divinyl ether, divinyl sulfide and divinylsulfone; and compounds having three or more vinyl groups. These compounds may be used alone or in combination.

It is preferable that the binder resin has a glass transition temperature (Tg) of 50 to 70° C. A glass transition temperature of lower than the above-mentioned range may often lead lower storage stability of the developer. On the other hand, a higher glass transition temperature may result in inferior fixing performance.

It is a preferred mode of the present invention to incorporate a wax component in the toner particles. Examples of the toner particles used in the present invention include: aliphatic hydrocarbon waxes, such as low molecular weight polyethylene, low molecular weight polypropylene, polyolefin, polyolefin copolymers, microcrystalline wax, paraffin wax and Fischer-Tropsch wax; oxidation products of aliphatic hydrocarbon waxes, such as polyethylene oxide; or block copolymers thereof; waxes based on fatty acid esters, such as carnauba wax, and montanic acid ester wax; and waxes formed by partially or totally deacidifying fatty acid esters, such as deacidified carnauba wax. Other examples include: saturated linear fatty acids, such as palmitic acid, stearic acid, montanic acid, and long chain alkylcarboxylic acids having longer alkyl chains; unsaturated fatty acids, such as brassidic acid, eleostearic acid, and parinaric acid; saturated alcohols, such as stearyl alcohol, aralkyl alcohol, behenyl alcohol, carnaubyl alcohol, cetyl alcohol, melissyl alcohol, and long chain alkyl alcohols having longer alkyl chains; polyhydric alcohols, such as sorbitol; fatty acid amides, such as linoleamide, oleamide, and lauramide; saturated fatty acid bis-amides, such as methylene bis-stearamide, ethylene bis-capramide, ethylene bis-lauramide, and hexamethylene bis-stearamide; unsaturated fatty acid amides, such as ethylene bis-oleamide, hexamethylene bis-oleamide, N,N′-dioleyladipamide, and N,N′-dioleylsebacamide; aromatic bisamides, such as m-xylene bis-stearamide, N,N′-distearyl isophthalamide; fatty acid metal salts (often called metallic soap), such as calcium stearate, calcium laurate, zinc stearate and magnesium stearate; waxes formed by grafting vinyl monomers, such as styrene and acrylic acid onto aliphatic hydrocarbon waxes; partial esters between fatty acids and polyhydric alcohols, such as monoglyceride of behenic acid; and methyl ester compounds having hydroxyl groups obtained by hydrogenation of vegetable fats and oils.

In the present invention, the wax may preferably be used in an amount ranging from 0.5 to 20 parts by weight, more preferably from 0.5 to 15 parts by weight, per 100 parts by weight of the binder resin.

Examples of the colorant contained in the toner particles used in the present invention include: carbon black, lamp black, iron black, cobalt blue, nigrosine dyes, Aniline Blue, Phthalocyanine Blue, Phthalocyanine Green, Hansa Yellow G, Rhodamine 6G, Calco oil Blue, Chrome Yellow, Quinacridone, Benzidine Yellow, Rose Bengal, triarylmethane dyes, and monoazo and disazo dyes and pigments. These dyes and pigments may be used alone or in combination.

In the present invention, it is preferable that the developer is a magnetic developer having a magnetization intensity of 10 to 40 Am²/kg, as measured in a magnetic field of 79.6 kA/m. It is more preferable that the magnetization intensity of the developer is 20 to 35 Am²/kg.

The magnetization intensity in the magnetic field of 79.6 kA/m is defined in the present invention for the following reason. A magnetization intensity at a saturated magnetism (i.e., a saturation magnetization) is more commonly used as a parameter for representing a magnetic property of a magnetic material. However, a magnetization intensity of the magnetic developer in a magnetic field that actually acts on the magnetic developer within the image forming apparatus is much more important in the present invention. In the case where a magnetic developer is used in an image forming device, the magnetic field acting on the magnetic developer is on the order of several tens to a hundred and several tens kA/m in many image forming apparatuses that are commercially available. This is because in order not to leak a large magnetic field out of the device or to suppress the cost of the magnetic field source. For this reason, the magnetic field of 79.6 kA/m (1,000 oersted) is taken as a representative of the magnetic fields actually acting on a magnetic developer in the image forming apparatus to determine a magnetization intensity at this magnetic field of 79.6 kA/m.

When the magnetization intensity at the magnetic field of 79.6 kA/m of the developer is lower than the above-mentioned range, it is difficult to convey the developer by means of a magnetic force and also difficult to have the developer-carrying member carry uniformly the developer. Furthermore, when an attempt is made to convey the developer under a magnetic force, it is difficult to form uniform ears of the developer. This may obstruct the supply of the conductive fine powder to the image-bearing member and sometimes deteriorate collectability of the transfer-residual toner particles. On the other hand, when the magnetization intensity at the magnetic field of 79.6 kA/m is higher than the above-mentioned range, the toner particles would have a higher cohesiveness. As a result, it becomes difficult to uniformly disperse the conductive fine powder in the developer and to supply them to the image-bearing member. Some effects of the invention, i.e., an effect of enhancing the charging of the image-bearing member or improving toner particles collectability may be impaired.

In order to obtain such a magnetic developer, a magnetic material may be incorporated in the toner particles. Examples of the magnetic material contained in the toner particles to prepare a magnetic developer in the present invention include: magnetic iron oxides, such as magnetite, maghemite and ferrite; metals, such as iron, cobalt and nickel, and alloys of these metals with other metals, such as aluminum, cobalt, copper, lead, magnesium, tin, zinc, antimony, beryllium, bismuth, cadmium, calcium, manganese, selenium, titanium, tungsten and vanadium.

It is preferable to use a magnetic material having a saturation magnetization of 10 to 200 Am²/kg, a residual magnetization of 1 to 100 Am²/kg, and coercivity of 1 to 30 kA/m, at a magnetic field of 796 kA/m. The magnetic material may be used in an amount of 20 to 200 parts by weight per 100 parts by weight of the binder resin. Among the magnetic material, those based on magnetite are particularly preferable.

In the present invention, the magnetization intensity of the developer may be measured by using a vibrating sample magnetometer (VSM) Model P-1-10 (TOEI INDUSTRY CO., LTD) under an external magnetic field of 79.6 kA/m at room temperature (25° C.). The magnetic properties of a magnetic material may be measured by applying an external magnetic field of 796 kA/m at room temperature (25° C.).

The developer of the present invention may preferably have a triboelectric charge in terms of absolute value of 20 to 100 mC/kg relative to particles of spherical ion powder that pass through a 149 μm size opening sieve (100 mesh) and do not pass through a 74 μm size opening sieve (200 mesh) (hereinafter, referred to as “₁₀₀ mesh pass and 200 mesh on”). When the triboelectric charge of the developer is smaller than 20 mC/kg in terms of absolute value, the transferability of the toner particles is deteriorated. This increases the transfer-residual toner particles. Consequently, the charging properties of the image-bearing member may be deteriorated and the load of collecting the transfer-residual toner particles is increased, which may often cause insufficient collection. When the triboelectric charge of the developer is larger than 100 mC/kg in terms of absolute value, the developer is caused to have a higher electrostatic cohesiveness. It is then difficult to ensure uniform dispersion of the conductive fine powder in the developer and to supply it to the image-bearing member. Some effects of the present invention, e.g., an effect of enhancing the charging of the image-bearing member and an effect of improving the toner collectability may be impaired. In particular, in the case of a magnetic developer, the developer has a magnetic cohesiveness and it is thus necessary to further suppress the electrostatic cohesiveness. With this respect, the developer preferably has a triboelectric charge in terms of absolute value of 25 to 50 mC/kg with respect to the above-mentioned spherical iron powder.

A method of measuring a triboelectric charge of a developer according to the present invention is described with reference to the drawings.

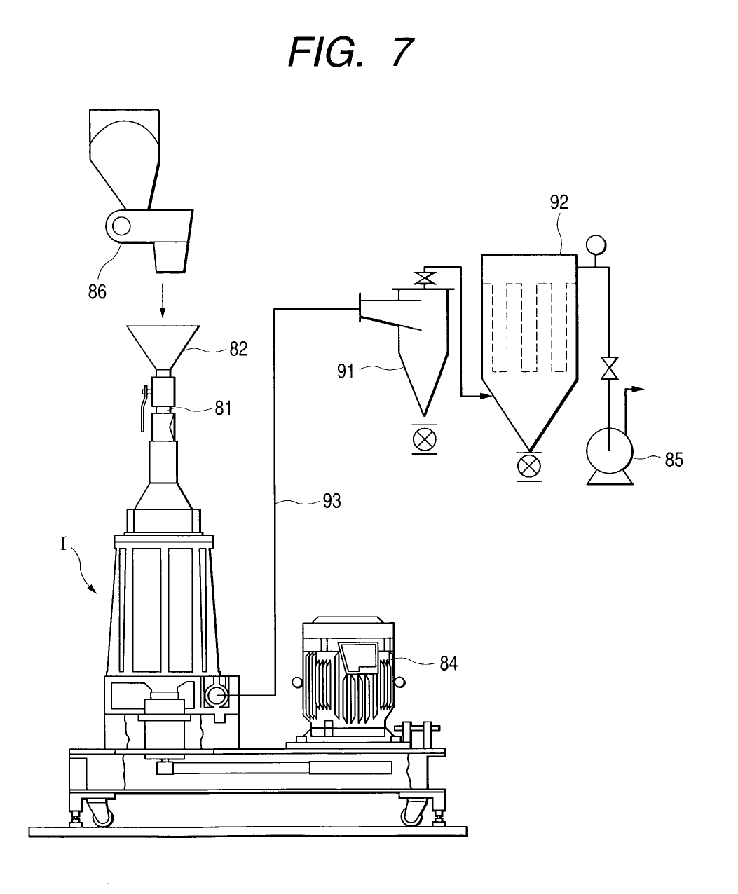

FIG. 5 is an illustration of a device used to measure a triboelectric charge of the developer. A mixture of a sample developer (of which triboelectric charge is to be measured) and a “100 mesh pass and 200 mesh on” spherical iron powder carrier (e.g., spherical iron powder DSP 138 available from Dowa Iron Powder Co., Ltd.) in a weight ratio of 5:95 (for example, 0.5 g of the developer and 9.5 g of the iron powder carrier) is placed in a 50 to 100 ml-polyethylene bottle, at 23° C., 60% relative humidity. The bottle is shaken 100 times. Subsequently, approximately 0.5 g of the mixture is loaded into a metal measuring container 52 equipped with a 25 μm size opening (500-mesh) screen 53 at the bottom thereof. The container is then covered with a metal lid 54. The total weight of the measuring container 52 is weighed and denoted by W1 (g). Then, an aspirator 51 (formed of an insulating material at least where contacting the container 52) is operated to suck the sample through a suction port 57 to set a pressure at a vacuum gauge 55 at 2,450 Pa while adjusting an aspiration control valve 56. In this state, the aspiration is performed sufficiently (approximately 1 minute) to remove the developer. The reading at this time of a electrometer 59, which is connected to the container 52 via a capacitor 58 having a capacitance C (μF), is measured and denoted by V (volts). The total weight of the measuring container after the aspiration is weighed and denoted by W2 (g). The triboelectric charge TC (mC/kg) of the developer is calculated according to the following formula:

(mC/Kg)=C×V/(W1−W2).

In the present invention, it is preferable that the developer contains a charge control agent. Examples of charge control agents that keep the developer positively charged include the following compounds.

Nigrosine and modified products thereof with metallic salts of a fatty acid; quaternary ammonium salts, such as tributylbenzylammonium-1-hydroxy-4-naphthosulfonate and tetrabutylammonium tetrafluoroborate, and onium salts such as phosphonium salts thereof and lake pigments thereof, triphenylmethane dyes and lake pigments thereof (examples of laking agents include phosphotungstic acid, phosphomolybdic acid, phosphotungsto-molybdic acid, tannic acid, lauric acid, gallic acid, ferricyanides and ferrocyanides), metallic salts of a fatty acid; diorganotin oxides, such as dibutyltin oxide, dioctyltin oxide and dicyclohexyltin oxide; diorganotin borates, such as dibutyltin borate, dioctyltin borate and dicyclohexyltin borate; guanidine compounds and imidazole compounds. These compounds may be used either alone or in combination. Among these, it is preferable to use a triphenylmethane compound or a quaternary ammonium salt having a non-halogen counter ion. It is possible to use, as a positive charge control agent, a copolymer of a polymerizable monomer, such as styrene, an acrylate or a methacrylate, as described above, with a homopolymer of a monomer represented by the following general formula (1). In such a case, the charge control agent also serves as (a part or all of) the binder resin.

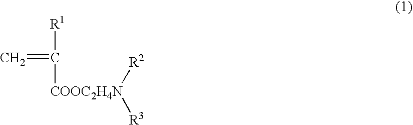

The compound represented by the following general formula (2) is particularly preferable in the present invention.

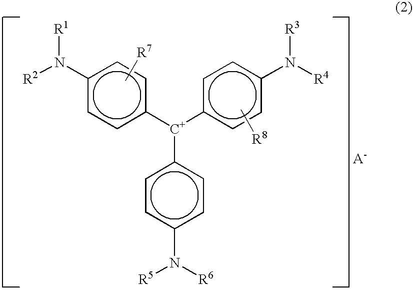

wherein R¹, R², R³, R⁴, R⁵ and R⁶ may be the same or different and are independently a group selected from the group consisting of a hydrogen atom, substituted or unsubstituted alkyl groups, and substituted or unsubstituted aryl groups; R⁷, R⁸ and R⁹ may be the same or different and are independently a group selected from the group consisting of a hydrogen atom, a halogen atom, an alkyl group and an alkoxy group; and A⁻ is an anion such as a sulfuric acid ion, a nitric acid ion, a boric acid ion, a phosphoric acid ion, a hydroxyl ion, an organic sulfuric acid ion, an organic sulfonic acid ion, an organic phosphoric acid ion, a carboxylic acid ion, an organic boric acid ion, an tetrafluoroborate.

Substances that control the developer negatively charged may be organometallic compounds and chelate compounds.

Examples of such compounds include, metal monoazo compounds, metal compounds of acetylacetone, metal compounds of aromatic hydroxycarboxylic acids and metal compounds of aromatic dicarboxylic acids. Other compounds useful for the present invention include aromatic hydroxycarboxylic acids, aromatic mono- and poly-carboxylic acids, anhydrides and esters thereof; and phenol derivatives thereof such as bisphenol.

A metal monoazo compound represented by the following general formula (3) is also preferable.

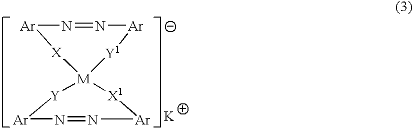

wherein M is a central metal of coordination, such as Sc, Ti, V, Cr, Co, Ni, Mn, and Fe; Ar is an aryl group, such as a phenyl group or a naphthyl group, which may have a substituent (the substituent may be, for example, a nitro group, a halogen group, a carboxyl group, an anilido group, an C₁ to C₁₈ alkyl group or an alkoxyl group); X, X′, Y and Y′ are each —O—, —CO—, —NH— or —NR— (R is an alkyl group having 1 to 4 carbon atoms); and K⁺ is a hydrogen ion, a sodium ion, a potassium ion, an ammonium ion, an aliphatic ammonium ion, or absent.

In the above-indicated formula, Fe and Cr are preferable central metals. Halogen, an alkyl group and an anilido group are preferable substituents. Hydrogen, ammonium, and aliphatic ammonium are preferable counter ions.

A basic organic acid metal compound represented by the following general formula (4) may also keep the developer negatively charged and may be used for the present invention. In the formula, Fe, Al, Zn, Zr and Cr are preferable central metals. Halogen, an alkyl group and an anilido group are preferable substituents. Hydrogen, an alkali metal, ammonium, and aliphatic ammonium are preferable counter ions. A mixture of compounds with different counter ions may also be used.

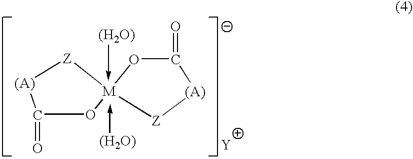

wherein M is a central metal of coordination, such as Cr, Co, Ni, Mn, Fe, Zn, Al, Si, and B; A is

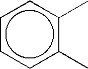

(which may have a substituent such as an alkyl group),

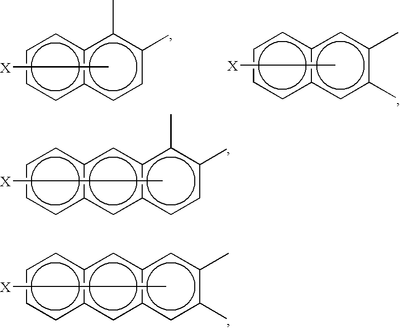

(X is a hydrogen atom, a halogen atom, a nitro group, or an alkyl group) or

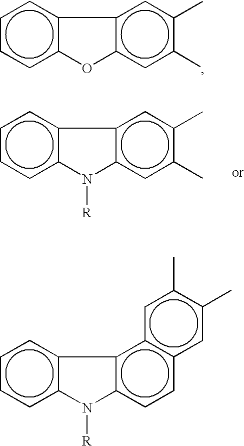

(R is a hydrogen atom, a C₁ to C₁₈ alkyl or alkenyl group);

Y⁺ is a hydrogen ion, a sodium ion, a potassium ion, an ammonium ion, an aliphatic ammonium ion, or

absent; and Z is —O— or

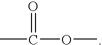

Such a charge control agent may be incorporated in the developer by internal addition into the toner particles or external addition to the toner particles. The charge control agent may be added preferably in a proportion of 0.1 to 10 parts by weight, more preferably 0.1 to 5 parts by weight, per 100 parts by weight of the binder resin though the amount depends on the type of the binder resin, presence or absence of other additive or additives, and the toner production process including a dispersion method that is to be used.

The toner particles of the present invention may preferably be produced through, for example, a process wherein the above-mentioned components are sufficiently blended in a blender, such as a ball mill, and well kneaded by means of a hot kneading machine, such as hot rollers, a kneader or an extruder, followed by cooling for solidification, pulverization, classification, and optionally surface treatment for toner shape adjustment, as desired, to obtain toner particles. Alternatively, it is also possible to use a process for producing spherical toner particles by spraying a molten mixture into air by using a disk or a multi-fluid nozzle as disclosed in, for example, Japanese Patent Publication No. 56-13945; a process for producing toner particles by dispersing components in a binder resin solution and spray-drying the mixture; a process for directly producing toner particles through suspension polymerization as disclosed in Japanese Patent Publication No. 36-10231, Japanese Patent Application Laid-Open No. 59-53856, and Japanese Patent Application Laid-Open No. 59-61842; a process for producing toner particles through emulsion polymerization as represented by soap-free polymerization wherein toner particles are directly formed by polymerization in the presence of a water-soluble polar polymerization initiator; an association polymerization process that causes resin fine particles and colorant to associate with each other in a solution to form toner particles; a dispersion polymerization process for directly producing toner particles in an aqueous organic solvent in which the monomer is soluble but the resultant polymer is insoluble; and a process for producing a so-called microcapsule toner wherein predetermined materials are incorporated in a core material or a shell material, or both.

The treatment for toner particle shape adjustment may be performed by various methods and techniques. Examples thereof include: a method in which toner particles that are produced through pulverization are dispersed into water or an organic solution, heated or swollen; a heat treatment in which toner particles are passed through a hot gas stream; and a mechanical impact method in which toner particles are treated under application of a mechanical impact force. The mechanical impact force may be applied by using, for example, Mechanofusion System (Hosokawa Micron Corporation) or Hybridization System (Nara Machinery Co., Ltd.). With these systems, toner particles are pressed against an inner wall of a casing under a centrifugal force exerted by blades rotated at a high speed. This applies mechanical impact forces including compression and abrasion forces to the toner particles.

For such an operation involving a mechanical impact force, it is preferable that an atmospheric temperature during the operation is around the glass transition temperature (Tg) of the toner particles (i.e., ±30° C. of the glass transition temperature (Tg)), in view of avoiding agglomeration of the toner particles and productivity. It is particularly advantageous that the temperature is ±20° C. of the glass transition temperature (Tg) for the significant reduction of deformed toner particles having a low circularity and effective action of the conductive fine powder.

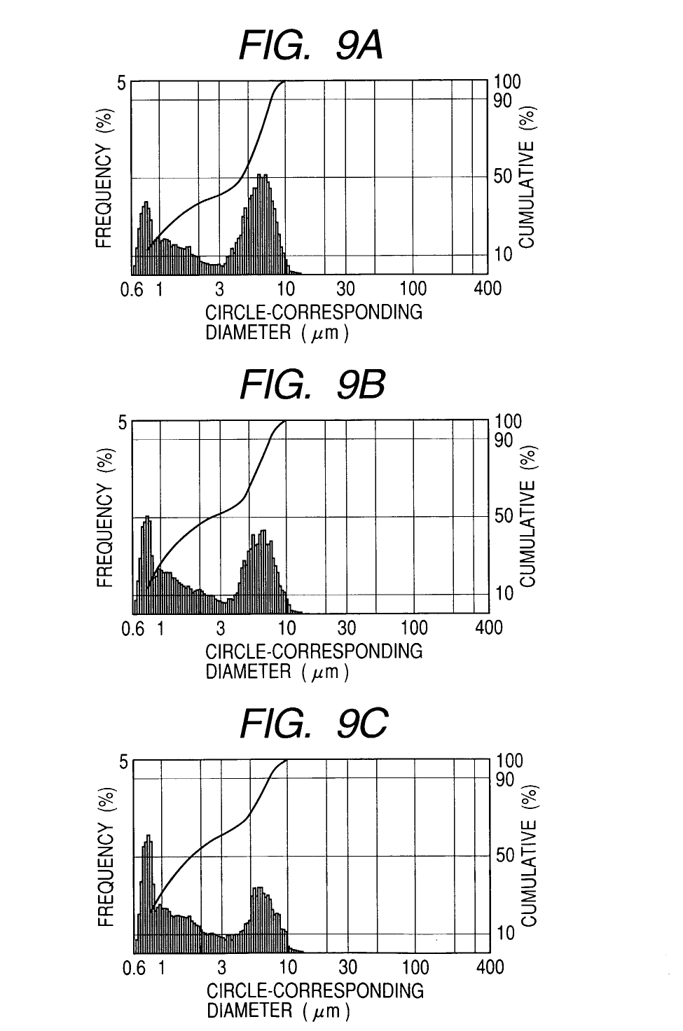

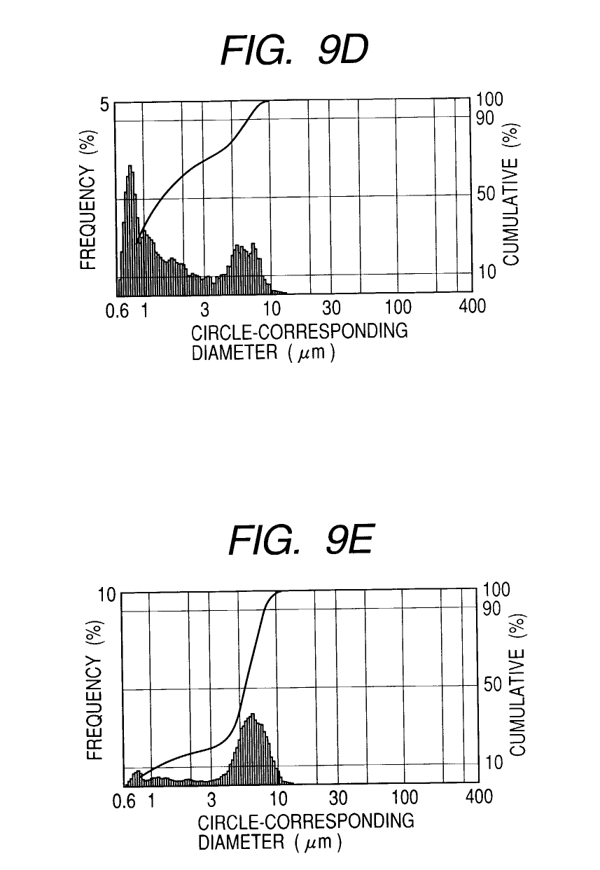

An example of repeated application of thermo-mechanical impact forces for spherizing toner particles is described more specifically with reference to FIGS. 7 and 8.

FIG. 7 is a schematic view of a toner particle spherizing system that is used in Production Examples 5 and 6 for toner particle production. FIG. 8 is an enlarged sectional view of a treating unit I of the system shown in FIG. 7.

The toner particle spherizing system presses toner particles against an inner wall of a casing under a centrifugal force exerted by blades rotated at a high speed and repeatedly applies thermo-mechanical impact forces including at least a compression force and an abrasion force to the toner particles to spherize the toner particles. As shown in FIG. 8, the treating unit I is equipped with vertically arranged four rotors 72a, 72b, 72c, and 72d. The rotors 72a to 72d are rotated together with a rotation drive shaft 73 by using an electrical motor 84 so as to provide an outermost peripheral speed of, for example, 100 m/s. Revolutions of the rotors 72a to 72d may be, for example, 130 s⁻¹. Furthermore, a suction blower 85 (FIG. 7) is operated to achieve a gas flow rate which is comparable to or even larger than a gas flow rate caused by the rotation of blades 79a to 79d that are integrally formed with the rotors 72a to 72d. Toner particles are sucked from a feeder 86 together with air into a hopper 82, and the thus-introduced toner particles are introduced via a powder supply pipe 81 and a powder supply port 80 to a central part of a first cylindrical processing chamber 89a. In the first cylindrical processing chamber 89a, the toner particles are subjected to spherization by the blade 79a and a side wall 77. The spherized toner particles are introduced via a first powder discharge port 90a formed at a center of a guide plate 78a to a central part of a second cylindrical processing chamber 89b. In the chamber, the toner particles are subjected to further spherization by the blade 79b and the side wall 77.

The toner particles treated for spherization in the second cylindrical processing chamber 89b are introduced via a second powder discharge port 90b formed at a center of a guide plate 78b to a central part of a third cylindrical processing chamber 89c for further spherization between the blade 79c and the side wall 77. The toner particles are then introduced via a third powder discharge port 90c formed at a center of a guide plate 78c to a fourth cylindrical processing chamber 89d for further spherization between the blade 79d and the side wall 77. The air conveying the toner particles flows out of the system through the first to fourth cylindrical processing chambers 89a to 89d and then through a discharge pipe 93, a pipe 97, a cyclone 91, a bag filter 92 and a suction blower 85.

The toner particles introduced in the cylindrical processing chambers 89a to 89d receive instantaneous mechanical forces from the blades 79a to 79d and collide with the side wall 77 where they receive mechanical impact forces. By the rotation of the blades 79a to 79d of a predetermined size installed on the rotors 72a to 72d, convection is caused from the center to the periphery and from the periphery to the center in a space above each rotor. The toner particles reside in the cylindrical processing chambers 89a to 89d where they are subjected to spherization. Due to heat generated by the mechanical impact force, the surface of the toner particles may be heated to a temperature around the glass transition temperature (Tg) of the binder resin. In such a case, the toner particles are formed into sphere under the action of the mechanical impact force. The toner particles are successively and effectively spherized while passing through the cylindrical processing chambers 89a to 89d.

The degree of spherization of the toner particles can be controlled by means of adjusting various factors, such as the residence time of the toner particles in a spherization processing unit, and the temperature thereof. More specifically, it can be controlled by means of adjusting, for example, a rotation speed and revolutions of the rotors, the height, width and number of the blades; a clearance between the blade periphery and the side wall, an air suction rate by the suction blower, a temperature of toner particles introduced into the spherization processing unit, and a temperature of the air conveying the toner particles.

A batch-wise hybridization system may also be advantageously used, such as those available from Nara Machinery Co., Ltd.

The shape of the toner particles as obtained according to the pulverization method can be controlled by means of selecting components, such as the binder resin, of the toner particles and adjusting conditions in the pulverization process. However, an attempt to increase the circularity of the toner particles using a jet pulverizer may often cause reduction in productivity. Accordingly, it is preferable that conditions to improve the circularity of the toner particles are determined by using a mechanical pulverizer.

In the present invention, it is preferable to use a multiple classifier for the classification step, to provide toner particles with a low variation coefficient of particle size distribution. Furthermore, in order to reduce the toner particles in the particle diameter range of from 1.00 μm, inclusive, to 2.00 μm, exclusive, it is preferable to use a mechanical pulverizer in the pulverization.

The developer of the present invention may be produced by blending the toner particles prepared in the manner as described above with externally-added additives (e.g., an inorganic fine powder, conductive fine powder) in a blender, and then sieving the mixture when required.

Various machines are commercially available for the production of toner particles through pulverization. Examples include mixers, such as Henschel mixers (available from Mitsui Mining Company Limited), Super Mixer (available from Kawata MFG Co., Ltd.), conical ribbon mixers/dryers “Ribocone” (available from OKAWARA MFG. CO., LTD.), Vrieco-Nauta™ series mixers, Turbulizer® mixer/coaters, and Cyclomix high shear impact mixers (available from Hosokawa Micron Corporation), spiral pin mixers (available from Pacific Machinery & Engineering Co., Ltd.), and Lodige mixers (available from MATSUBO Corporation); kneaders, extruders, and compounders, such as KRC kneaders (available from KURIMOTO LTD.), Buss co-kneaders (available from BUSS Ltd.), TEM series twin screw compounders (available from TOSHIBA MACHINE CO., LTD.), TEX series twin screw extruders (available from The Japan Steel Works, Ltd.), PCM series twin screw extruders (available from Ikegai Ironworks), three roll mills, mixing roll mills, and kneaders (available from INOUE MANUFACTURING CO., LTD.), Kneadex® open roll extruders (available from Mitsui Mining Company Limited), MS dispersion kneaders and kneader-ruders (available from Moriyama Manufacturing Co., Ltd.), and Banbury mixers (available from KOBE STEEL, LTD.); pulverizers, such as fluid bed opposed jet mills, Micronjet®, and Inomizer (available from Hosokawa Micron Corporation), IDS series and PJM series super sonic jet mills (available from Nippon Pneumatic Mfg. Co., Ltd.), cross jet mills (available from KURIMOTO LTD.), Ulmax® pulverizing systems (available from NISSO ENGINEERING CO., LTD.), vertical jet mill “SK Jet-O-Mill” (available from SEISHIN ENTERPRISE CO., LTD.), Kryptron (available from Kawasaki Heavy Industries, Ltd.), and turbo mills (available from TURBO KOGYO CO., LTD.). Of these, it is preferable to use a mechanical pulverizer such as Kryptron and a turbo mill. As a classier, it is preferable to use Classiell®, Micron classifiers, and Spedic classifiers (available from SEISHIN ENTERPRISE CO., LTD.), turbo classifiers (available from Nisshin Engineering Co., Ltd.), Micron Separator mechanical centrifugal air classifiers, ATP Turboplex classifiers, and TSP High Efficiency Toner classifiers (available from Hosokawa Micron Corporation), Elbow-Jet classifiers (available from Nittetsu Mining Co., Ltd.), Dispersion Separator classifiers (available from Nippon Pneumatic Mfg. Co., Ltd.), and YM Microcut (available from Yasukwa Shoji K. K.). Of these, multiple classifiers are preferable such as Elbow-Jet. Examples of sifters used to sift and separate particles such as coarse particles include ULTRASONICS vibration sifters (available from Koei Sangyo Co., Ltd.), Rezona Sieve and gyro sifters (available from Tokuju Kosakusho K. K.), Vibrasonic sifters (available from DALTON Corporation), Soniclean® ultrasonic cleaners (available from SINTOKOGIO, LTD.), Turbo Screener (available from TURBO KOGYO CO., LTD.), MICROSHIFTER series sifters (available from Makino mfg Co., Ltd.), and other circular vibration sifters.

The following is examples of the additives that may be added to the developer for the purpose of imparting various properties suitable for the present invention.

(1) Abrasives: metal oxides, such as strontium titanate, cerium oxide, aluminum oxide, magnesium oxide, and chromium oxide; nitrides, such as silicon nitride; carbides, such as silicon carbide; and metal salts, such as calcium sulfate, barium sulfate, and calcium sulfate.

(2) Lubricants: fluorine resin powdery particulate, such as polyvinylidene fluoride and polytetrafluoroethylene; silicone resin powdery particulates; metal salts of a fatty acid, such as zinc stearate, and calcium stearate.

These additives may typically be added in an amount of 0.05 to 10 parts by weight, preferably 0.1 to 5 parts by weight, per 100 parts by weight of the toner particles. These additives may be used alone or in combination.

### Image Forming Method, Image Forming Device and Process Cartridge

Next, an image forming method and an image forming apparatus to which the developer of the present invention can suitably be applied are described. A process cartridge of the present invention is also described.

An image forming method according to a first embodiment of the present invention comprises (I) a charging step for charging electrostatically an image-bearing member; (II) a latent image forming step for writing image information as an electrostatic latent image on a charged surface of the image-bearing member that is charged in the charging step; (III) a developing step for visualizing the electrostatic latent image that is formed in the latent image forming step as a toner image with the above-mentioned developer of the present invention; and (IV) a transferring step for transferring the toner image that is formed in the developing step to a transfer material. The charging step is a step of charging electrostatically the image-bearing member by means of applying a voltage to a charging member in the presence of a component of the developer that contains at least the above-mentioned conductive fine powder at a position where the image-bearing member abuts the charging member that is in contact with the image-bearing member. With this method, these steps are repeated to form an image. The image forming method according to the first embodiment relates to an image forming method that charges the image-bearing member in the charging step that uses a so-called contact charging method, at least in the presence of the conductive fine powder contained in the developer of the present invention at a charging region (i.e., an abutting part between the image-bearing member and the contact charging member with the direct injection charging mechanism, while a discharging region in the vicinity of the abutting part that forms a small gap between the image-bearing member and the contact charging member with a discharge-based mechanism).

In the above-mentioned image forming method, it is preferable that the content proportion of the conductive fine powder relative to the total components of the developer that are present in the above-mentioned abutting part is higher than the content proportion of the conductive fine powder contained in the developer.

In the above-mentioned image forming method, it is preferable that the developing step is a step of visualizing the electrostatic latent image and collecting the developer that remains on the surface of the image-bearing member after the transfer of the toner image to the transfer material.

An image forming apparatus according to the first embodiment to which the developer of the present invention can suitably be applied is an image forming apparatus comprising (A) an image-bearing member for bearing an electrostatic latent image; (B) charging means for charging electrostatically the image-bearing member; (C) latent image forming means for forming an electrostatic latent image on the image-bearing member by means of exposing the image-bearing member charged by the charging means; (D) developing means for forming a toner image by means of developing the electrostatic latent image formed by the latent image forming means with the developer of the present invention; and (E) transferring means for transferring the toner image formed by the developing means on the transfer material. The above-mentioned charging means is means for charging electrostatically the image-bearing member by means of applying a voltage to a charging member in the presence of a component of the developer that remains on the image-bearing member after the deposition on the image-bearing member by the developing means and the transfer by the transferring means and that contains at least above-mentioned conductive fine powder at a position where the image-bearing member abuts the charging member that is in contact with the image-bearing member. With this device, toner-based images are repeatedly formed on the image-bearing member.

In the above-mentioned image forming device, it is preferable that the content proportion of the conductive fine powder relative to the total components of the developer that are present in the above-mentioned abutting part is higher than the content proportion of the conductive fine powder contained in the developer.

In the above-mentioned image forming apparatus, it is preferable that the developing means is means for forming the toner image and collecting the developer that remains on the image-bearing member after the transfer of the toner image to the transfer material.

A process cartridge according to a first aspect of the present invention is a process cartridge comprising at least: (I) an image-bearing member for bearing an electrostatic latent image; (II) charging means for charging electrostatically the image-bearing member; and (III) developing means for developing the electrostatic latent image formed on the image-bearing member with a developer to form a toner image, wherein the process cartridge is adapted to be detachably mountable to the main body of an image forming device, the image forming device is for visualizing the electrostatic latent image formed on the image-bearing member with a developer and transferring the visualized toner image to a transfer material to form an image. The charging means is means for charging electrostatically the image-bearing member by means of applying a voltage to a charging member in the presence of a component of the developer that remains on the image-bearing member after the deposition on the image-bearing member by the developing means and the transfer by the transferring means and that contains at least above-mentioned conductive fine powder at a position where the image-bearing member abuts the charging member that is in contact with the image-bearing member.

It is preferable that the developing means is means that comprises at least a developer-carrying member that is opposed to the image-bearing member and a developer layer restricting member that forms a thin developer layer on the developer-carrying member and that the toner image is formed by means of developing the electrostatic latent image formed on the image-bearing member by causing the developer to move from the developer layer on the developer-carrying member to the image-bearing member.

In the above-mentioned process cartridge, it is preferable that the content proportion of the conductive fine powder relative to the total components of the developer that are present in the above-mentioned abutting part is higher than the content proportion of the conductive fine powder contained in the developer.

In the above-mentioned process cartridge, it is preferable that the developing means is means for forming the toner image and collecting the developer that remains on the image-bearing member after the transfer of the toner image to the transfer material.

An image forming method according to a second embodiment of the present invention comprises (i) a charging step for charging electrostatically an image-bearing member; (ii) a latent image forming step for writing image information as an electrostatic latent image on a charged surface of the image-bearing member that is charged in the charging step; (iii) a developing step for visualizing the electrostatic latent image that is formed in the latent image forming step as a toner image with the above-mentioned developer of the present invention; and (iv) a transferring step for transferring the toner image that is formed in the developing step to a transfer material. The developing step is a step of visualizing the electrostatic latent image and collecting the developer that remains on the image-bearing member after the transfer of the toner image to the transfer material. With this method, these steps are repeated to form an image. In this image forming method according to the second embodiment, the developing step uses a cleaning-at-development technique in which the developing step also serves as the cleaning step to collect the developer that remains on the image-bearing member after the transfer of the toner image to the transfer material.

In the above-mentioned image forming method, it is preferable that the charging step is a step for charging the image-bearing member by means of applying a voltage to the charging member that contacts with the image-bearing member.

An image forming apparatus according to the second embodiment to which the developer of the present invention can suitably be applied is an image forming apparatus comprising (a) an image-bearing member for bearing an electrostatic latent image; (b) charging means for charging electrostatically the image-bearing member; (c) latent image forming means for forming an electrostatic latent image on the image-bearing member by means of exposing the image-bearing member charged by the charging means; (d) developing means for forming a toner image by means of developing the electrostatic latent image formed by the latent image forming means with the developer of the present invention; and (e) transferring means for transferring the toner image formed by the developing means on the transfer material. The developing means is means for forming the toner image and collecting the developer that remains on the image-bearing member after the transfer of the toner image to the transfer material. With this apparatus, toner-based images are repeatedly formed on the image-bearing member.

In the above-mentioned image forming apparatus, it is preferable that the charging means is contact charging means for charging the image-bearing member by means of applying a voltage to the charging member that contacts with the image-bearing member.

A process cartridge according to the second embodiment of the present invention comprising at least (i) an image-bearing member for bearing an electrostatic latent image; and (ii) developing means for developing the electrostatic latent image formed on the image-bearing member with the developer of the present invention to form a toner image, wherein the process cartridge is adapted to be detachably mountable to the main body of an image forming apparatus, the image forming apparatus is for developing the electrostatic latent image formed on the image-bearing member with a developer and transferring the developed toner image to a transfer material to form an image. The developing means is means for forming the toner image by means of developing the electrostatic latent image formed on the image-bearing member, and for collecting the developer that remains on the image-bearing member after the toner image is transferred to the transfer material.

It is preferable that the developing means comprises at least a developer-carrying member that is opposed to the image-bearing member and a developer layer restricting member that forms a thin developer layer on the developer-carrying member and that the toner image is formed by causing the developer to move from the developer layer on the developer-carrying member to the image-bearing member.

The above-mentioned process cartridge is a process cartridge that comprises the charging means for charging the image-bearing member. It is preferable that the charging means is contact charging means for charging the image-bearing member by means of the charging member that contacts with the image-bearing member.

Next, the image forming method, the image forming apparatus, and the process cartridge of the present invention are described in detail.

First, the charging step in the image forming method of the present invention is performed by using a contact charging device in which a non-contact charging device such as a corona charger that serves as the charging means, or the image-bearing member that serves as the charged member, is brought into contact with a conductive charging member (a contact charging member, a contact charger) in the form of a roller (charge roller), a fur brush, a magnetic brush or a blade. A charge bias is applied to the contact charging member (hereinafter, referred to as a “contact charging member”) to charge the surface of the charged member to a predetermined polarity and potential. In the present invention, it is preferable to use a contact charging device because contact charging devices produce a smaller amount of ozone and consume lower electric power, as compared with a non-contact charging device such as a corona charger.

The transfer-residual toner particles on the image-bearing member include those corresponding to an image pattern to be formed and those of so-called fog toner corresponding to a region where no image is formed. The transfer-residual toner particles corresponding to an image pattern to be formed are difficult to be completely collected in the cleaning-at-development step. When they are collected insufficiently, a pattern ghost may appear under which insufficient collection is reflected to a subsequent image forming cycle.

Collectability of such transfer-residual toner particles corresponding to an image pattern can be improved significantly in the cleaning-at-development step when patterns of the transfer-residual toner particles are leveled or made even.

For example, in a contact developing process, when the developer-carrying member carrying the developer and the image-bearing member contacting the developer-carrying member are moved with a relative speed difference, the pattern of the transfer-residual toner particles can be leveled and the transfer-residual toner particles can be collected more effectively. However, in the above-mentioned contact development process, a large amount of the transfer-residual toner particles may be left on the image-bearing member as by instantaneous power failure or paper clogging, the patterns of the transfer-residual toner particles on the image-bearing member obstruct the formation of a latent image, such as the exposure. Therefore, it is difficult to solve the problem of a patter ghost.

In contrast, when a contact charging device is used, the pattern of the transfer-residual toner particles can be leveled by the contact charging member. This leveling makes it possible to effectively collect the transfer-residual toner particles even when the developing step is based on the non-contact scheme. Production of a pattern ghost due to insufficient collection can be obviated. Furthermore, even when a large amount of the transfer-residual toner particles are left on the image-bearing member, the contact charging member serves to once dam the transfer-residual toner particles, level the patterns of the transfer-residual toner particles and gradually supply them to the image-bearing member. In this manner, a pattern ghost due to obstruction of forming the latent image can be avoided. As to possible deterioration of the charging properties of the image-bearing member as a result of contamination of the contact charging member which would be caused when a large amount of the transfer-residual toner particles are dammed by the contact charging member, the developer of the present invention restricts this problem of the reduction in charging properties of the image-bearing member to a certain level at which practically no problem arises. From this point of view, it is preferable in the present invention to use a contact charging device.

In the present invention, it is preferable to provide a relative difference in movement speed between the charging member and the image-bearing member. This relative speed difference can result in remarkable increase in torque that acts between the contact charging member and the image-bearing member and remarkable increase in abrasion of the contact charging member and the image-bearing member. However, the developer provides a lubricating effect (i.e., friction-reducing effect) when present at the contact part between the contact charging member and the image-bearing member. This makes it possible to provide such a surface speed difference without remarkable increase in torque or remarkable abrasion.

In the present invention, it is preferable that components of the developer containing at least conductive fine powder are present at the abutting part between the image-bearing member and the charging member that is brought into contact with the image-bearing member. The presence of the components of the developer containing at least conductive fine powder at the above-mentioned abutting part ensures an electrically conductive channel between the image-bearing member and the contact charging member. This serves to restrict deterioration of the charging properties of the image-bearing member which otherwise would occur as a result of deposition or incorporation of the transfer-residual toner particles on or into the contact charging member

In the present invention, it is also preferable that the content proportion of the conductive fine powder relative to the total components of the developer at the abutting part between the image-bearing member and the charging member that is brought into contact with the image-bearing member is larger than the content proportion of the conductive fine powder in the above-mentioned developer of the present invention (the conductive fine powder in the developer before the formation of an image of the present invention). With the content of the conductive fine powder relative to the total components of the developer at the abutting part that is larger than the content of the conductive fine powder in the developer, the deterioration in charging properties of the image-bearing member due to deposition or incorporation of the transfer-residual toner particles on or into the contact charging member can be restricted more reliably.

In the present invention, it is preferable that the charging is achieved by means of a charging method mainly using the direct injection charging mechanism. With the direct injection charging mechanism, the components of the developer containing at least the conductive fine powder are introduced at the abutting part between the image-bearing member and the charging member that is brought into contact with the image-bearing member. Consequently, in addition to the effect of restricting deterioration in charging properties of the image-bearing member due to deposition or incorporation of the transfer-residual toner particles on or into the contact charging member, it is ensured that the image-bearing member contacts with the charging member more closely. In other words, they are in more close contact through the conductive fine powder. This provides an effect of actively improving the charging properties of the image-bearing member. Based on the direct injection charging mechanism, with the content proportion of the conductive fine powder relative to the total components of the developer at the abutting part that is larger than the content proportion of the conductive fine powder in the developer, the effect of actively improving the charging properties of the image-bearing member may further be enhanced.

For the content proportion of the conductive fine powder relative to the total components of the developer at the abutting part between the image-bearing member and the charging member that is brought into contact with the image-bearing member, elements contained in the conductive fine powder may be quantitatively analyzed by using an X-ray fluorescence spectrometer. Alternatively, the content proportion of the conductive fine powder may be compared in the following manner. Comparison is made between a photograph of the developer components (present at the abutting part) taken in an enlarged form through a scanning electron microscope and a photograph of the developer components that are mapped with elements contained in the conductive fine powder by using element analyzing means such as an X-ray microanalyzer (XMA) associated with the scanning electron microscope. The conductive fine powder, which is either deposited on the surface of the toner particles or is freely moved, are specified. In this event, the images of the specified conductive fine powder are supplied to an image processor, through photographs of the developer component taken in an enlarged form through a scanning electron microscope or through image information introduced via an interface from the scanning electron microscope.

The photographs or image information are analyzed to determine a ratio between an area of an image of the specified particles of the conductive fine powder and an area of an image of other developer component (toner particle) Likewise, a ratio is obtained between an area of an image of the specified particles of the conductive fine powder in the developer before the actual formation of an image and an area of an image of other developer component (toner particle). Comparison with the previously determined ratio of the developer component at the above-mentioned abutting part provides a comparison of the content of the conductive fine powder.

The charge bias voltage applied to the contact charging member may comprise a DC voltage alone or a DC voltage in superposition with an AC voltage (or AC voltage) to provide good charging properties of the image-bearing member. The AC voltage may have any appropriate waveform of sine waves, rectangular waves, triangular waves, etc. The AC voltage can also comprise pulsed voltages formed by periodically turning on and off a DC power supply. In this way, any bias waveform of voltage periodically changing voltage values can be used as such an AC voltage.

In the present invention, it is preferable that the charge bias voltage that is applied to the contact charging member is lower than a discharge initiation voltage between the contact charging member and the charged member (image-bearing member). When an applied charge bias is higher than the discharge initiation voltage, discharge products such as ozone or NOx produced by the discharge are deposited on or corrode the image-bearing member, resulting in deterioration of the performance of the image-bearing member. Therefore, it is preferable that the contact charging process is based mainly on the direct injection charging mechanism with which the charging properties can be achieved at an applied charge bias that is lower than the discharge initiation voltage.

In the cleaning-at-development method, the charging properties of the image-bearing member may often be lowered due to the contact, deposition or incorporation of the insulating transfer-residual toner particles that are left on the image-bearing member to, on, or into the contact charging member. This deterioration in charging properties suddenly appears with a resistivity at which the toner layer deposited on the surface of the contact charging member obstructs the discharge in the charging process mainly based on the discharge-based mechanism. In contrast, in the charging process mainly based on the direct injection charging mechanism, the uniform charging properties of the charged member (image-bearing member) is lowered by the decrease in probability of contact between the contact charging member and the image-bearing member due to the deposited or incorporated transfer-residual toner particles. This lowers the contrast and uniformity of the electrostatic latent images, resulting in a lower image density or increased fog.

In view of differences in deterioration of charging properties between the discharge-charging mechanism and the injection-charging mechanism, an effect of preventing deterioration of the charging properties of the image-bearing member or an effect of enhancing the charging that is achieved by means of providing at least the conductive fine powder at the contact part between the image-bearing member and the charging member that is brought into contact with the image-bearing member is more noticeable in the direct injection charging mechanism. Accordingly, it is preferable to use the developer of the present invention in the direct injection charging mechanism.

In order to prevent the toner that is deposited on or incorporated into the contact charging member from obstructing the discharge in the discharge-charging mechanism by means of providing at least the conductive fine powder at the contact part between the image-bearing member and the charging member that is brought into contact with the image-bearing member, it is necessary that the content proportion of the conductive fine powder is larger than the content proportion of the total components of the developer present at the abutting part between the image-bearing member and the charging member that is brought into contact with the image-bearing member. Taking this into consideration, when a large amount of the transfer-residual toner particles are deposited on or incorporated into the contact charging member, it is necessary to sweep out a larger amount of the transfer-residual toner particles to the image-bearing member in order to reduce the amount of the transfer-residual toner particles deposited on or incorporated into the contact charging member and prevent the toner from having a resistivity that obstructs the discharge. This makes it easier to obstruct the formation of a latent image. In contrast, in the direct injection charging mechanism, by means of providing at least the conductive fine powder at the contact part between the image-bearing member and the charging member that is brought into contact with the image-bearing member it is easy to ensure contact points between the contact charging member and the charged member via the conductive fine powder. Thus, it is possible to prevent reduction in contact probability between the contact charging member and the charged member due to deposition or incorporation of the transfer residual toner particles on or into the contact charging member and thus suppress deterioration of the charging properties of the image-bearing member.

In particular, when a relative difference in movement speed is provided between the surface of the contact charging member and the surface of the image-bearing member, the rubbing between the contact charging member and the image-bearing member reduces the amount of the total components of the developer that are present at the contact part between the abutting part between the image-bearing member and the contact charging member. Obstruction of the charging on the image-bearing member can be prevented more reliably, and the opportunity of the conductive fine powder to contact the image-bearing member at the abutting part between the contact charging member and the image-bearing member is remarkably increased. This enhances the direct injection-based charging through the conductive fine powder. On the other hand, the discharge-based charging occurs at a non-contact region where the image-bearing member and the contact charging member is disposed with a small gap therebetween rather than at the above-mentioned abutting part. Thus, a limited amount of the total components of the developer that are present at the abutting part is not expected to suppress the obstruction of the charging. From this point of view, it is also preferable that the present invention is performed mainly by using the direct injection charging mechanism. In order to realize a charging process which mainly uses the direct injection charging mechanism without relying on the discharge-based mechanism, it is preferable that the maximum voltage of the charge bias that is applied to the contact charging member is lower than the discharge initiation voltage between the contact charging member and the charged member (image-bearing member).

It is preferable that a relative speed difference between the surfaces of the contact charging member and the image-bearing member is provided by means of rotation-driving the contact charging member.

In the present invention, it is preferable that the opposing surfaces of the charging member and the image-bearing member move in the opposite directions relative to each other.

Likewise, it is preferable that the opposing surfaces of the contact charging member and the image-bearing member move in the opposite directions relative to each other in order to enhance the effect of temporarily collecting in the contact charging member the transfer-residual toner particles on the image-bearing member that are brought to the contact charging member. For example, the contact charging member is rotation-driven so that the surfaces of the opposing contact charging member and the image-bearing member move in the opposite directions relative to each other. Such movement in the opposite directions contributes to separating the transfer-residual toner particles from the image-bearing member to advantageously effect the direct injection-based charging and suppressing the obstruction of the formation of a latent image. Furthermore, an improved effect of leveling the pattern of the transfer-residual toner particles in turn improves the collectability of the transfer-residual toner particles in the cleaning-at-development step. A pattern ghost due to insufficient collection can be prevented more reliably.

It is possible to provide a relative surface speed difference by moving the charging member and the image-bearing member in the same direction. However, as the charge properties in the direct injection-based charging depend on a ratio of movement speeds between the image-bearing member and the contact charging member. A higher speed is thus required for the movement in the same direction than for the movement in the opposite directions in order to obtain an identical relative movement speed difference. This is disadvantageous. Furthermore, the movement in the opposite directions is more advantageous also in order to attain an effect of leveling the pattern of the transfer-residual toner particles on the image-bearing member.

In the present invention, it is preferable that a ratio of movement speeds (ratio of relative movement speeds) between the opposing image-bearing member and the charging member is 10 to 500%, more preferably 20 to 400%. When the ratio of the relative movement speed is lower than the 10%, it is impossible to sufficiently increase the probability of contact between the contact charging member and the image-bearing member. Accordingly, it is difficult to maintain the charging properties of the image-bearing member in combination with the direct injection charging mechanism. It is further difficult to obtain the effect of suppressing obstruction of charging on the image-bearing member by means of reducing the amount of the total components of the developer that are present at the abutting part between the image-bearing member and the contact charging member by rubbing the contact charging member and the image-bearing member, and the effect of leveling the pattern of the transfer-residual toner particles to enhance the collectability of the developer in the cleaning-at-development step. On the other hand, when the ratio of the relative movement speed is higher than 500%, the charging member is moved at a high speed. The developer components that are brought to the abutting part between the image-bearing member and the contact charging member may often be scattered in the device to cause pollution, and the image-bearing member and the contact charging member are more easily abraded or damaged. Consequently, the useful life thereof would be shortened.

When the moving speed of the charging member is zero (the charging member is kept sill), the charging member contacts the moving image-bearing member at a fixed point. The portion of the charging member that contacts the image-bearing member tends to be abraded or deteriorated. This often reduces the effect of suppressing obstruction of charging on the image-bearing member and the effect of leveling the pattern of the transfer-residual toner particles to enhance collection of toner in the cleaning-at-development step.

A ratio of the relative movement speed described herein can be given according to the following formula:

Ratio of relative movement speed (%)=|(Vc−Vp)/Vp|×100,

wherein Vc is a movement speed on the surface of the charging member and Vp is a movement speed of the image-bearing member. The sign of Vc is the same when the surface of the charging member moves in the same direction as the surface of the image-bearing member at the abutting part.

In the present invention, it is preferable that the contact charging member has an elasticity so as to temporarily collect the transfer-residual toner particles on the image-bearing member in the charging member, carry the conductive fine powder with the charging member, and provide an abutting part that is a contact portion between the image-bearing member and the charging member, thereby advantageously affecting the direct injection-based charging. This elasticity is also preferable in terms of allowing the contact charging member to level the pattern of the transfer-residual toner particles, thereby to improve the collectability of the transfer-residual toner particles.

In the present invention, it is preferable that the charging member is conductive in order to make it possible to charge the image-bearing member by applying a voltage to the charging member. More specifically, the charging member may preferably be achieved as a conductive elastic roller, a magnetic-brush contact charging member comprising a magnetic brush formed of magnetic particles constrained under a magnetic force and disposed in contact with the charged member, or a brush comprising conductive fibers.

The conductive elastic roller should have an appropriate hardness as the roller member. An excessively low hardness results in poor contact between the roller and the charged member because of an unstable shape. The components of the developer that are present at the charge abutting part abrade or damage the surface layer of the conductive elastic roller. Thus, it is difficult to provide stable charging properties of the image-bearing member. On the other hand, an excessively high hardness makes it difficult to ensure uniform charging properties by direct injection because enough charge abutting parts cannot be provided between the roller and the charged member. The higher hardness may result in a poor microscopic contact between the roller and the surface of the charged member (image-bearing member). The effect of leveling the pattern of the transfer-residual toner particles would be reduced, thus it is difficult to enhance the collectability of the transfer-residual toner particles. This problem may partly be solved by means of increasing a contact pressure of the roller charging member against the image-bearing member to sufficiently provide the charge abutting parts and the leveling effect. However, this leads abrasion or damage of the contact charging member or the image-bearing member. From these points of view, the conductive elastic roller may preferably have an Asker-C hardness of 25 to 50, and more preferably 25 to 40, as the roller member. A certain hardness of the contact charging member can be obtained by means of appropriately selecting a material and adjusting the hardness according to a well-known method.

In the present invention, it is preferable that the roller member that serves as the contact charging member has small cells or irregularities in its surface so as to retain more conductive fine particles thereon. With the contact charging member having small cells or irregularities in its surface, it is possible to lower the contact pressure of the image-bearing member against the contact charging member to provide enough charge abutting parts for better injection charging of the image-bearing member. Abrasion and damages of the charging member and the image-bearing member can be reduced. The pattern of the transfer-residual toner particles is leveled to a higher degree, the collectability of the transfer-residual toner particles can be improved. The surface of the contact charging member having small cells or irregularities may be formed by using a well-known method. Using a foam material for at least the surface layer of the roller member is one of preferable modes of the contact charging member.

In addition to the elasticity for attaining sufficient contact with the image-bearing member, it is important for the conductive elastic roller to function as an electrode having a sufficiently low resistivity for charging the moving image-bearing member. On the other hand, in case where the image-bearing member has a surface defect, such as a pinhole, it is necessary to prevent leakage of the charge bias. When an image-bearing member such as an electrophotographic photosensitive member is used, in order to have sufficient charging properties and leakage resistance, the conductive elastic roller may preferably have a resistivity of 10³ to 10⁸ Ω·cm, more preferably 10⁴ to 10⁷ Ω·cm. The resistivity of the roller described herein may be measured by pressing the roller against a cylindrical aluminum drum having a diameter of 30 mm to force the conductive elastic roller against the aluminum drum under a linear pressure of 39.2 N/m (with a load of 39.2 N per a contact area of 1 m), applying a voltage of 100 V between the core metal of the elastic roller and the aluminum drum.

Such a conductive elastic roller may be prepared by forming a medium resistivity layer of rubber or a foam material (as a flexible member) on a core metal. The medium resistivity layer may be produced in the shape of a roller on the core metal with an appropriate composition comprising a resin (of, e.g.., urethane), conductive particles (of, e.g., carbon black), a sulphidizing agent and a foaming agent. Thereafter, a post-treatment, such as cutting or surface polishing, for shape adjustment may be performed to provide a conductive elastic roller.

The conductive elastic roller may be formed of various materials which are not limited to an elastic foam material. Examples of a material for the elastic member include rubber materials obtained by dispersing a conducive substance, such as carbon black or a metal oxide, for resistivity adjustment in ethylene-propylene-diene polyethylene (EPDM), urethane, butadiene-acrylonitrile rubber (NBR), silicone rubber or isoprene rubber. It is also possible to use a foam product of such an elastic conductive material. Alternatively, a resistivity adjustment may be effected by using an ionically conductive material alone or together with a conductor substance as described above rather than dispersing the conductive substance.

The conductive elastic roller is disposed under a predetermined pressure against the image-bearing member that serves as the charged member while resisting the elasticity thereof to provide a charge abutting part between the conductive elastic roller and the image-bearing member. The width of the abutting part is not particularly limited but may preferably be at least 1 mm, more preferably at least 2 mm, so as to provide close contact between the conductive elastic roller and the image-bearing member in a stable manner. The width of the charge abutting part may be adjusted and controlled depending on, for example, elasticity of the conductive elastic roller, pressure of the conductive elastic roller against the image-bearing member, the diameter of the conductive elastic roller and the image-bearing member, or curvature at contact portions.

The charging member used in the charging step of the present invention may also be in the form of a brush (brush member) comprising conductive fibers. In such a case, the voltage is applied to the brush to charge the image-bearing member. The charging brush as the contact charging member may comprise typical fibers containing a conductor dispersed therein for resistivity adjustment. The fiber may be one of well-known fibers. Examples thereof include nylon, acrylic resin, rayon, polycarbonate or polyester fibers. The conductor may be one of well-known conductors. Examples thereof include conductive metals, such as nickel, iron, aluminum, gold and silver; conductive metal oxides, such as iron oxide, zinc oxide, tin oxide, antimony oxide and titanium oxide; and conductive powder such as carbon black. The conductors may be surface-treated for hydrophobization or resistivity adjustment, as desired. These conductors may appropriately be selected in view of dispersibility with the fiber material and productivity.

The charging brush used as the contact charging member may be a fixed type or a rotatable roll type. A roll charging brush may be formed by, for example, winding a tape to which conductive fiber piles are inserted on a core metal in a spiral form. The conductive fiber may preferably have a thickness of 1 to 20 deniers (fiber diameter of approximately 10 to 500 μm) and a brush fiber length of 1 to 15 mm, a brush density of 1.5×10⁷ to 4.5×10⁸ fibers per square meter (10,000 to 300,000 fibers per one square inch).

The charging brush may preferably have as high a brush density as possible. It is also preferable to use a thread or fiber composed of several to several hundred fine filaments, e.g., threads of 300 deniers/50 filaments, with each thread composed of a bundle of 50 filaments of 300 deniers. In the present invention, however, the charging points in the direct injection-based charging are principally determined by the density of conductive fine powder that are present at the charge abutting part and in its vicinity between the charging member and the image-bearing member, so that there are much more options for the charging member materials.

As in the case of the elastic conductive roller, the charging brush may preferably have a resistivity of 10³ to 10⁸ Ω·cm, more preferably 10⁴ to 10⁷ Ω·cm so as to provide sufficient charging properties and leakage resistance of the image-bearing member. The resistivity of the charging brush may be measured in a similar manner to that described in conjunction with the conductive elastic roller.

Commercially available examples of the materials for the charging brush include: conductive rayon fibers REC-B, REC-C, REC-M1 and REC-M10 (UNITIKA LTD.), SA-7 (Toray Industries, Inc.), Thunderon® (Nihon Sanmo Dyeing Co., Ltd.), BELLTRON® (Kanebo, Ltd.), carbon-containing conductive fiber CLACARBO® (Kuraray Co., Ltd.) and ROVAL® (Mitsubishi Rayon Co., Ltd.). Of these, REC-B, REC-C, REC-M1 and REC-M10 are particularly preferable in view of their environmental stability.

The contact charging member may preferably have a flexibility so as to increase the opportunity of the conductive fine powder to contact the image-bearing member at the charge abutting part. This provides higher contactability and better charging properties in the direct injection-based charging. By having the contact charging member very closely contact the image-bearing member through the conductive fine powder and having the conductive fine powder rub the surface of the image-bearing member without discontinuity, the image-bearing member can be charged by the contact charging member without any discharge. Instead, the image-bearing member can be charged by using a stable and safe direct injection charging mechanism through the conductive fine powder. With the direct injection-based charging being applied to the image forming method of the present invention, it becomes possible to attain a high charging efficiency that cannot be achieved by conventional roller charging that uses the discharge-based mechanism. The image-bearing member is applied with a potential that is almost equal to the voltage applied to the contact charging member accordingly. Flexibility of the contact charging member enhances the effect of temporarily damming the transfer-residual toner particles and the effect of leveling the pattern of the transfer-residual toner particles, when a large amount of the transfer-residual toner particles are supplied to the contact charging member. Consequently, it is possible to avoid more reliably a defect of images due to obstruction of the formation of a latent image and insufficient collection of the transfer-residual toner particles.

When the amount of the conductive fine powder that is present at the charge abutting part is too small, the lubricating effect of the conductive fine powder cannot be sufficiently attained. This results in a large friction between the image-bearing member and the contact charging member, so that it may become difficult to rotation-drive the contact charging member with a speed difference relative to the image-bearing member. As a result, the drive torque is increased, and if the contact charging member is forcibly driven, the surfaces of the contact charging member and the image-bearing member may be abraded. The effect of increasing the contact opportunity owing to the conductive fine powder may not be attained. It becomes difficult to attain sufficient charging properties of the image bearing member. On the other hand, when the amount of the conductive fine powder that is present at the above-mentioned abutting part is excessively large, the falling of the conductive fine powder from the contact charging member is increased. It may often cause adverse effects such as obstruction of the formation of a latent image due to interception of imagewise exposure light beams.

According to the studies of the present inventors, it is preferable that the conductive fine powder particles are present at the charge abutting part in an amount of at least 10³ particles/mm², more preferably at least 10⁴ particles/mm². When the conductive fine powder particles are present in an amount of at least 10³ particles/mm², the lubricating effect of the conductive fine powder is sufficiently attained without increasing the driving torque. With the amount smaller than 10³ particles/mm², it is difficult to sufficiently attain the lubricating effect and the effect of increasing the contact opportunity, which may lead deterioration in charging properties of the image-bearing member. When the direct injection-based charging is used for uniform charging of the image-bearing member in the cleaning-at-development step, the charging properties of the image-bearing member may be deteriorated due to deposition or incorporation of the transfer-residual toner particles on or into the charging member. In order to provide better direct injection-based charging while controlling the deposition and incorporation of the transfer-residual toner particles on and into the charging member and overcoming the problem of charge obstruction that is caused by the deposition or incorporation of the transfer-residual toner particles on or into the transfer-residual toner particles, it is preferable that the conductive fine powder particles are present in an amount of at least 10⁴ particles/mm² at the abutting part between the image-bearing member and the contact charging member. With a smaller amount than 10⁴ particles/mm², the charging properties of the image-bearing member may often be deteriorated especially when the amount of the transfer-residual toner particles is relatively large.

An appropriate amount of the conductive fine powder on the image-bearing member in the charging step is also determined depending on the density of the conductive fine powder affecting the uniform charging properties of the image-bearing member.

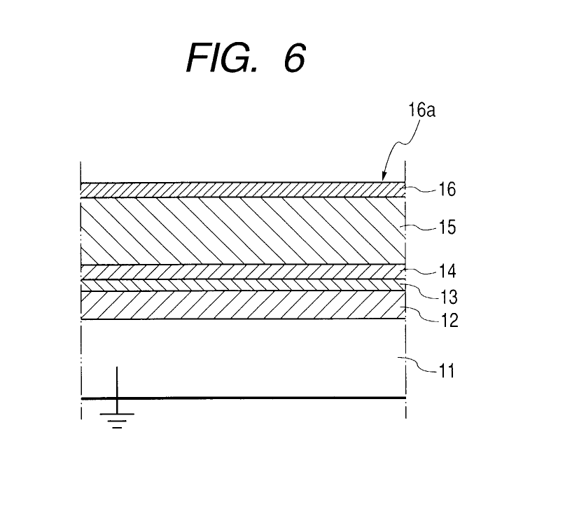

It is needless to say that more uniform contact charging is required during charging than at least the recording resolution. However, in view of a profile of a human eye's visual characteristic curve as shown in FIG. 4, discriminatable gradation levels approach infinitely to 1 at a higher spatial frequency than 10 mm⁻¹, that is, uneven densities are imperceptible to the eye. Making good use of this characteristic, a density of at least 10 mm⁻¹ is enough for the conductive fine powder particles when they are deposited on the image-bearing member for the direct injection-based charging. Even if a minor faulty charging is generated on the portion of the image-bearing member where no conductive fine powder particles are present, uneven densities of the image due to the faulty charging appear in a region with a spatial frequency that is imperceptible to the human visual sensitivity. Therefore, no practical problem arises on the resultant images.

As to whether the faulty charging on the image-bearing member is perceptible as uneven densities in the resultant images when the application density of the conductive fine powder fluctuates, only a small amount (e.g., 10 particles/mm²) of the conductive fine powder applied to the image-bearing member can demonstrate an effect of suppressing the unevenness in density. However, this is insufficient from the viewpoint whether the uneven densities are tolerable to the human eyes. An application amount of at least 10² particles/mm² provides a remarkably preferable effect by objective evaluation of the image. Further, an increased amount of 10³ particles/mm² or larger eliminates any problems associated with images attributable to the faulty charging.

Charging procedures based on the direct injection charging mechanism are basically different from those based on the discharge-based mechanism. For the former case, the charging is effected through close and reliable contact between the contact charging member and the image-bearing member. However, even when an excess amount of conductive fine powder is applied to the image-bearing member, there still remain portions on the image-bearing member where no conductive fine powder can access. This problem is, however, solved for practical applications by means of applying the conductive fine powder while making good use of the above-mentioned visual characteristics of the human eyes.

An effective amount of the conductive fine powder on the image-bearing member has the upper limit that is determined by a single layer of the conductive fine powder uniformly applied to the image-bearing member. A larger amount does not provides better effects of the conductive fine powder. Instead, an excess amount of the conductive fine powder may be swept onto the image-bearing member after the charging step, sometimes causing problems such as interruption or scattering of exposure light beams from the light source.

Further, it has been found, from experiments about the effects of enhancing the collectability of the transfer-residual toner particles in the cleaning-at-development step depending on the amount of the conductive fine powder on the image-bearing member, that an amount of the conductive fine powder particles in excess of 10² particles/mm² on the image-bearing member after the charging step and before the developing step improves collectability of the transfer-residual toner particles as compared with the case where no conductive fine powder is present on the image-bearing member. This effect can be achieved without any defect of images in the cleaning-at-development step until or around the uniform single layer of the conductive fine powder is formed on the image-bearing member.

With the amount of the conductive fine powder particles at the charge abutting part of at least 10³ particles/mm², and the amount of the conductive fine powder particles on the image-bearing member of at least 10² particles/mm², the charging properties of the image-bearing member are improved and the collectability of the transfer-residual toner particles is also improved. It is preferable that the conductive fine powder particles are present at the abutting part between the image-bearing member and the contact charging member in an amount of at least 10⁴ particles/mm².

The relationship between the amount of the conductive fine powder at the abutting part between the image-bearing member and the contact charging member and the amount of the conductive fine powder on the image-bearing member in the latent image forming step, is determined depending on various factors such as: (1) the amount of supply of the conductive fine powder to the abutting part between the image-bearing member and the contact charging member, (2) adhesion of the conductive fine powder onto the image-bearing member and the contact charging member (which is associated with, for example, a particle diameter, a shape and surface properties of the conductive fine powder), (3) the retentivity of the conductive fine powder by the contact charging member, and (4) the retentivity of the conductive fine powder by the image-bearing member. However, experiments have indicated that the amount of the conductive fine powder in the range of 10³ to 10⁶ particles/mm² at the abutting part between the image-bearing member and the contact charging member resulted in amounts of the conductive fine powder falling on the image-bearing member (i.e., the amount of the conductive fine powder on the image-bearing member in the latent image forming step) in the range of 10² to 10⁵ particles/mm².

The upper limit of amount of the conductive fine powder on the image-bearing member depends on various factors as described above. However, the conductive fine powder may scatter from the charging member or from the image-bearing member with the amount of the conductive fine powder on the image-bearing member of about 10⁵ particles/mm². This may cause pollution inside the apparatus. On the other hand, the developer of the present invention contains the conductive fine powder having the number-average particle diameter of the primary particles of 50 to 500 nm. The developer comprises the agglomerated matters of the primary particles. Further, the developer has the particle size distribution that satisfies the above-mentioned requirements for the developer of the present invention. The conductive fine powder demonstrates good adhesion to the image-bearing member and the contact charging member. No scattering of the conductive fine powder would occur until the amount of the conductive fine powder on the image-bearing member reaches about 10⁶ particles/mm². There is a higher tolerance for the amount of the conductive fine powder on the image-bearing member. This makes it possible to achieve stable and satisfactory level of the direct injection-based charging and cleaning-at-development without any pollution inside the apparatus and without any defect of images which otherwise would occur due to obstruction of exposure.

Description is now made in conjunction with a method for measuring the amount of the conductive fine powder at the charge abutting part and measuring the amount of the conductive fine powder on the image-bearing member in the latent image forming step (i.e., after the charging step and before the developing step). The amount of the conductive fine powder at the charge abutting part may preferably be measured directly on a contact surface between the contact charging member and the image-bearing member. However, when a relative difference in movement speed is provided between the surface of the contact charging member that forms the charge abutting part and the image-bearing member that is opposed to the charging member, the charging member that moves in the opposite direction in contact therewith sweeps out most portions of the particles on the image-bearing member before they are brought into contact with the contact charging member. Therefore, the amount of the particles on the surface of the contact charging member just before they reach the contact surface is defined as the amount in question in the present invention. More specifically, the image-bearing member and the contact charging member are stopped without application of any charge bias. The surfaces of the image-bearing member and the contact charging member are photographed through a video microscope (“OVM 1000N” available from Olympus Optical Co., Ltd.) and a digital still recorder (“SR-310” available from DELTIS). For the contact charging member, the contact charging member is abutted to a slide glass under the same conditions as in the case of the image-bearing member. The contact surface is photographed at 10 spots or more through the slide glass using an objective lens having a magnification of 1,000 of the video microscope. The digital images that are thus obtained are processed into binary data with a certain threshold for regional separation of individual particles, and the -number of regions with particles present is counted by an appropriate image processing software product. As to the amount on the image-bearing member, photographs of the image-bearing member are taken in a similar manner through the video microscope. Then, similar processing is performed.

The amount of the conductive fine powder on the image-bearing member is measured by means of taking photographs of the surface of the image-bearing member after the transferring step and before the charging step, and after the charging step and before the developing step, in a similar manner to the one described above using the same image processing software product as in the above.

In the present invention, the outermost layer of the image-bearing member preferably has a volume resistivity of 1×10⁹ to 1×10¹⁴ Ω·cm, more preferably, 1×10¹⁰ to 1×10¹⁴ Ω·cm. This range of volume resistivity gives results in good charging of the image-bearing member and is thus preferable. Using the direct injection charging mechanism, reduction in resistivity of the member to be charged allows much more efficient transfer of the charges. To this end, the outermost layer preferably has a volume resistivity of not higher than 1×10¹⁴ Ω·cm. On the other hand, in order to retain the electrostatic latent image as the image-bearing member for a certain period of time, the outermost layer preferably has a volume resistivity of at least 1×10⁹ Ω·cm. In order to retain the electrostatic latent image under a high humidity environment without producing minute disturbance of latent images, the outermost layer preferably has a volume resistivity of at least 1×10¹⁰ Ω·cm.

The image-bearing member may be an electrophotography photosensitive member and the outermost layer of the electrophotography photosensitive member may have a volume resistivity of 1×10⁹ Ω·cm to 1×10¹⁴ Ω·cm. This range of volume resistivity is preferable because a sufficient level of charging can be applied to the image-bearing member even in an apparatus with a higher process speed.

It is preferable that the image-bearing member is provided in the form of a photosensitive drum or a photosensitive belt having a layer of a photoconductive insulating material, such as amorphous selenium, CdS, ZnO₂, amorphous silicon or an organic photoconductor. In particular, a photosensitive member having an amorphous silicon photosensitive layer or an organic photosensitive layer is advantageously used.

The organic photosensitive layer may be a single photosensitive layer that comprises a charge-generating substance and a substance having charge-transporting properties. Alternatively, the organic photosensitive layer may be a function-separated photosensitive layer that comprises a charge transport layer and a charge generation layer. A laminate photosensitive layer comprising a charge generation layer and a charge transport layer laminated in this order on a conductive substrate is a preferred example.

By adjusting the surface resistivity of the image-bearing member, it is possible to achieve the uniform charging of the image-bearing member in a more stable and uniform manner.

In order to effect a surface resistivity adjustment of the image-bearing member so as to promote injection of charges at higher efficiency it is also preferable to dispose a charge injection layer on the surface of the electrophotographic photosensitive member. The charge injection layer may preferably comprise a resin with conductive fine particles dispersed therein.

Such a charge injection layer may for example be provided in any of the following forms:

(i) a charge injection layer is disposed on an inorganic photosensitive member of, e.g., selenium or amorphous silicon, or on a single-layer organic photosensitive member;

(ii) a charge transport layer as a surface by comprising a charge-transporting material and a resin in the function-separated organic photosensitive member is also caused to have the function of a charge injection layer (for example, a charge transport layer is formed from a resin, a charge-transporting material and conductive particles dispersed therein, or a charge transport layer is also provided with a function of a charge injection layer by selection of the charge-transporting material or the state of presence of the charge-transporting material);

(iii) a functional-separated organic photosensitive member is provided with a charge injection layer as the outermost layer. In any of the above forms, it is important that the outermost layer has a volume resistivity in the above-mentioned preferred range.

The charge injection layer may, for example, be formed as an inorganic material layer, such as a metal deposition film, or a resin layer formed of a binder resin with the conductive fine particles dispersed therein. The deposition film is formed by using vapor deposition. The resin layer formed of the binder resin with the conductive fine particles dispersed therein may be formed by appropriate coating methods, such as dipping, spray coating, roller coating or beam coating. Such a charge injection layer may also be formed by blending or copolymerizing an insulating binder resin with a phototransmissive resin having an ionic conductivity, or by using a photoconductive resin alone having a medium resistivity as mentioned above.

It is particularly preferred to use the image-bearing member with a resin layer containing at least conductive fine particles of metal oxide (hereinafter, “metal oxide conductive fine particles”) dispersed therein as the outermost layer of the image-bearing member. With the outermost layer of the image-bearing member having such configuration, the electrophotographic photosensitive member has a lower surface resistivity. This allows the charge transfer more efficiently. The lower surface resistivity is preferable because it suppresses the blurring or flowing of a latent image caused by diffusion of the charges of the latent image while the image-bearing member retains electrostatic latent images thereon.

In case of the resin layer having the above-mentioned metal oxide conductive fine particles dispersed therein, it is preferable that the metal oxide conductive fine particles have a particle diameter that is smaller than the wavelength of an exposure light beam that is incident thereto, so as to avoid the scattering of incident light by the dispersed particles. With this respect, it is preferable that the metal oxide conductive fine particles have a particle diameter of 0.5 μm or smaller. The amount of the metal oxide conductive fine particles may preferably be 2% to 90% by weight, more preferably, 5% to 70% by weight, with respect to the total weight of the outermost layer. A lower amount of the metal oxide conductive fine particles makes it difficult to obtain a desired volume resistivity. A larger amount often lowers a film strength. The charge injection layer may often be abraded, shortening the useful life of the photosensitive member. Further, an excessively lower resistivity often results in a defect of images due to flow of a latent image potential.

The charge injection layer may preferably have a thickness of 0.1 to 10 μm, more preferably 5 μm or smaller so as to retain a sharpness of the latent image contour. In view of the running performance of the charge injection layer, the thickness of at least 1 μm is preferable.

The charge injection layer may comprise a binder resin that is identical to that for a lower side layer. In this case, however, the coating surface of the lower side layer (e.g., charge transport layer) may be damaged during the application of the charge injection layer. Accordingly, the application method should be selected to avoid any possible problems.

The volume resistivity of the outermost layer of the image-bearing member of the present invention may be measured in the following manner. A layer of the same composition as that of the outermost layer of the image-bearing member is formed on a polyethylene terephthalate (PET) film on which gold has been deposited, and the volume resistivity of the layer is measured by using a picoammeter (Model 4140B pA MATER available from Hewlett-Packard Company) while applying a voltage of 100 V across the film in an environment of 23° C. and 65% RH.

In the present invention, the surface of the image-bearing member may preferably have a releasability. It is also preferable that the surface of the image-bearing member has a contact angle to water of at least 85 degrees, and preferably at least 90 degrees.

A large contact angle of the image-bearing member corresponds to a high releasability from the toner particles. As a result, the collection efficiency of the transfer-residual toner particles is improved in the cleaning-at-development step. The amount of transfer-residual toner particles can be reduced. Consequently, it is possible to suppress the deterioration of the charging properties of the image-bearing member by the transfer-residual toner particles.

Various methods may be used to impart the releasability to the surface of the image-bearing member. For example, (1) a resin having a low surface energy may be used for the formation of the film; (2) an additive providing water repellency or lipophilicity may be added; and (3) a material having high releasability may be dispersed in the form of powder. For the method of (1), a fluorine-containing group or a silicone-containing group may be introduced into the structure of the resin. For the method of (2), a surfactant may be used as the additive. For the method of (3), it is possible to use a fluorine-containing compound, such as polytetrafluoroethylene, polyvinylidene fluoride or fluorinated carbon, a silicone resin or a polyolefin resin.

According to these measures, it is possible to provide the surface of the image-bearing member having a contact angle to water of at least 85 degrees.

Among the above, it is preferable to use an outermost layer of the image-bearing member that contains lubricant fine particles comprising at least one material selected from fluorine resins, silicone resins and polyolefin resins, in which the material is dispersed in the layer. It is particularly preferable to use a fluorine-containing resin, such as polytetrafluoroethylene or polyvinylidene fluoride, particularly as a material dispersed in the outermost layer according to the above-mentioned measure (3).

In order to provide these powders in the surface, a layer of the binder resin having the powders dispersed therein may be provided on the outermost surface of the photosensitive member. Alternatively, the powders may be dispersed in the outermost layer without providing an additional surface layer when the outermost layer is formed of an organic photosensitive member based on a resin.

The amount of the above-mentioned releasability powder to be added to the surface of the image-bearing member is preferably from 1% to 60% by weight, and more preferably from 2% to 50% by weight, relative to the total volume of the layer(s) on the surface. With a lower amount than the range, the transfer-residual toner particles may not be reduced to a sufficient level. The collection efficiency of the transfer-residual toner particles may not be demonstrated enough in the cleaning-at-development step. On the other hand, a higher amount than the above-mentioned range may lower the strength of the film. In addition, the intensity of the incident light beam to the photosensitive layer may be reduced significantly. The charging properties of the image-bearing member are deteriorated accordingly. The powder may preferably have a particle diameter of not larger than 1 μm by the image-quality considerations, and more preferably not larger than 0.5 μn. With the powder having a larger particle diameter than the above-mentioned range, the resolution of images, particularly line images may be deteriorated or impaired due to scattering of the incident light beams.

In the present invention, the contact angle may be measured by using pure water and a contact angle meter (Model CA-DS available from Kyowa Interface Science Co., LTD.).

A preferred embodiment of the photosensitive member as the image-bearing member used in the present invention is described below.

A conductive substrate may comprise: a metal, such as aluminum or stainless steel; a plastic material coated with a layer of an aluminum alloy or indium tin oxide; a paper or plastic material impregnated with conductive particles; or a plastic material comprising a conductive polymer, in the form of a cylinder or a sheet.

The conductive substrate may be coated with an undercoating layer for the purpose of, for example, improving adhesion of a photosensitive layer, improving coatability, protecting the substrate, coating a defect in the substrate, improving charge injection from the substrate, and/or protecting the photosensitive layer from electrical breakage.

The undercoating layer may be formed of a material such as polyvinyl alcohol, poly-N-vinylimidazole, polyethylene oxide, ethyl cellulose, methyl cellulose, nitro cellulose, ethylene-acrylic acid copolymers, polyvinyl butyral, phenolic resins, casein, polyamide, copolymerized nylon, glue, gelatin, polyurethane or aluminum oxide. The undercoating layer may have a thickness of typically 0.1 to 10 μm, more preferably 0.1 to 3 μm.

The charge generation layer may be formed by means of applying a paint of a binder with a charge-generating substance dispersed therein or by means of vapor deposition. Examples of the charge-generating substance applicable for this purpose include azo pigments, phthalocyanine pigments, indigo pigments, perylene pigments, polycyclic quinone pigments, squarylium dyes, pyrylium salts, thiopyrylium salts, triphenylmethane dyes, or an inorganic substances such as selenium or amorphous silicon. Among these, a phthalocyanine pigment is particularly preferred in order to provide a photosensitive member with a photosensitivity suitable for the present invention. The binders may be selected from various choices and examples thereof include polycarbonate resins, polyester resins, polyvinyl butyral resins, polystyrene resins, acrylic resins, methacrylic resins, phenolic resins, silicone resins, epoxy resins or vinyl acetate resins. The amount of the binder may preferably be 80% by weight or lower, preferably 0% to 40% by weight, of the charge generation layer. The charge generation layer may preferably have a thickness of 5 μm or smaller, in particular 0.05 to 2 μm.

The charge transport layer has a function of receiving charge carriers from the charge generation layer and transporting the carriers under the electric field. The charge transport layer may be formed by means of dissolving or dispersing a charge-transporting substance in a solvent, optionally together with a binder resin, and applying the resulting coating liquid. The film thickness thereof may generally be in the range of 5 to 40 μm. Examples of the charge-transporting substance include polycyclic aromatic compounds including a structure of biphenylene, anthracene, pyrene and phenanthrene on the principal chain or a side chain; nitrogen-containing cyclic compounds, such as indole, carbazole, oxadiazole and pyrazoline; hydrazone compounds; styryl compounds; selenium; selenium-tellurium; amorphous silicon; and cadmium sulfide.

Examples of the binder in which the charge-transporting substance is dispersed or dissolved include resins such as polycarbonate resins, polyester resins, polymethacrylate esters, polystyrene resins, acrylic resins, and polyamide resins; and organic photoconductive polymers such as poly-N-vinylcarbazole and polyvinyl anthracene.

It is possible to provide a surface layer for the purpose of improving the charge injection at a higher efficiency. The surface layer for this purpose is formed by means of dispersing the conductive fine particles in a resin. Examples of the resins include polyester, polycarbonate, acrylic resins, epoxy resins, and phenolic resins. These resins may be used alone or in combination, optionally together with a hardner for such a resin. The conductive fine particles may comprise a metal or a metal oxide. Preferred examples thereof include ultrafine particles of zinc oxide, titanium oxide, tin oxide, antimony oxide, indium oxide, bismuth oxide, tin oxide-coated titanium oxide, tin-coated indium oxide, and antimony-coated tin oxide or zirconium oxide. These materials may be used alone or in combination.

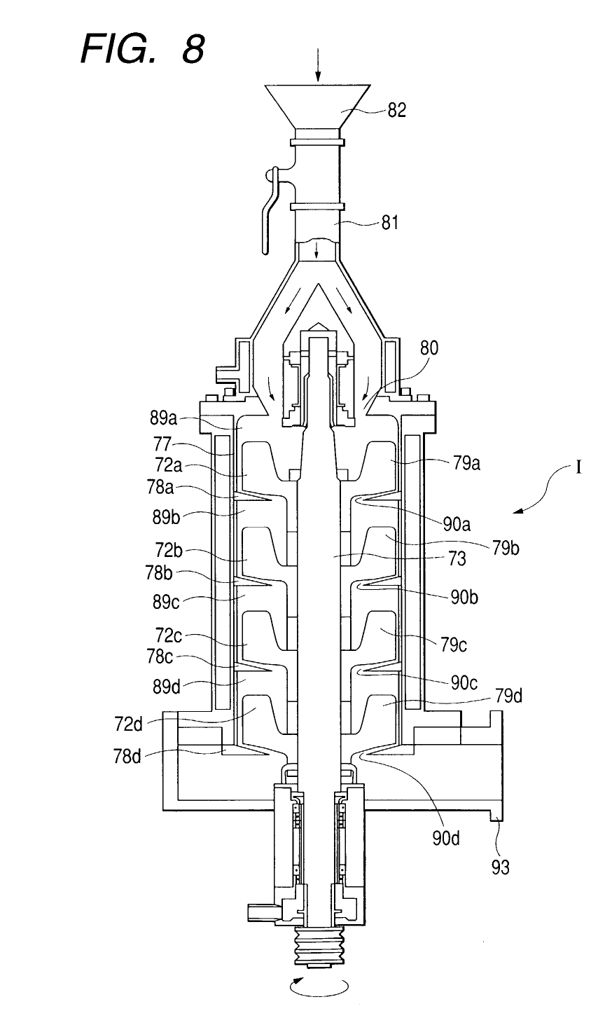

FIG. 6 is a schematic sectional view of a photosensitive member having a charge injection layer that serves as the surface layer. More specifically, the photosensitive member has a typical drum configuration of an organic photosensitive member. The photosensitive member comprises a conductive substrate (aluminum drum substrate) 11, a conductive layer 12, a positive charge injection prevention layer 13, a charge generation layer 14 and a charge transport layer 15, which are disposed successively in this order by means of coating them on the conductive substrate 11. The conductive substrate also has a charge generation layer 16 to provide better charging properties by charge injection. The charge injection layer 16 contains metal oxide conductive fine particles 16a dispersed therein.

It is important for the charge injection layer 16 that is formed as the outermost layer of the image-bearing member to have a volume resistivity of ranging from 1×10⁹ to 1×10¹⁴ Ω·cm. A similar effect can be obtained without the charge injection layer 16 when the charge transport layer 15 serves as the outermost layer and has a volume resistivity in the above-described range. For example, an amorphous silicon photosensitive member having a volume resistivity of approximately 10¹³ Ω·cm demonstrates good charging properties.

In the present invention, it is preferable that the latent image forming step for writing image data onto a charged surface of an image-bearing member is a step of subjecting the charged surface of the image-bearing member to imagewise exposure for writing the image data, and the latent image-forming means is an imagewise exposure means. The imagewise exposure means for the formation of electrostatic latent images is not restricted to a laser scanning exposure means for the formation of digital latent images, but may also be an ordinary analog imagewise exposure means or those using other types of light emission devices, such as LED, or a combination of a light emission device such as a fluorescent lamp and a liquid crystal shutter, etc. Thus, any imagewise exposure means capable of forming electrostatic latent images corresponding to image data can be used.

The image-bearing member may also be an electrostatic recording dielectric material. In this case, the dielectric material that serves as an image-bearing surface may be primarily charged uniformly to a predetermined polarity and potential and then subjected to selective charge removal by charge removing means, such as a charge-removal stylus head or an electron gun, to write in objective electrostatic latent image.

The developer-carrying member that is used as a part of developing means in the present invention may preferably comprise a conductive cylinder (developing roller) formed of a metal or an alloy, such as aluminum or stainless steel. The conductive cylinder may also be formed of a resinous composition having a sufficient strength and electroconductivity. It is also possible to use a conductive rubber roller. Instead of a cylindrical form, it is also possible to use a form of an endless belt driven in rotation.

The developer-carrying member that is used in the present invention may preferably have a surface roughness (in terms of JIS central line-average roughness (Ra)) of 0.2 to 3.5 μm. When the surface roughness Ra is below the above-indicated range, the amount of the developer carried on the developer-carrying member is reduced or the triboelectric charging of the developer on the developer-carrying member becomes too high, so that the developabiity may often be deteriorated. On the other hand, with the surface roughness Ra exceeding the above-indicated range, the developer layer on the developer-carrying member is accompanied with irregularities. This may result in images with uneven densities. Thus, it is more preferable that the surface roughness Ra is in the range of 0.5 to 3.0 μm.

It is preferable that the developer-carrying member has a surface coating layer formed of a resin composition containing conductive fine particles and/or lubricant particles dispersed therein so as to control the triboelectric charging of the developer on the developer-carrying member.

In the coating layer of the developer-carrying member, the conductive fine particles contained in the resin material preferably has a resistivity of 0.5 Ω·cm or lower under a pressure of 1.2×10⁷ Pa.

The conductive fine particles may preferably be carbon fine particles, mixed particles of carbon fine particles and crystalline graphite particles, or crystalline graphite particles. The particles may preferably have a particle diameter of 0.005 to 10 μm.

Examples of the resin material include thermoplastic resins, such as styrene resins, vinyl resins, polyethersulfone resins, polycarbonate resins, polyphenylene oxide resins, polyamide resins, fluorine resins, cellulose resins, and acrylic resins; thermosetting resins or photo-curable resins, such as epoxy resins, polyester resins, alkyd resins, phenolic resins, melamine resins, polyurethane resins, urea resins, silicone resins, and polyimide resins.

Among the above, it is preferable to use those that demonstrate good releasability, such as silicone resins or fluorine resins; or those having excellent mechanical properties, such as polyethersulfone, polycarbonate, polyphenylene oxide, polyamide, phenolic resins, polyester, polyurethane, or styrene resins. Phenolic resins are particularly preferred.

The conductive fine particles may preferably be used in an amount of 3 to 20 parts by weight per 10 parts by weight of the resin.

In the case of using a mixture of carbon fine particles and graphite particles as the conductive fine particles, the carbon fine particles may preferably be used in an amount of 1 to 50 parts by weight per 10 parts by weight of the graphite particles.

The coating layer of the developer-carrying member containing the conductive fine particles dispersed in the coating layer may preferably have a volume resistivity of 10⁻⁶ to 10⁶ Ω·cm.

In the present invention, it is preferable to form a developer layer at a coating rate of 3 to 30 g per 1 m² of the developer-carrying member. Forming the developer layer at a coating rate of 3 to 30 g/m² on the developer-carrying member facilitates to form a uniform developer layer. Consequently, it is easier to uniformly supply the conductive fine powder to the image-bearing member, so that the uniform charging of the image-bearing member may easily be accomplished. When there is a smaller amount of the developer on the developer-carrying member than the above-mentioned range, it is difficult to obtain a sufficient image density. Minute irregularities in the developer layer on the developer-carrying member are liable to result in uneven image densities and uneven charging on the image-bearing member due to irregular or non-uniform supply of the conductive fine powder. With a larger amount of the developer than the above-mentioned range present on the developer-carrying member, the triboelectric charging of the toner particles is liable to be insufficient. This may cause scattering of the toner, increasing fog in images. Poor transferability may often obstruct the charging of the image-bearing member.

It is further preferable to form a developer layer at a coating rate of 5 to 25 g/m² on the developer-carrying member. As a result, the developer on the developer-carrying member is provided with more uniform triboelectric charging, so that the influence of the collected transfer-residual toner particles on the triboelectric charging of the toner particles in proximity to the developer-carrying member can be alleviated, thereby stably effecting the developing and cleaning operations in parallel in the cleaning-at-development step. When the amount of the developer on the developer-carrying member is lower than the above-mentioned range, the transfer-residual toner particles after being collected tend to affect on the triboelectric charging of the toner particles near the image-bearing member. The triboelectric charging of the toner particles becomes uneven at some portions and, in turn, the developer layer becomes uneven. The collectability of the transfer-residual toner particles may become non-uniform. On the other hand, when the amount of the developer on the developer-carrying member is larger than the above-mentioned range, the collected transfer-residual toner particles are again supplied to the developing section to be used for development without being supplied with a sufficient triboelectric charge, thus being liable to result in fog.

Further, in the present invention, it is particularly preferred that a regulating member for regulating the amount of the developer on the developer-carrying member is disposed above the developer-carrying member and abutted against the developer-carrying member via the developer carried thereon, so as to suppress the change in developability caused by the collection of the transfer-residual toner particles and provide the developer with a uniform triboelectric charging which is less liable to be affected in changes in environmental conditions and provides a good transferability.

In the present invention, the amount of the developer on the developer-carrying member may be calculated by means of collecting by suction the developer into a cylindrical filter of a metal cylindrical tube or other similar tube. The area S of the portion on the developer-carrying member where the developer is collected, and the weight M of the collected developer is calculated to obtain the amount of the developer per a unit area by using a simple equation of M/S (g/m²).

In the present invention, the surface of the developer-carrying member may move in a relative direction which is same as or opposite to the moving direction of the surface of the image-bearing member at places where they are opposed to each other. In the case of movement in the same direction, the developer-carrying member may preferably be moved at a movement speed which is at least 100% of that of the image-bearing member. Below 100%, the image quality may deteriorate. On the other hand, when the above-mentioned ratio of the movement speed is 100% or higher (i.e., in the development part the developer-carrying member is moved at a surface speed which is equal to or larger than that of the image-bearing member), the developer is supplied in a sufficient quantity from the developer-carrying member to the image-bearing member, and the conductive fine powder is also supplied sufficiently so that good charging properties of the image-bearing member are ensured.

It is further preferable that the developer-carrying member is moved at a surface speed which is 1.05 to 3.0 times that of the image-bearing member. At a higher ratio (of the movement speed), the amount of the toner particles that are supplied to the developing section becomes larger, so that the frequency of deposition onto and return from the latent image of the toner is increased to cause a frequent repetition of sweeping out the toner particles of unnecessary parts and deposition of them on necessary parts, whereby the collectability of the transfer-residual toner particles is improved to more reliably suppress the occurrence of pattern ghost due to the collection -failure. Further, it is possible to provide a toner image faithful to the latent image. Further, in a contact developing mode, at a higher movement ratio, the collectability of the transfer-residual toner particles is improved due to rubbing between the image-bearing member and the developer-carrying member. However, when the movement speed substantially exceeds the above range, fog and image staining are liable to occur due to scattering of the developer from the developer-carrying member, and the useful life of the image-bearing member or the developer-carrying member is liable to be shortened due to wearing or abrasion by rubbing in the contact developing mode. Moreover, in the case where the developer layer thickness regulating member is abutted against the developer-carrying member via the developer layer. The useful life of the developer-layer thickness regulating member or the developer-carrying member is liable to be shortened due to wearing and abrasion by rubbing. From the above points, it is further preferable that the surface movement speed ratio of the developer-carrying member to the image-bearing member is in the range of 1.1 to 2.5 times.

In order to apply the non-contact developing in the present invention, it is preferable to form a thin developer layer, which is smaller in thickness than a predetermined gap length between the developer-carrying member and the image-bearing member, on the developer-carrying member. According to the present invention, it has become possible to effect the formation of an image at a high image quality by using a cleaning-at-development step according to a non-contact developing mode which has been difficult heretofore. In the developing step, by applying a non-contact developing mode wherein a developer layer is disposed in no contact with the image-bearing member to develop an electrostatic latent image on the image-bearing member to form a toner image, a development fog caused by injection of a developing bias electric field to the image-bearing member can be prevented even when conductive fine powder having a low electrical resistivity is added in a substantial amount in the developer, whereby good images can be obtained.

It is preferable that the developer-carrying member is disposed with a gap length of 100 to 1,000 μm from the image-bearing member. When the gap length of the developer-carrying member relative to the image-bearing member is smaller than the charge range, the developing performance with the developer is liable to be fluctuated depending on a fluctuation of the gap length, so that it becomes difficult to mass-produce image forming apparatus satisfying stable image qualities. When the gap length is larger than the above-indicated range, the flowability of the toner particles onto the latent image on the image-bearing member is lowered. This may often cause image quality lowering, such as lower resolution and lower image density. Further, the supply of the conductive fine powder onto the image-bearing member is liable to be insufficient, so that the charging properties of the image-bearing member may often be deteriorated. It is further preferable to dispose the developer-carrying member with a gap length of 100 to 600 μm from the image-bearing member. As a result, the collection of the transfer-residual toner particles can be made more advantageously performed in the cleaning-at-development step. When the gap length is larger than the above-indicated range, the collection rate of the collectability of the transfer-residual toner particles results in fog due to collection failure.

In the present invention, it is preferable to operate the developing step under the application of an alternating electric field (AC electric field) between the developer-carrying member and the image-bearing member which is formed by applying an AC voltage between the developer-carrying member and the image-bearing member in the non-contact development. This improves the supply to the conductive fine powder, improving the uniform charging properties of the image-bearing member and the collectability of the transfer-residual toner particles. Without the alternate current, the conductive fine powder may be transferred to the image-bearing member upon the development of the toner particles on the imaging part. On the contrary, the supply of the conductive fine powder to the non-imaging part is insufficient. For example, repeated formation of images that requires less toner may reduce the amount of the conductive fine powder at the abutting part, i.e., the contact portion between the image-bearing member and the contact charging member. This deteriorates the effect of enhancing the charging of the image-bearing member. The amount of the conductive fine powder is reduced in the cleaning-at-development step on the image-bearing member. The effect of promoting the collection of the transfer-residual toner particles is thus deteriorated.

The alternating electric field may be provided by means of applying an AC voltage between the developer-carrying member and the image-bearing member. The development bias to be applied may be a superposed voltage of the DC voltage and the AC voltage.

The alternating bias voltage may have a waveform which may be a sine wave, a rectangular wave, a triangular wave, etc., as appropriately be selected. It is also possible to use pulse voltages formed by periodically turning on and off a DC power supply. Thus, it is possible to use an AC voltage waveform.

It is preferable to form an AC electric field at a peak-to-peak electric field intensity of 3×10⁶ to 10×10⁶ V/m and a frequency of 100 to 5,000 Hz between the developer-carrying member and the image-bearing member by applying a development bias. As a result, the conductive fine powder that is added to the developer can readily be transferred to the image-bearing member in a uniform manner, thereby achieving a uniform and close contact between the contact charging member and the image-bearing member via the conductive fine powder. This significantly enhances the uniform charging, in particular the direct injection-based charging, of the image-bearing member. Further, owing to the AC electric field, the charge injection to the image-bearing member at the developing part does not occur even when a high potential difference exists between the developer-carrying member and the image-bearing member, so that development fog caused by such charge injection to the image-bearing member is prevented even when a substantial amount of the conductive fine powder are added to the developer, thus providing good images.

When the AC electric field intensity is below the above-mentioned range that is formed by means of applying the development bias between the developer-carrying member and the image-bearing member, the amount of the conductive fine powder supplied to the image-bearing member may become insufficient. The uniform charging properties of the image-bearing member may often be deteriorated, and the resultant images may have a lower image density because of a smaller developing ability. On the other hand, when the AC electric field exceeds the above range, too large a developing ability is liable to result in a lower resolution because of thin lines and image quality deterioration due to increased fog, a lowering in charging properties of the image-bearing member and image defects due to leakage of the developer bias voltage to the image-bearing member. When the frequency of the AC component of the electric field, which is formed by applying the development bias between the developer-carrying member and the image-bearing member, is lower than the above-mentioned range, it becomes difficult to uniformly supply the conductive fine powder to the image-bearing member. Therefore, uneven charging may often be caused on the image-bearing member. When the frequency exceeds the above range, the amount of the conductive fine powder that is supplied to the image-bearing member may become insufficient, thus resulting in the deterioration of the uniform charging properties of the image-bearing member.

The AC electric field formed between the developer-carrying member and the image-bearing member may further preferably have a peak-to-peak electric field intensity of 4×10⁶ to 10×10⁶ V/m and a frequency of 500 to 4,000 Hz. As a result, the conductive fine powder in the developer can readily be transferred to the image-bearing member in a uniform manner. The conductive fine powder are uniformly applied onto the image-bearing member after the transfer step, which allows a higher collectability of the transfer-residual toner particles even in the non-contact developing mode.

When the AC electric field intensity between the developer-carrying member and the image-bearing member is lower than the above-mentioned range, collectability of the transfer-residual toner particles in the cleaning-at-development step may be deteriorated, with a higher possibility of causing fog due to the insufficient collection. When the frequency is lower than the above-indicated range between the developer-carrying member and the image-bearing member, the frequency of depositing on and releasing from the latent image of the toner is lowered and the collectability of the transfer-residual toner particles in the cleaning-at-development step may be deteriorated. This often results in lower image qualities. When the AC electric field frequency exceeds the above-indicated range, the amount of toner particles capable of following the changes in electric field becomes smaller, so that the collectability of the transfer-residual toner particles may often be deteriorated.

The follow-up properties of the toner particles with respect to the electric field depends on the intensity and the frequency of the above-mentioned electric field as well as the weight of the toner particles (associated with a particle diameter and a specific weight) and the charge (a specific charge of the toner particles). With larger toner particles or lower charge, the follow-up properties of the toner particles relative to the change in developing electric field would be deteriorated, reducing the amount of development of the toner particles. Therefore, it becomes necessary that the developer has the conductive fine powder. When the developer whose charge may readily be lowered is applied to the non-contact development and an alternating electric field is applied as the development bias, in order to make the toner particles maintain the follow-up properties depending on the developing electric field and provide good images, it is necessary that the developer contains, in number-based particle size distribution of particles in the particle diameter range of from 0.60 μm, inclusive, to 159.21 μm, exclusive,, 15% to 70% by number of particles having particle diameters in the range of from 3.00 μm, inclusive, to 8.96 μm, exclusive. The developer is required to have a triboelectric charge in terms of absolute value of 20 to 100 mC/kg with respect to the spherical iron powder of “100 mesh pass and 200 mesh on”. Since the developer does not contain a large amount of toner particles having a large particle diameter with lower follow-up properties of the toner particles by the development electric field, it is preferable that the developer has 0 to 20% by number of particles of at least 8.96 μm in number-based particle size distribution in the particle diameter range of from 0.60 μm, inclusive, to 159.21 μm, exclusive.

Behavior of the conductive fine powder by the development electric field is significantly affected by the follow-up properties of the toner particles by the development field. The conductive fine powder is difficult to retain high charge (specific charge of the particles) because of its conductivity. Therefore, the conductive fine powder alone has low follow-up properties to the development electric field. Behavior of the conductive fine powder mainly results from the movement of the toner particles that follow up the development electric field. For example, in the non-contact development process, the development electric field causes the toner particles to move from the developer layer on the developer-carrying member to the latent image on the image-bearing member. The conductive fine powder also moves from the developer layer to the latent image along with the toner particles.

In the process of forming images by using a magnetic developer containing the magnetic toner particles wherein the developer is carried on the developer-carrying member under the action of the magnetic field to convey the magnetic developer to the developing unit, the magnetic developer forms aggregates of the toner particles on the developer-carrying member due to magnetic cohesive and repulsive forces. The aggregates are also called as “ears” and contain particles of the conductive fine powder. The magnetic developer moves from the developer-carrying member to the image-bearing member by the development electric field because of the ears. The ears are disintegrated into individual particles on the image-bearing member. As a result, the conductive fine powder in the ears is caused to be moved to the image-bearing member. As described above, the development electric field causes the magnetic developer to move from the developer-carrying member to the image-bearing member as the ears that are the aggregates of the toner particles and conductive fine powder. Therefore, with the magnetic developer, the conductive fine powder can be supplied to the image-bearing member more effectively.

When the development is made with the application of the alternating electric field generated by means of applying the development bias between the developer-carrying member and the image-bearing member, the conductive fine powder may be supplied more advantageously with an alternating electric field that causes a higher frequency of deposition and removal of the toner particles relative to the image-bearing member or with a developer that includes the toner particles having better follow-up properties to the alternating electric field.

The supply of the conductive fine powder to the image-bearing member depends on how easily the conductive fine powder is deposited on the image-bearing member and on the surface of the toner particles, or how the conductive fine powder is retained there. In the present invention, the conductive fine powder particles contained in the developer have the number-average particle diameter of the primary particles of 50 to 500 nm, and contain the agglomerated matter of the primary particles. Accordingly, the conductive fine powder particles are deposited on the image-bearing member more easily. They are also deposited on the surface of the toner particles and hardly behave along with the toner particles. This means that the conductive fine powder particles are easily released from the toner particles. Therefore, the conductive fine powder of the present invention can advantageously be supplied to the image-bearing member.

In the present invention, the transferring step may be a step of re-transferring the toner image that has been formed in the developing step to the transfer material after the transfer of it to the intermediate transfer member. In other words, the intermediate transfer member such as a transfer drum may serve as the transfer material that directly receives the toner image from the image-bearing member. When the intermediate transfer member is used, the toner image can be obtained by means of re-transferring it from the intermediate transfer member to the transfer material such as paper. With the intermediate transfer member, the amount of the transfer-residual toner particles on the image-bearing member can be reduced regardless of the recording medium such as cardboard.

In the present invention, it is preferable that the transfer member is abutted to the image-bearing member through the transfer material (recording medium).

In the contact transferring step in which the toner image on the image-bearing member is transferred to the transfer material while abutting the transfer member to the image-bearing member through the transfer material, it is preferable that the transfer member is abutted to the image-bearing member at a linear pressure of 2.94 to 980 N/m (applying a pressure of 2.94 N per 1 m of contact length), more preferably, 19.6 to 490 N/m.

With a lower abutting pressure of the transfer member than the above-mentioned range, the amount of the transfer-residual toner particles is increased, often deteriorating the charging properties of the image-bearing member. On the other hand, with a higher abutting pressure than the above-mentioned range, the pressure helps the conductive fine powder to be transferred to the transfer material. The supply of the conductive fine powder to the image-bearing member and the contact charging member reduced accordingly. Consequently, the effect of enhancing the charging of the image-bearing member may be deteriorated, and the collectability of the transfer-residual toner particles may also be deteriorated in the cleaning-at-development step. The toner may be scattered on images.

A device having a transfer roller or a transfer belt is preferably used as the transferring means in the contact transferring step. The transfer roller has a core metal and a conductive elastic layer coating the core metal. The conductive elastic layer may be formed of an elastic material such as a polyurethane rubber or an ethylene-propylene-diene polyethylene (EPDM) containing a conductivity-imparting agent, such as carbon black, zinc oxide, tin oxide, or silicon carbide, dispersed therein. It is preferable that the conductive elastic layer is a solid or foam elastic member having an electric resistivity value (volume resistivity) of 10⁶ to 10¹⁰ Ωcm, that is, a medium-resistivity.

Preferable transfer conditions with the transfer roller are as follows. The transfer roller is abutted to the image-bearing member at a linear pressure of 2.94 to 980 N/m (applying a pressure of 2.94 to 980 N per 1 m of contact length) to form a transfer nip. It is more preferable that the linear pressure is 19.6 to 490 N/m. When the linear pressure as the abutting pressure is lower than the above range, difficulties, such as deviation in conveyance of the transfer material and transfer failure, are liable to occur. When the abutting pressure exceeds the above range, the deterioration of and toner attachment onto the photosensitive member surface is liable to occur, thus promoting toner melt-sticking onto the photosensitive member surface.

During the contact transferring step wherein the toner image is transferred onto the transfer material while abutting the transfer member against the image-bearing member, it is preferable that the DC voltage applied is ±0.2 to ±10 kV.

The present invention is particularly advantageously applicable to an image forming apparatus including a photosensitive member having a small diameter, having a peripheral length not larger than 100 mm (e.g., photosensitive member having a diameter of 30 mm) as the image-bearing member. When the image-bearing member is used which has a peripheral length of not larger than about 210 mm in case of using a A4 size paper as the transfer material, or when the image-bearing member is used which has a peripheral length of not larger than about 420 mm in case of using a A3 size paper, the image formation occurs repeatedly at the same part on the image-bearing member for one operation of image formation. When the image-bearing member is used which has a peripheral length of not larger than 100 mm, the image formation occurs repeatedly at least 3 times at the same part on the image-bearing member for one operation of image formation. As no independent cleaning step is included after the transferring step and before the charging step, the latitude of arrangement of the charging, exposure, developing and transferring means is increased, which may be combined with use of such a photosensitive member having a small diameter and having a peripheral length of not larger than 100 mm to realize a reduction in entire size and space for installment of an image forming device. When the belt-like photosensitive member is used, one having a peripheral length of not larger than 100 mm may be employed, and when the drum-like photosensitive member is used, one having a diameter of not larger than 30 mm may be employed, thereby increasing the latitude of arrangement of the steps and achieving a reduction in entire size and space for installment of an image forming apparatus. As a result, an image forming apparatus can be obtained which is able to make good use of the effects of the present invention.

The image forming device of the present invention may be applicable to a process cartridge that comprises at least the above-mentioned image-bearing member and the developing means, in which the process cartridge can be loaded into and unloaded from the image forming apparatus. The process cartridge may further comprise the above-mentioned charging means.

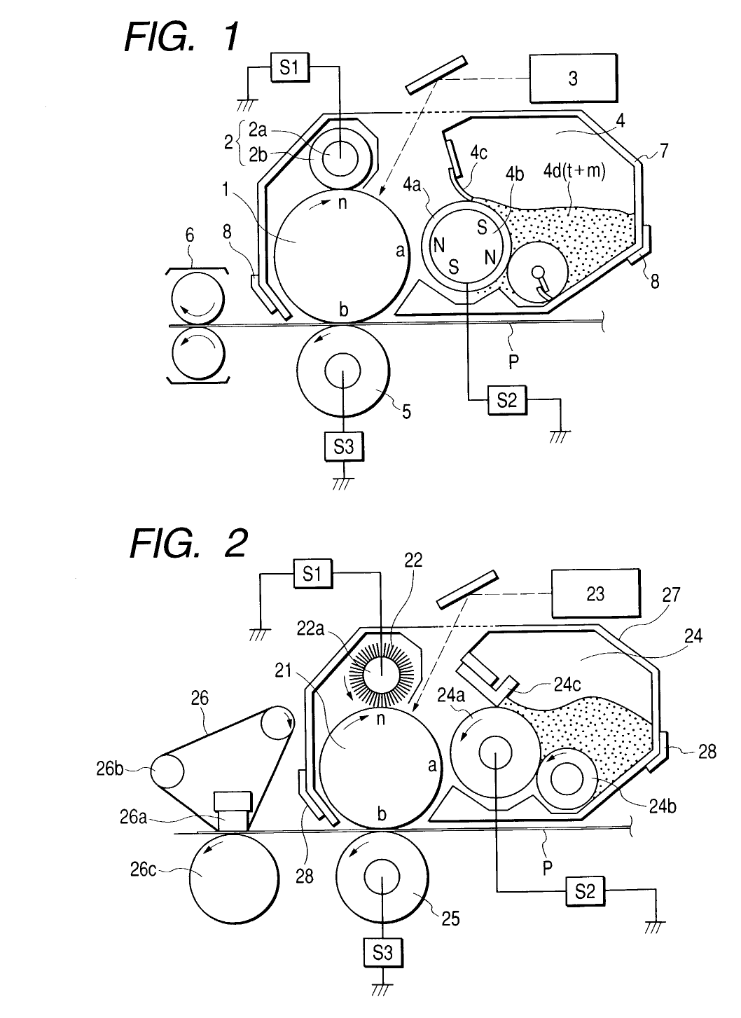

A configuration of the image forming apparatus according to an embodiment of the present invention is described with reference to FIG. 1.

This image forming apparatus is a laser printer (recording apparatus) that uses a cleaning-at-development process (cleanerless system) involving a transfer electrophotographic process. The image forming apparatus comprises a process cartridge with no cleaning unit having a cleaning member such as a cleaning blade. As the developer, a magnetic one-component developer is used. This image forming apparatus achieves non-contact development in which the developer layer on the developer-carrying member is away from the image-bearing member without any contact.

The image forming apparatus comprises a rotating drum-type OPC photosensitive member 1 that serves as an image-bearing member. The photosensitive member 1 is rotation-driven in the clockwise (indicated by an arrow) direction at a peripheral velocity of 120 mm/sec (process speed).

A charging roller 2 that serves as a contact charging member is forced against the photosensitive member 1 at a predetermined pressing force in resistance to its elasticity. Between the photosensitive member 1 and the charging roller 2, a contact nip (abutting part) n is formed. In this embodiment, the charging roller 2 is rotated at a peripheral velocity of 120 mm/sec in an opposite direction (with respect to the surface movement direction of the photosensitive member 1) at the abutting part n. This means that the charging roller 2 that serves as the contact charging member has a relative movement speed ratio of 200% to the surface of the photosensitive member 1. Conductive fine powder is applied to the surface of the charging roller 2 to provide a generally uniform amount by a single layer.

The charging roller 2 has a core metal 2a to which a DC voltage of −700 V is applied as a charge bias from a charge bias voltage supply S1. In this embodiment, the surface of the photosensitive member 1 is uniformly charged at a potential (−680 V) that is almost equal to the voltage applied to the charge roller 2, by means of the direct injection-based charging. This is described later again.

The image forming apparatus also comprises a laser beam scanner 3 (exposing unit) including, for example, a laser diode and a polygon mirror. The laser beam scanner produces laser light beams whose intensity is modified corresponding to a time-serial electrical digital image signal of target image information and scanning-exposes (L) the uniform charged surface of the photosensitive member 1 with the laser beams. This scanning-exposure produces an electrostatic latent image corresponding to the target image information on the rotating photosensitive member 1.

The image forming apparatus further comprises a developing device 4, by which the electrostatic latent image on the surface of the photosensitive member 1 is developed to form a toner image thereon.

The developing device 4 of this embodiment is a non-contact reversal developing device which comprises a negatively chargeable, magnetic one-component insulating developer. A developer 4d includes toner particles (t) and conductive fine powder (m).

The developing device 4 has a 16 mm-diameter non-magnetic developing sleeve 4a that serves as a developer-conveyance member enclosing a magnet roller 4b therein. The developing sleeve 4a is opposed to the photosensitive member 1 with a gap length of 320 μm. The developing sleeve 4a is rotated with a 110% speed difference relative to the surface speed of the photosensitive member 1 moving in an identical direction. In this event, the photosensitive member 1 moves in the same direction as the developing sleeve 4a moves in a developing part (developing region) against the photosensitive member 1.

The developer 4d is applied as a thin coating layer on the developing sleeve 4a by means of an elastic blade 4c. The elastic blade 4c restricts the thickness of the layer of the developer 4d on the developing sleeve 4a and charges the developer 4d.

The developer 4d applied to the developing sleeve 4a is conveyed along with the rotation of the developing sleeve 4a to the developing unit a where the photosensitive member 1 and the developing sleeve 4a are opposite to each other.

The developing sleeve 4a is applied with a development bias voltage from a development bias voltage supply S2. The development bias voltage is a totaled voltage of −420 V DC voltage and a rectangular AC voltage having a frequency of 1,500 Hz and a peak-to-peak voltage of 1,600 V (electric field intensity of 5×10⁶ V/m). The development bias voltage is used to effect one-component jumping development between the developing sleeve 4a and the photosensitive member 1.

The image forming apparatus further comprises a medium resistivity transfer roller 5 that serves as a contact transferring means. The transfer roller 5 is forced against the photosensitive member 1 at a linear pressure of 98 N/m to form a transfer nip b. To the transfer nip b, a transfer material P as a recording medium is supplied from a paper supply section (not shown) at predetermined timing. A predetermined transfer bias voltage is applied to the transfer roller 5 from a transfer bias voltage supply S3, whereby toner images on the photosensitive member 1 are successively transferred onto the surface of the transfer material P supplied to the transfer nip b.

In this embodiment, the transfer roller 5 has a resistivity of 5×10⁸ Ωcm. A DC voltage of +2,000 V is applied for transfer. Thus, the transfer material P introduced to the transfer nip b is nipped and conveyed through the transfer P, and on its surface, the toner images formed on the surface of the photosensitive member 1 are successively transferred under the action of an electrostatic force and a pressing force.

A fixing device 6 of the heat fixing type is provided. The transfer material P having received a toner image from the photosensitive member 1 at the transfer nip b is separated from the surface of the photosensitive member 1 and introduced into the fixing device 6, where the toner image is fixed to provide an image product (print or copy). The transfer material with the toner image is then conveyed out of the apparatus.

The image forming apparatus in this embodiment has no cleaning unit. The developer (transfer-residual toner particle) remaining on the surface of the photosensitive member 1 after the transfer of the toner image onto the transfer material P is not removed by such a cleaner. It travels via the charge abutting part n and reaches the developing part a along with the rotation of the photosensitive member 1. The developer is subjected to a cleaning-at-development operation (collection) in the developing device 4.

In the image forming apparatus according to this embodiment, three process components, i.e., the photosensitive member 1, the charge roller 2 and the developing device 4 are collectively supported to form a process cartridge 7 that can be detachably mounted to a main body of the image forming apparatus via a loading guide/retention member 8. The components of the process cartridge are not limited to the above-listed three components. Instead, the process cartridge may be composed of other combinations of devices.

Conductive fine powder m that is incorporated into the developer 4d in the developing device 4 are moved together with the toner particles t and transferred in an appropriate amount to the photosensitive member 1 at the time of developing the electrostatic latent image by the developing device 4.

The toner images, that is, the toner particles t on the photosensitive member 1 are aggressively caused to be transferred to the transfer material P that serves as the recording medium under the influence of the transfer bias at the transfer unit b. However, the conductive fine powder m on the photosensitive member 1 is not positively caused to be transferred to the transfer material P because of its electroconductivity. The conductive fine powder is substantially deposited and retained on the photosensitive member 1.

In the present invention, no cleaning unit is involved in the image forming apparatus. The transfer-residual toner particles t and the conductive fine powder m that are left on the photosensitive member 1 after the transfer are brought to the charge abutting part n formed at the abutting part between the photosensitive member 1 and the charge roller 2 that serves as the contact charging member, along with the rotation of the photosensitive member 1. They are then deposited on or incorporated into the charge roller 2. As a result, the photosensitive member 1 is charged by the direct injection-based charging in the presence of the conductive fine powder m at the charge abutting part n.

Because of the presence of the conductive fine powder m, very close contact and low contact resistance can be provided between the charge roller 2 and the photosensitive member 1 even when the transfer-residual toner particles are deposited on or incorporated into the charge roller 2. Accordingly, the direct injection-based charging of the photosensitive member 1 can be performed by using the charge roller 2.

The charge roller 2 closely contacts the photosensitive member 1 via the conductive fine powder m, and the conductive fine powder m rubs the surface of the photosensitive member 1 without discontinuity. As a result, the charging of the photosensitive member 1 by the charge roller 2 is performed not relying on the discharge-based mechanism but mainly relying on the stable and safe direct injection charging mechanism, to provide a high charging efficiency that has not been achieved by conventional roller charging. As a result, a potential that is almost identical to the voltage applied to the charge roller 2 can be imparted to the photosensitive member 1.

The transfer-residual toner particles t that are deposited on or incorporated into the charge roller 2 are gradually released from the charging roller 2 to the photosensitive member 1 and reach the developing part a along with the movement of the photosensitive member 1. The toner particles are subjected to the cleaning-at-development step (collection) in the developing device 4.

The cleaning-at-development step is a step of collecting the toner particles, which are left on the photosensitive member 1 after the transfer, at the time of developing after the formation of images (i.e., during development of a latent image formed after the charging and exposing steps are performed again after the first development) under the action of a fog-removing bias of the developing device (Vback, i.e., a difference between a DC voltage applied to the developing device and a surface potential on the photosensitive member). In the image forming apparatus according to this embodiment adopting a reversal development scheme, the cleaning-at-development step is performed under the action of an electric field that collects the toner particles from a dark portion potential part on the photosensitive member and an electric field that deposits (develops) the toner particles from the developing sleeve on a light portion potential part on the photosensitive member, in response to the development bias.

As the image forming apparatus is operated, the conductive fine powder m contained in the developer in the developing device 4 is transferred to the surface of the photosensitive member 1 at the developing part a, and moved via the transfer unit b to the charge abutting part n along with the movement of the surface of the photosensitive member 1, whereby the charging part n is successively supplied with a fresh conductive fine powder m. As a result, even when the conductive fine powder m is reduced by falling or when the conductive fine powder m at the charging part n is deteriorated, the charging properties are kept constant and good charging properties of the photosensitive member 1 are stably retained.

In the image forming apparatus involving a contact charging scheme, a transfer scheme and a toner recycle process, the photosensitive member can be uniformly charged at a low application voltage by using a simple charging roller 2 as the contact charging member. Furthermore, ozone-free direct injection-based charging can be stably maintained to exhibit uniform charging properties even though the charging roller 2 is soiled with the transfer-residual toner particles. As a result, it is possible to provide a simple and cost-effective image forming apparatus without problems, such as generation of ozone products and faulty charging.

As mentioned above, it is necessary for the conductive fine powder m to have a resistivity of 1×10⁹ Ω·cm or lower in order to avoid deterioration of the charging properties. When the conductive fine powder m has a resistivity of higher than 1×10⁹ Ω·cm, with a developing device wherein the developer directly contacts a photosensitive member 1 in the developing part m, charges are injected to the photosensitive member 1 via the conductive fine powder m in the developer under the action of the development bias. This results in undesirable fog of images.

However, a non-contact developing device is used in this embodiment, so that good images can be formed without causing charge injection to the photosensitive member 1 by the development bias. Furthermore, no charge injection occurs to the photosensitive member 1 at the developing part a. This means that it is possible to provide a large potential difference between the developing sleeve 4a and the photosensitive member 1 as an AC bias. Consequently, it becomes possible to uniformly apply the conductive fine powder m to the surface of the photosensitive member 1 to achieve uniform contact at the charging part and to obtain good images.

Owing to the lubricating effect (friction-reducing effect) of the conductive fine powder m present at the contact surface n between the charging roller 2 and the photosensitive member 1, it becomes possible to easily and effectively provide a speed difference between the charging roller 2 and the photosensitive member 1. Owing to this lubricating effect, the friction between the charging roller 2 and the photosensitive member 1 is reduced, the drive torque is reduced, and the surface abrasion or damage of the charging roller 2 and the photosensitive member 1 can be prevented. The speed difference makes it possible to remarkably increase an opportunity of the conductive fine powder particles m to contact the photosensitive member 1 at the mutually contacting surface part (abutting part) n between the charging roller 2 and the photosensitive member 1, thereby allowing good direct injection-based charging. As a result, good images can be obtained in a stable manner.

In this embodiment, the charging roller 2 is rotation driven in the direction opposite to the moving direction of the surface of the photosensitive member 1. Consequently, the transfer-residual toner particles on the photosensitive member 1 that are brought to the charging part n are temporarily collected by the charging roller 2 to level or uniformize the density of the transfer-residual toner particles that are present at the charging part n. Thus, it becomes possible to prevent faulty charging due to localization of the transfer-residual toner particles at the charge abutting part. It is therefore possible to provide stabler charging properties.

By rotating the charging roller 2 in a reverse direction, the charging is performed while releasing the transfer-residual toner particles from the photosensitive member 1. This allows direct injection-based charging in an advantageous manner. Furthermore, deterioration of the charging properties of the image-bearing member due to excessive falling of the conductive fine powder m from the charge roller 2 can be prevented.

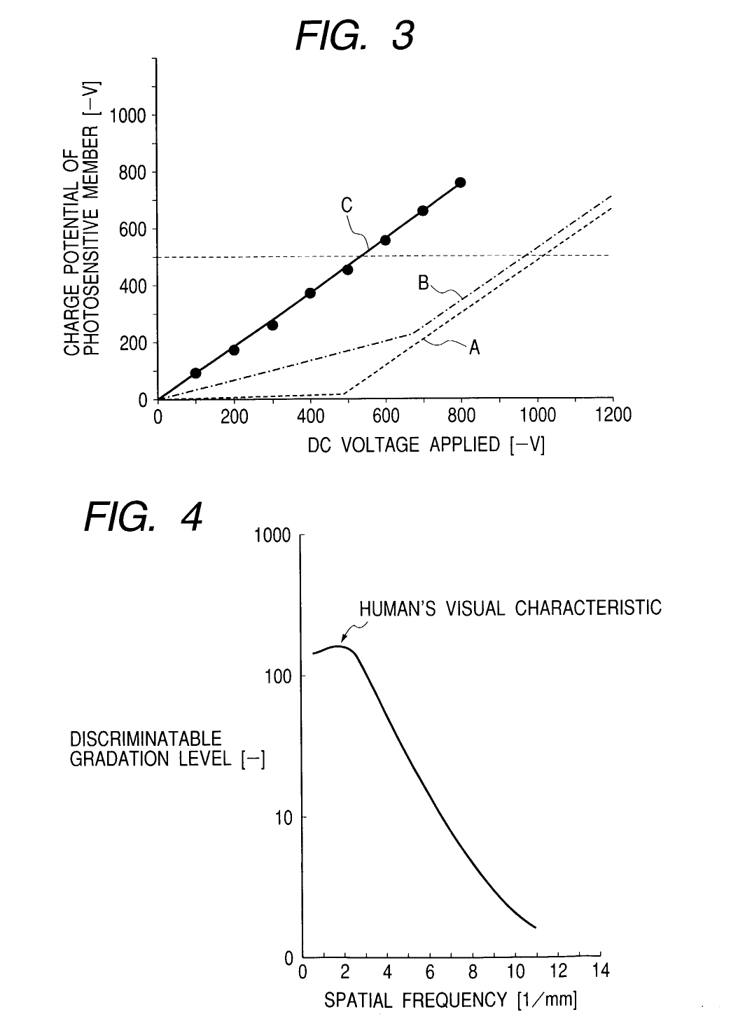

A configuration of the image forming apparatus according to another embodiment of the present invention is described with reference to FIG. 2.

This image forming apparatus is a laser printer (recording device) that uses a cleaning-at-development process involving a transfer electrophotographic process. It comprises no cleaning unit. Instead, it comprises a small process cartridge achieved by using a drum-shaped photosensitive member having a small diameter. The process cartridge can be loaded into and unloaded from the image forming apparatus. As the developer, a non-magnetic one-component developer is used. This image forming apparatus achieves non-contact development in which the developer layer on the developer-carrying member is away from the image-bearing member without any contact.

The image forming apparatus comprises a rotating 24-mm diameter drum-type OPC photosensitive member 21 that serves as an image-bearing member. The photosensitive member 21 is rotation-driven in the clockwise that is indicated by an arrow direction at a peripheral velocity of 60 mm/sec (process speed is variable in the range of 60 to 150 mm/sec.).

A conductive brush roller 22 (hereinafter, referred to as a “charging brush”) that serves as the contact charging member. The charging brush 22 is rotated with a −150% speed difference relative to the peripheral speed (or surface speed) of the photosensitive member at the charge abutting part n between the charging brush 22 and the photosensitive member 21. In this event, the charging brush 22 moves in the opposite direction to the photosensitive member 21. The charge brush 22 has a core metal 22a to which a DC voltage of −700 V is applied as a charge bias from a charge bias voltage supply S1 in the presence of the conductive fine powder (the conductive fine powder contained in the developer) at the charge abutting part n. The surface of the photosensitive member 21 is thus uniformly charged by means of the direct injection-based charging.

The image forming apparatus also comprises a laser beam scanner 23 that serves as the latent image forming means. The laser beam scanner produces laser light beams whose intensity is modified corresponding to a time-serial electrical digital image signal of target image information and scanning-exposes the uniform charged surface of the photosensitive member 21 with the laser beams. This scanning-exposure produces an electrostatic latent image corresponding to the target image information on the surface of the photosensitive member 21.

The image forming apparatus further comprises a developing device 24, by which the electrostatic latent image on the surface of the photosensitive member 21 is developed to form a toner image thereon.

The developing device 24 is a non-contact reversal developing device which comprises a negatively chargeable, non-magnetic one-component insulating developer using a developer that is obtained by means of externally adding the inorganic fine powder and the conductive fine powder to the toner particles.

The developing device 24 has a developing roller 24a that serves as a developer carrying member. The developing roller is formed of a medium resistivity rubber roller made of a silicone rubber and having a diameter of 16 mm in which carbon black is dispersed. The developer-carrying member 24a is opposed to the photosensitive member 21 with a gap length of 300 μm.

The developer-carrying member 24a is rotated with a 150% speed difference relative to the rotating peripheral speed (or surface speed) of the photosensitive member 21 moving in an identical direction. In this event, the photosensitive member 21 moves in the same direction as the developer-carrying member 24a moves against the photosensitive member 21. More specifically, the movement speed on the surface of the developer-carrying member 24a is 90 mm/s. The speed relative to the surface of the photosensitive member 21 is 30 mm/s.

A coating roller 24b is provided at a developing area to apply the developer to the developer-carrying member 24a. The coating roller 24b is abutted against the developer-carrying member 24a. At a contact point between the developer-carrying member 24a and the coating roller 24b, the surface of the coating roller 24b moves in the direction opposite to the moving direction (rotation direction) of the surface of the developer-carrying member 24a (rotation is made in the identical direction). In this way, the developer is applied to the developer-carrying member 24a. The coating roller 24b is constituted of a core metal to which bias is applied and a high resistivity layer or a medium resistivity layer on the core metal. The potential on the surface of the coating roller 24b is controlled by applying the bias to the coating roller 24b, which is preferable to control the supply and removal of the developer. An elastic layer may be provided on the core metal.

In order to control a coat layer of the developer on the developer-carrying member 24a, a non-magnetic blade that is formed by means of bending SUS 316 (a developer restricting member 24c) into an L shape is abutted to the developer-carrying member 24a.

The developer that is housed in a developing assembly 24 is applied to the developing roller 24a that serves as the developer-carrying member by means of the developer coating roller 24b and a coating blade 24c. The developer receives charge accordingly.

The developer 4d applied to the developing roller 24a is conveyed along with the rotation of the developing roller 24a to the developing part a where the photosensitive member 21 and the developing roller 24a are opposite to each other.

The developing roller 24a is applied with a development bias voltage from a development bias voltage supply S2. The development bias voltage is a superposed voltage of −400 V DC voltage and a rectangular AC voltage having a frequency of 2,000 Hz and a peak-to-peak voltage of 1,800 V (electric field intensity of 6.0×10⁶ V/m). The development bias voltage is used to effect non-magnetic one-component jumping development between the developing roller 24a and the photosensitive member 21.

The image forming apparatus further comprises a medium resistivity transfer roller 25 (roller resistivity of 5×10⁸ Ωcm) that serves as a contact transferring means. The transfer roller 25 is forced against the photosensitive member 21 at a linear pressure of 98 N/m to form a transfer nip. To the transfer nip, a transfer material P as a recording medium is supplied. A DC voltage of 2,800 V is applied to the transfer roller 25 as a transfer bias voltage from a transfer bias voltage supply S3, whereby toner images on the photosensitive member 21 are successively transferred onto the surface of the transfer material P supplied to the transfer nip. Thus, the transfer material P introduced to the transfer nip is nipped and conveyed through the transfer P, and on its surface, the toner images formed on the surface of the photosensitive member 21 are successively transferred under the action of an electrostatic force and a pressing force.

A fixing device 26 of the heat fixing type is provided. In the fixing device 26, a toner image on the transfer material is heated from a planar heat-generating member 26a via a heat-resistant endless belt 26b while receiving a pressure from a pressure roller 26c. The image is thus fixed under heat and pressure. The transfer material P having received a toner image from the photosensitive member 21 at the transfer nip is separated from the surface of the photosensitive member 21 and introduced into the fixing device 26, where the toner image is fixed to provide an image product (print or copy). The transfer materials with the toner image is then conveyed out of the device.

In the image forming apparatus according to this embodiment, the transfer-residual toner particles that are left on the surface of the photosensitive member 21 after the transfer of the toner image onto the transfer material P are not removed by a cleaner. They travel via the charging part and reach the developing part along with the rotation of the photosensitive member 21. The developer is subjected to a cleaning-at-development operation (collection) in the developing device 24.

The reference numeral 27 depicts a process cartridge that can be loaded into and unloaded from the image forming apparatus. In the image forming apparatus of this embodiment, three process components, i.e., the photosensitive member 21 (the image-bearing member), the charging brush 22 (the contact charging member), and the developing device 24 are collectively supported to form a process cartridge that can be loaded into and unloaded from the printer via a loading guide/retention member 28. The components of the process cartridge are not limited to the above-listed three components. Instead, the process cartridge may be composed of other combinations of devices.

The conductive fine powder that is contained in the developer in the developing device 24 is moved together with the toner particles and transferred in an appropriate amount to the photosensitive member 21 at the time of developing the electrostatic latent image by the developing device 24.

The toner images, that is, the toner particles on the photosensitive member 21 are readily caused to be transferred to the transfer material P that serves as the recording medium under the influence of the transfer bias at the transfer part b. However, the conductive fine powder on the photosensitive member 21 is not readily caused to be transferred to the transfer material P because of its electroconductivity. The conductive fine powder is substantially deposited and retained on the photosensitive member 21.

In the present invention, no cleaning unit is involved in the image forming apparatus. The transfer-residual toner particles and the conductive fine powder that are left on the photosensitive member 21 after the transfer are brought to the charging part n formed at the abutting part between the photosensitive member 21 and the charging brush 22 that serves as the contact charging member, along with the rotation of the photosensitive member 21. They are then deposited on or incorporated into the charging brush 22. As a result, the photosensitive member 21 is charged in the presence of the conductive fine powder at the abutting part n between the photosensitive member 21 and the charging brush 22.

Because of the presence of the conductive fine powder, very close contact or low contact resistivity can be provided between the charging brush 22 and the photosensitive member 21 even when the transfer-residual toner particles are deposited on or incorporated into the charging brush 22. Accordingly, charging of the photosensitive member 21 can be performed by using the charging brush 22 at a high charging efficiency.

The charging brush 22 closely contacts the photosensitive member 21 via the conductive fine powder, and the conductive fine powder rubs the surface of the photosensitive member 21 without discontinuity. As a result, the charging of the photosensitive member 21 by the charging brush 22 is performed not relying on the discharge-based mechanism but mainly relying on the stable and safe direct injection charging mechanism, to provide a high charging efficiency that has not been achieved by conventional roller charging. As a result, a potential that is almost identical to the voltage applied to the charging brush 22 can be imparted to the photosensitive member 21.

The transfer-residual toner particles that are deposited on or incorporated into the charging brush 22 are gradually released from the charging brush 22 to the photosensitive member 21 and reach the developing part a along with the movement of the photosensitive member 21. The toner particles are subjected to the cleaning-at-development step (collection) in the developing device 24.

The cleaning-at-development step is a step of collecting the toner particles, which are left on the photosensitive member 1 after the transfer, at the time of developing after the formation of images (i.e., during development of a latent image formed after the charging and exposing steps are performed again after the first development) under the action of a fog-removing bias of the developing device (Vback, i.e., a difference between a DC voltage applied to the developing device and a surface potential on the photosensitive member). In the image forming apparatus according to this embodiment adopting a reversal development scheme, the cleaning-at-development step is performed under the action of an electric field that collects the toner particles from a dark portion potential part on the photosensitive member and an electric field that deposits (develops) the toner particles from the developing sleeve on a light portion potential part on the photosensitive member, in response to the development bias.

As the image forming apparatus is operated, the conductive fine powder contained in the developer in the developing device 24 is transferred to the surface of the photosensitive member 21 at the developing part a, and moved via the transfer part b to the charging part n along with the movement of the surface of the photosensitive member 21, whereby the charging part n is successively supplied with fresh conductive fine powder. As a result, even when the conductive fine powder is reduced by falling or when the conductive fine powder at the charging part n is deteriorated, the charging properties of the image-bearing member are kept constant and good charging properties of the photosensitive member 21 are stably retained.

In the image forming apparatus involving a contact charging scheme, a transfer scheme and a toner recycle process, the photosensitive member can be uniformly charged at a low application voltage by using the charging brush 22 as the contact charging member. Furthermore, ozone-free direct injection-based charging can be stably maintained to exhibit uniform charging properties even though the charging brush 22 is soiled with the transfer-residual toner particles. As a result, it is possible to provide a simple and cost-effective image forming apparatus without problems, such as generation of ozone products and faulty charging.

A non-contact developing device is used in this embodiment, so that good images can be formed without causing charge injection to the photosensitive member 21 by the development bias. Furthermore, no charge injection occurs to the photosensitive member 21 at the developing part a. This means that it is possible to provide a large potential difference between the developing sleeve 24a and the photosensitive member 21 by means of, for example, applying an AC bias. Consequently, it becomes possible to uniformly apply the conductive fine powder to the surface of the photosensitive member 21 to achieve uniform contact at the charging part and to obtain good images.

The present invention is described more specifically with reference to Examples. However, the present invention is not limited to those specific Examples.

First of all, some examples of production of photosensitive members as image-bearing members used in Examples are described below.

In the following examples of producing the photosensitive members, a layer of the same composition as that of the outermost layer of the image-bearing member was formed on a polyethylene terephthalate (PET) film on which gold had been deposited, and the volume resistivity of the layer is measured by using a picoammeter (Model 4140B pA MATER available from Hewlett-Packard Company) while applying a voltage of 100 V across the film in an environment of 23° C. and 65% RH. The contact angle of the surfaces of the photosensitive members was measured by using pure water and a contact angle meter (Model CA-DS available from Kyowa Interface Science Co., LTD.).

### PHOTOSENSITIVE MEMBER PRODUCTION EXAMPLE 1

A negatively chargeable photosensitive member using an organic photoconductor (“OPC photosensitive member”) was prepared in the following manner.

An aluminum cylinder having a diameter of 24 mm was used as a substrate for the photosensitive member. The following layers were successively laminated on the cylinder by dipping to form a photosensitive member having a configuration shown in FIG. 6.

A first layer 12 was a conductive layer, which is a conductive particle-dispersed resin layer (formed of phenolic resin with tin oxide and titanium oxide powder dispersed therein) having a thickness of approximately 20 μm, for smoothening defects, etc., on the aluminum drum and for preventing the occurrence of moire due to reflection of exposure laser beam.

A second layer 13 was a positive charge injection prevention layer for preventing a positive charge injected from the aluminum substrate 11 from dissipating the negative charge imparted by charging the photosensitive member surface. It was formed as a medium resistivity layer having a thickness of approximately 1 μm, with a resistivity of approximately 10⁶ Ω·cm formed of methoxymethylated nylon.

A third layer 14 was a charge generation layer which is a resinous layer containing a disazo pigment dispersed in butyral resin and having a thickness of approximately 0.3 μm, for generating positive and negative charge pairs on receiving exposure laser light.

A fourth layer 14 was a charge transport layer having a thickness of approximately 25 μm that was formed by dispersing a hydrazone compound in a polycarbonate resin. This is a p-type semiconductor layer, so that the negative charge imparted to the surface of the photosensitive member cannot be moved through the layer. Only the positive charge generated in the charge generation layer is transported to the photosensitive member surface.

A fifth layer 16 was a charge injection layer containing conductive ultrafine particles of tin oxide and tetrafluoroethylene resin particles having a particle diameter of approximately 0.25 μm. The particles were dispersed in a photocurable acrylic resin. More specifically, 100% by weight of low-resistivity antimony-doped tin oxide particles of approximately 0.03 μm in diameter, 20% by weight of tetrafluoroethylene resin particles and 1.2% by weight of dispersing agent, based on the resin, were dispersed in the resin to prepare a coating solution. The coating solution was applied by spray coating to form a film having a thickness of approximately 3 μm to form the charge injection layer 16.

The outermost layer of the photosensitive member obtained in this example exhibited a volume resistivity of 5×10¹² Ω·cm and a contact angle to water of 10³ degrees.

### PHOTOSENSITIVE MEMBER PRODUCTION EXAMPLE 2

The photosensitive member production example 1 was repeated to produce a photosensitive member except that the tetrafluoroethylene resin particles and the dispersing agent are not dispersed in the fifth layer (charge injection layer 16) in the photosensitive member production example 1. The outermost layer of the photosensitive member obtained in this example exhibited a volume resistivity of 2×10¹² Ω·cm and a contact angle to water of 78 degrees.

### PHOTOSENSITIVE MEMBER PRODUCTION EXAMPLE 3

The photosensitive member production example 1 was repeated to produce a photosensitive member except that the amount of the low-resistivity antimony-doped conductive tin oxide ultrafine particles of approximately 0.03 μm in diameter was changed to 300 parts by weight based on 100 parts by weight of the photocurable acrylic resin in the fifth layer (charge injection layer 16) in the photosensitive member production example 1. The outermost layer of the photosensitive member obtained in this example exhibited a volume resistivity of 2×10⁷ Ω·cm and a contact angle to water of 88 degrees.

### PHOTOSENSITIVE MEMBER PRODUCTION EXAMPLE 4

The photosensitive member production example 1 was repeated to produce a four-layered photosensitive member except that the fifth layer (charge injection layer 16) in the photosensitive member production example 1 was not provided and the charge transport layer was used as the outermost layer of the four-layered photosensitive member. The outermost layer of the photosensitive member obtained in this example exhibited a volume resistivity of 1×10¹⁵ Ω·cm and a contact angle to water of 73 degrees.

Next, some examples of production of charging members used in the Examples of the present invention are described below.

The resistivity of the roller was measured by pressing the roller against a cylindrical aluminum drum having a diameter of 30 mm to force the core metal of the roller against the aluminum drum under a linear pressure of 39.2 N/m (a load of 39.2 N per a contact area of 1 m in length between the roller and the image-bearing member in the longitudinal direction; e.g., a total load of 9.2 N for a 234-mm length roller) applying a voltage of 100 V between the core metal of the roller and the aluminum drum.

### CHARGING MEMBER PRODUCTION EXAMPLE 1

A SUS (stainless steel)-made roller of 6 mm in diameter and 264 mm in length was used as a core metal. A medium resistivity foam urethane layer was coated on the core metal to form a roller by using a composition of an urethane resin, carbon black (as conductive particles), a sulphidizing agent and a foaming agent. The roller was cut and polished for shape and surface adjustment. Thus, a charge roller with a flexible foam urethane roller of 12 mm in diameter and 234 mm in length was obtained.

The foam urethane roller of the charge roller obtained in this example exhibited a resistivity of 10⁵ Ω·cm and an Asker-C hardness of 30 degrees.

### CHARGING MEMBER PRODUCTION EXAMPLE 2

A SUS (stainless steel)-made roller of 6 mm in diameter and 264 mm in length was used as a core metal. A medium resistivity foam EPDM layer was coated on the core metal to form a roller by using a composition of an EPDM rubber, carbon black (as conductive particles), a sulphidizing agent and a foaming agent. The roller was cut and polished for shape and surface adjustment. Thus, a charge roller with a flexible foam EPDM roller of 12 mm in diameter and 234 mm in length was obtained.

The foam EPDM roller of the charge roller obtained in this example exhibited a resistivity of 10⁶ Ω·cm and an Asker-C hardness of 45 degrees.

### CHARGING MEMBER PRODUCTION EXAMPLE 3

The charge member production example 2 was repeated to produce a charge roller with a flexible EPDM roller of 12 mm in diameter and 234 mm in length except that a medium resistivity, non-foam EPDM layer was formed into a roller.

The EPDM roller of the charge roller obtained in this example exhibited a resistivity of 10⁵ Ω·cm and an Asker-C hardness of 60 degrees.

### CHARGING MEMBER PRODUCTION EXAMPLE 4

A SUS (stainless steel)-made roller of 6 mm in diameter and 264 mm in length was used as a core metal. A tape to which conductive nylon fiber piles are inserted was wound on the core metal in a spiral form to form a roll-shaped charging brush. The conductive nylon fiber has carbon black dispersed in the nylon fiber whose resistivity was adjusted. The fiber had a thickness of 6 deniers (300 deniers/50 filaments). The brush fiber length was 3 mm, a brush density was 1.5×10⁸ fibers per square meter (100,000 fibers per square inch). The charging brush roll obtained in this example exhibited a resistivity of 10⁷ Ω·cm.

Then, some examples of production or provision of toner particles, an inorganic fine powder and conductive fine powder that are contained in developers are described. Some examples of production of developers used in the examples of the present invention are also described. Physical properties were evaluated as follows.

Volume-Average Particle Diameter of the Toner Particles:

As in the measurement of the particle size distribution of the developer, the circle-corresponding diameter measured by using a flow type particle image analyzer is defined as the “particle diameter”, and a volume-average particle diameter is calculated that can be obtained from the volume-based particle size distribution over the particle diameter range of circle-corresponding diameter from 0.60 μm, inclusive, to 159.21 μm, exclusive. In practice, the volume-average particle diameter was calculated by using a flow type particle image analyzer FPIA-1000 (TOA Medical Electronics Co., Ltd.).

Resistivity of the Toner Particles:

Approximately 0.5 g of a powder sample was placed in a cylinder having a bottom area of 2.26 cm² and sandwiched between upper and lower electrodes under a load of 15 kg. Then, a voltage of 1000 volts was applied between the electrodes to measure the resistivity. The resistivity of the toner particles was then calculated by normalization.

The Number-Average Particle Diameter of the Primary Particles of the Inorganic Fine Powder:

Comparison was made between a photograph of the developer taken in an enlarged form through a scanning electron microscope and a photograph of the developer that is mapped with elements contained in the inorganic fine powder by using element analyzing means such as an X-ray microanalyzer (XMA) associated with the scanning electron microscope. Measurement was made on 100 or more primary particles of the inorganic fine powder which are either deposited on the surface of the toner particles or are freely moved to determine the number-average particle diameter.

Specific Surface Area of the Inorganic Fine Powder:

The specific surface area of the inorganic fine powder was measured by the nitrogen adsorption BET method, i.e., according to a BET multi-point method using a specific surface area analyzer Autosorb I (Yuasa Ionics) with nitrogen gas.

Resistivity of the Conductive Fine Powder:

Approximately 0.5 g of a powder sample was placed in a cylinder having a bottom area of 2.26 cm² and sandwiched between upper and lower electrodes under a load of 15 kg. Then, a voltage of 100 volts was applied between the electrodes to measure the resistivity. A specific resistivity was then calculated by normalization.

Particle Size Distribution of the Conductive Fine Powder:

A minute amount of surfactant was added to 10 ml of pure water, to which 10 mg of sample conductive fine powder was added. The mixture was subjected to dispersion by using an ultrasonic disperser (ultrasonic homogenizer) for 10 minutes. A laser diffraction particle size distribution analyzer (Model LS-230, available from Coulter Electronics Inc.) was equipped with a liquid module, and the measurement was performed in a particle diameter range of 0.04 to 2000 μm to obtain a volume-basis particle diameter distribution through a single measurement for 90 sec. From the volume-based particle size distribution, a 10% volume diameter D₁₀, a 50% volume diameter D₅₀, and a 90% volume diameter D₉₀ were calculated.

The conductive fine powder was observed through a scanning electron microscope at magnifications of 3,000 and 30,000 to confirm primary particles and agglomerated matters.

### TONER PARTICLES PRODUCTION EXAMPLE 1

As a binder resin 100 parts by weight of styrene-butyl acrylate-monobutyl maleate half-ester copolymer (peak molecular weight=35,000; glass transition temperature=65° C.), 90 parts by weight of magnetite powder (saturation magnetization=85 Am²/kg, residual magnetization=8 Am²/kg, coercive force=7 kA/m, at a magnetic field of 795.8 kA/m) (magnetic powder), 2 parts by weight of an iron complex (negative charge control agent) of a salicylic acid derivative, and 3 parts by weight of maleic anhydride-modified polypropylene (release agent) were blended by a blender. The mixture was melt-kneaded in an extruder heated at 130° C. The kneaded product was cooled, coarsely crushed and finely pulverized by a pulverizer using a jet air stream. The resultant pulverizate was strictly classified by a multi-division classifier utilizing the Coanda effect to obtain toner particles 1 having a volume-average particle diameter of 8.8 μm. The toner particles 1 exhibited a resistivity of at least 10¹⁴ Ω·cm.

### TONER PARTICLES PRODUCTION EXAMPLES 2 and 3

The toner particles production example 1 was repeated to produce toner particles 2 having a volume-average particle diameter of 8.0 μm except that a mechanical pulverizer was used under pulverization conditions to provide a higher circularity of the toner particles.

The mechanical pulverizer was used under pulverization conditions to provide a yet higher circularity of the toner particles. The pulverizate was strictly classified by a multi-division classifier utilizing the Coanda effect to obtain toner particles 3 having a volume-average particle diameter of 7.5 μm.

The toner particles 2 and 3 exhibited a resistivity of at least 10¹⁴ Ω·cm.

### TONER PARTICLES PRODUCTION EXAMPLE 4

The toner particles production example 1 was repeated to produce toner particles 4 having a volume-average particle diameter of 8.3 μm except that 5 parts by weight of carbon black was used as the colorant in place of the magnetic powder, and that 1 part by weight of monoazo iron complex was used in place of 2 parts by weight of the iron complex of the salicylic acid derivative as the negative charge control agent. The toner particles 4 exhibited a resistivity of at least 10¹⁴ Ω·cm.

### TONER PARTICLES PRODUCTION EXAMPLES 5 and 6

The toner particles 4 obtained in the toner particles production example 4 were subjected to spherization by using thermal/mechanical impact forces in a toner particle spherizer as shown in FIGS. 7 and 8. The degree of spherization was modified as given in Table 2 below. Thus, toner particles 5 and 6 were obtained that had volume-average particle diameters 8.2 μm and 8.1 μm, respectively, calculated from the volume-based particle size distribution over the particle diameter range of from 0.60 μm, inclusive, to 159.21 μm, exclusive. The toner particles 5 and 6 had a resistivity of at least 10¹⁴ Ω·m.

### TONER PARTICLES PRODUCTION EXAMPLE 7

The toner particles production example 5 was repeated to produce toner particles 7 having a volume-average particle diameter of 11.2 μm except that pulverization and classification conditions were modified.

Some physical properties of the toner particles 1 to 7 in the above-mentioned examples are given in Table 2 below.

TABLE 2

| | Particle size | | | | | | |
|---|---|---|---|---|---|---|---|
| | distribution | | | | | | |
| | | % by number | | | | | |
| | Volume- | of from 1.00 | Circularity | | Surface modification conditions | | |
| | Average | μm, | distribution | | Peri- | | Maximum |
| | particle | inclusive, | % by | Standard | pheral | | temperature |
| | diameter | to 2.00 μm, | number of | deviation | speed | Modification | inside the |
| Toner | (μm) | exclusive | a ≧ 0.90 | SD | (m/s) | time (min.) | machine (° C.) |
| 1 | 8.8 | 5.7 | 88.6 | 0.043 | untreated | | |
| 2 | 8.0 | 5.6 | 86.5 | 0.046 | untreated | | |
| 3 | 7.5 | 3.3 | 92.6 | 0.044 | untreated | | |
| 4 | 8.3 | 14.1 | 90.7 | 0.043 | untreated | | |
| 5 | 8.2 | 9.8 | 93.6 | 0.034 | 80 | 2 | 56 |
| 6 | 8.1 | 2.3 | 94.1 | 0.032 | 90 | 4 | 64 |

| | | | | | |
|---|---|---|---|---|---|
| 7 | 11.2 | 8.5 | 84.8 | 0.047 | untreated |

### EXAMPLE OF AN INORGANIC FINE POWDER 1

Hydrophobic dry process silica fine powder was used as an inorganic fine powder A-1 which was first treated with hexamethyldisilazane and then with dimethyl silicone oil (15 parts by weight relative to 100 parts by weight of silica). The inorganic fine powder A-1 had a number-average particle diameter of the primary particles of 12 nm, and a BET specific surface area of 120 m²/g.

### EXAMPLE OF AN INORGANIC FINE POWDER 2

Dry process silica fine powder without hydrophobization was used as an inorganic fine powder A-2. The inorganic fine powder A-2 had a number-average particle diameter of the primary particles of 10 nm, and a BET specific surface area of 300 m²/g.

### EXAMPLE OF AN INORGANIC FINE POWDER 3

Dry process silica fine powder treated with hexamethyldisilazane was used as an inorganic fine powder A-3. The inorganic fine powder A-3 had a number-average particle diameter of the primary particles of 16 nm, and a BET specific surface area of 170 m²/g.

### EXAMPLE OF AN INORGANIC FINE POWDER 4

Titanium dioxide fine powder treated with hexamethyldisilazane was used as an inorganic fine powder A-4. The inorganic fine powder A-4 had a number-average particle diameter of the primary particles of 30 nm, and a BET specific surface area of 60 m²/g.

Some physical properties of the inorganic fine powders A-1 to A-4 are given in Table 3 below.

TABLE 3

| | | Primary | | |
|---|---|---|---|---|
| | | particle | | |
| | | diameter | BET | |
| | Material | (nm) | (m²/g) | Treatment |
| A-1 | Dry process | 10 | 160 | Treated with |
| | silica | | | hexamethyldisilazane and |
| | | | | then treated with |
| | | | | silicone oil |
| A-2 | Dry process | 10 | 300 | No treatment with |
| | silica | | | hydrophobizing agent |
| A-3 | Dry process | 16 | 170 | Treated with |
| | silica | | | hexamethyldisilazane |
| A-4 | Titanium | 30 | 60 | Treated with |
| | dioxide | | | hexamethyldisilazane |

### EXAMPLE OF CONDUCTIVE FINE POWDER 1

Zinc oxide fine powder that contains an aluminum element and has a resistivity of 100 Ω·cm was used as conductive fine powder B-1.

The conductive fine powder B-1 was formed of an agglomerated matter having a particle diameter of 0.3 to 10 μm. The agglomerated matter was formed as a result of the agglomeration of primary particles having a number-average particle diameter of 100 nm.

The conductive fine powder B-1 was white colored, and had a transmittance of 35% at a wavelength of 740 nm, when measured using a light source having a wavelength of 740 nm and a transmission densitometer X-Rite Model 310T. The wavelength of 740 nm was identical to the wavelength of laser beam emitted by a laser beam scanner for imagewise exposure in an image forming apparatus used in Examples described hereinafter.

### EXAMPLE OF CONDUCTIVE FINE POWDER 2

Zinc oxide fine powder having a resistivity of 400 Ω·cm was obtained as conductive fine powder B-2, by means of pneumatic classification of the conductive fine powder B-1.

The conductive fine powder B-2 was white colored, and had a transmittance of 35% at a wavelength of 740 nm.

The conductive fine powder B-2 was formed of an agglomerated matter having a particle diameter of 1 to 5 μm. The agglomerated matter was formed as a result of the agglomeration of primary particles having a number-average particle diameter of 100 nm.

### EXAMPLE OF CONDUCTIVE FINE POWDER 3

Zinc oxide fine powder having a resistivity of 1,500 Ω·cm was obtained as conductive fine powder B-3, by means of pneumatic classification of the conductive fine powder B-2 after disintegration.

The conductive fine powder B-3 had a transmittance of 35% at a wavelength of 740 nm.

The conductive fine powder B-3 was formed of primary particles having a number-average particle diameter 100 nm and an agglomerated matter having a particle diameter of 0.5 to 3 μm. The agglomerated matter was formed as a result of the agglomeration of the primary particles.

### EXAMPLE OF CONDUCTIVE FINE POWDER 4

White conductive fine powder was obtained by means of dispersing the above-mentioned conductive fine powder B-3 into an aqueous system and filtrating the mixture repeatedly to remove fine particles. The conductive fine powder obtained in this way had a volume resistivity of 1,500 Ω·cm, and was designated as conductive fine powder B-4.

The conductive fine powder B-4 was white colored, and had a transmittance of 35% at a wavelength of 740 nm.

The conductive fine powder B-4 was formed of primary particles having a number-average particle diameter of 100 nm and an agglomerated matter having a particle diameter of 1 to 4 μm. The agglomerated matter was formed as a result of the agglomeration of zinc oxide primary particles. A ratio of the primary particles was reduced as compared with the conductive fine powder B-3.

### EXAMPLE OF CONDUCTIVE FINE POWDER 5

Zinc oxide fine powder having a resistivity of 1×10⁵ Ω·cm was used as conductive fine powder B-5. The conductive fine powder B-5 had blue-tint white colored and had a transmittance of 25% at a wavelength of 740 nm.

The conductive fine powder B-5 was formed of primary particles having a number-average particle diameter of 1,000 nm and a particle diameter of 0.2 to 1.5 μm, and agglomerated matters of the primary particles having a particle diameter of 1 to 5 μm.

### EXAMPLE OF CONDUCTIVE FINE POWDER 6

Zinc oxide fine powder that contains an aluminum element and has a resistivity of 80 Ω·cm was used as conductive fine powder B-6. The conductive fine powder B-6 was white colored and had a transmittance of 35% at a wavelength of 740 nm.

The conductive fine powder B-6 was formed of primary particles and agglomerated matters of the primary particles having a particle diameter of 0.2 to 0.4 μm, whose primary particles had a number-average particle diameter of 200 nm. Agglomerated matters of about 1 μm or larger were not found.

### EXAMPLE OF CONDUCTIVE FINE POWDER 7

Tin oxide fine powder having a resistivity of 7×10⁴ Ω·cm was used as conductive fine powder B-7. The conductive fine powder B-7 was white colored and had a transmittance of 30% at a wavelength of 740 nm.

The conductive fine powder B-7 was mostly formed of primary particles having a number-average particle diameter of 30 nm. No agglomerated matters of closely adhered primary particles, as in the conductive fine powders B-1 to B-4, were found. Agglomerated matters of about 1 μm or larger were not found.

Some physical properties of the conductive fine powders B-1 to B-7 are given in Table 4 below.

TABLE 4

| | | Average | | | | | |
|---|---|---|---|---|---|---|---|
| | | primary | Particle size | | | | |
| | | particle | distribution | | | | Trans- |
| | | diameter | D10 | D50 | D90 | Resistivity | missivity |
| | Material | (nm) | (μm) | (μm) | (μm) | (Ω · cm) | (%) |
| B-1 | zinc | 100 | 1.79 | 5.37 | 10.14 | 100 | 35 |
| | oxide | | | | | | |
| B-2 | zinc | 100 | 1.21 | 2.90 | 4.77 | 400 | 35 |
| | oxide | | | | | | |
| B-3 | zinc | 100 | 1.00 | 2.14 | 3.56 | 1500 | 35 |
| | oxide | | | | | | |
| B-4 | zinc | 100 | 1.70 | 2.72 | 3.77 | 1500 | 35 |
| | oxide | | | | | | |
| B-5 | zinc | 1000 | 1.17 | 3.20 | 5.30 | 1.2 × E5 | 25 |
| | oxide | | | | | | |
| B-6 | zinc | 200 | 0.24 | 0.45 | 0.71 | 80 | 35 |
| | oxide | | | | | | |
| B-7 | tin | 30 | 0.15 | 0.30 | 0.52 | 7.0 × E4 | 30 |
| | oxide | | | | | | |

### EXAMPLE 1

### DEVELOPER PRODUCTION EXAMPLE 1

To 100 parts by weight of magnetic toner particles 1 that were obtained in the toner particles production example 1, 1.55 parts by weight of an inorganic fine powder A-1 and 2.07 parts by weight of conductive fine powder B-1 were added. The mixture was mixed uniformly by using a mixer to obtain a magnetic developer 1. As apparent from Table 5, the magnetic developer 1 contains 1.5% by weight of an inorganic fine powder and 2.0% by weight of conductive fine powder.

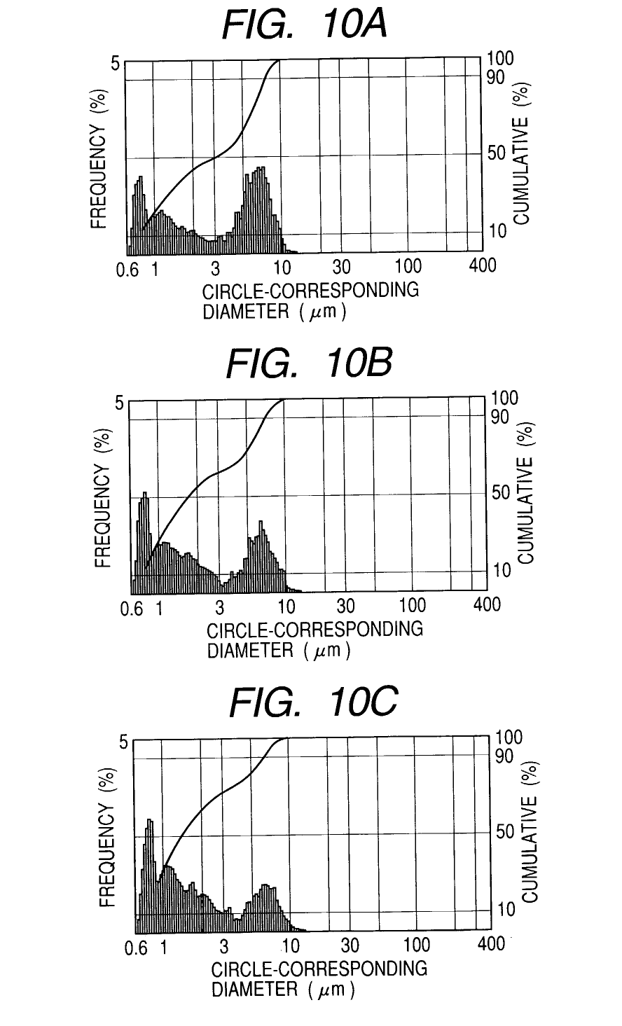

FIG. 9A shows the number-based particle size distribution over the particle diameter range of from 0.60 μm, inclusive, to 159.21 μm, exclusive, of the magnetic developer 1. Table 5 shows values obtained from the particle size distribution thereof. These values were measured by using a flow type particle image analyzer, FPIA-1000 (TOA Medical Electronics Co., Ltd.), according to the method described above.

The magnetic developer 1 had a magnetization intensity of 31 Am²/kg at the magnetic field of 79.6 kA/m.

### EXAMPLES 2 TO 4

### DEVELOPER PRODUCTION EXAMPLES 2 TO 4

The developer production example 1 was repeated to produce magnetic developers 2 to 4 except that the content of the conductive fine powder B-1 was changed to 5.0% by weight, 8.0% by weight and 12.0% by weight, respectively.

FIGS. 9B, 9C, and 9D show the number-based particle size distribution over the particle diameter range of from 0.60 μm, inclusive, to 159.21 μm, exclusive, for the magnetic developers 2 to 4.

### EXAMPLES 5 TO 8

### DEVELOPER PRODUCTION EXAMPLES 5 TO 8

The developer production example 1 was repeated to produce magnetic developers 5 to 8 except that the conductive fine powder B-2 was used in place of the conductive fine powder B-1, as apparent from Table 5, and contents thereof were varied.

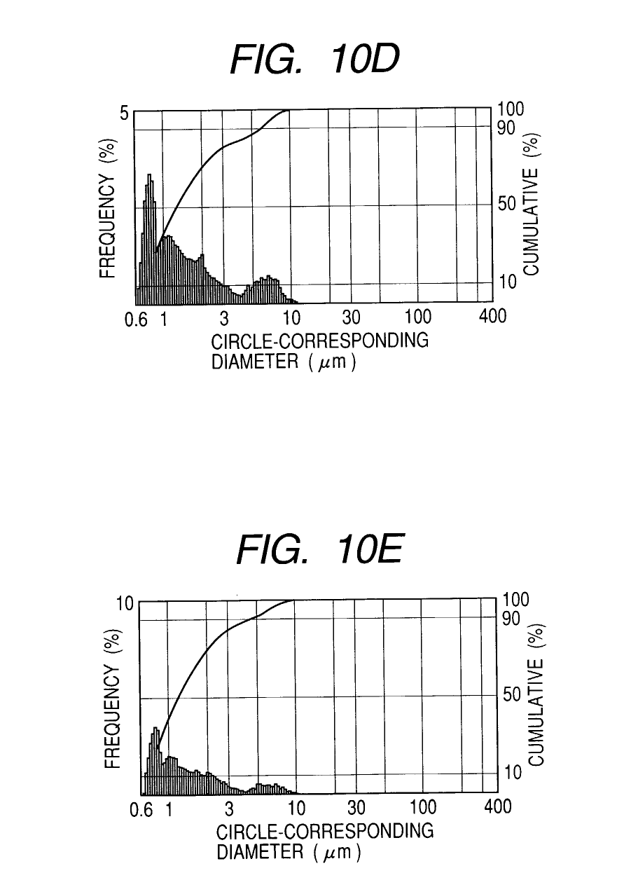

FIGS. 10A, 10B, 10C and 10D show the number-based particle size distribution over the particle diameter range of from 0.60 μm, inclusive, to 159.21 μm, exclusive, for the magnetic developers 5 to 8.

### COMPARATIVE EXAMPLE 1

### DEVELOPER PRODUCTION EXAMPLE 9

The developer production example 1 was repeated to produce a magnetic developer 9 except that the conductive fine powder B-2 was used in an amount of 12.0% by weight in place of the conductive fine powder B-1 of 2.0% by weight.

FIG. 10E shows the number-based particle size distribution over the particle diameter range of from 0.60 μm, inclusive, to 159.21 μm, exclusive, for the magnetic developer 9. The magnetic developer 9 contained 35.7% by number of particles having the particle diameter range of from 1.00 μm, inclusive, to 2.00 μm, exclusive, measured from the number-based particle size distribution over the particle diameter range of from 0.60 μm, inclusive, to 159.21 μm, exclusive.

### EXAMPLES 9 AND 10

### DEVELOPER PRODUCTION EXAMPLES 10 AND 11

The developer production example 1 was repeated to produce magnetic developers 10 and 11 except that the conductive fine powder B-3 or B-4 was used in place of the conductive fine powder B-1, as apparent from Table 5, and contents thereof were varied.

### COMPARATIVE EXAMPLE 2

### DEVELOPER PRODUCTION EXAMPLE 12

The developer production example 1 was repeated to produce a magnetic developer 12 except that the conductive fine powder B-5 was used in an amount of 1.0% by weight in place of the conductive fine powder B-1 of 2.0% by weight.

The magnetic developer 12 contained 13.0% by number of particles having the particle diameter range of from 1.00 μm, inclusive, to 2.00 μm, exclusive, measured from the number-based particle size distribution over the particle diameter range of from 0.60 μm, inclusive, to 159.21 μm, exclusive.

### COMPARATIVE EXAMPLES 3 AND 4

### DEVELOPER PRODUCTION EXAMPLES 13 AND 14

The developer production example 12 was repeated to obtain magnetic developers 13 and 14 except that the conductive fine powder B-5 was contained in an amount of 2.0% by weight or 5.0% by weight.

### COMPARATIVE EXAMPLES 5 TO 7

### DEVELOPER PRODUCTION EXAMPLES 15 TO 17

The developer production example 1 was repeated to produce magnetic developers 15 to 17 except that the conductive fine powder B-6 or B-7 was used in an amount of 2.0% by weight or 5.0% by weight in place of the conductive fine powder B-1. The magnetic developers 15 to 17 contained 11.2% by number, 9.6% by number, and 8.8% by number, respectively, of particles having the particle diameter range of from 1.00 μm, inclusive, to 2.00 μm, exclusive, measured from the number-based particle size distribution over the particle diameter range of from 0.60 μm, inclusive, to 159.21 μm, exclusive.

### COMPARATIVE EXAMPLE 8

### DEVELOPER PRODUCTION EXAMPLE 18

The developer production example 1 was repeated to produce a magnetic developer 18 except that no conductive fine powder was used. FIG. 9E shows the number-based particle size distribution over the particle diameter range of from 0.60 μm, inclusive, to 159.21 μm, exclusive, for the magnetic developer 18. The magnetic developer 18 contained 9.0% by number of particles having the particle diameter range of from 1.00 μm, inclusive, to 2.00 μm, exclusive, measured from the number-based particle size distribution over the particle diameter range of from 0.60 μm, inclusive, to 159.21 μm, exclusive.

### EXAMPLES 11 TO 14

### DEVELOPER PRODUCTION EXAMPLES 19 TO 22

The developer production example 1 was repeated to produce magnetic developers 19 to 22 except that the type and content of the inorganic fine powder were varied as shown in Table 5 in place of 1.5% by weight of an inorganic fine powder A-1.

The magnetic developers 2 to 22 had a magnetization intensity of 29 to 32 Am²/kg at the magnetic field of 79.6 kA/m.

### EXAMPLES 15 AND 16

### DEVELOPER PRODUCTION EXAMPLES 23 TO 24

The developer production example 1 was repeated to produce magnetic developers 23 and 24 as shown in Table 5, except that the magnetic toner-particles 2 or 3 that were obtained in the toner particles production examples 2 or 3 was used in place of the toner particle 1.

The magnetic developers 23 and 24 had a magnetization intensity of 28 Am²/kg at the magnetic field of 79.6 kA/m.

### EXAMPLE 17

### DEVELOPER PRODUCTION EXAMPLE 25

The developer production example 1 was repeated to produce a non-magnetic developer 25 except that the non-magnetic toner particle 4 obtained in the toner particles production example 4 was used in place of the toner particle 1 and that the type and content of the inorganic fine powder and the conductive fine powder were changed as shown in Table 5.

### EXAMPLES 18 AND 19

### DEVELOPER PRODUCTION EXAMPLES 26 TO 27

The developer production example 25 was repeated to produce non-magnetic developers 26 and 27 as shown in Table 5, except that the non-magnetic toner particles 5 or 6 that were obtained in the toner particles production examples 5 or 6 was used in place of the toner particle 4.

### COMPARATIVE EXAMPLE 9

### DEVELOPER PRODUCTION EXAMPLE 28

The developer production example 1 was repeated to produce a non-magnetic developer 28 except that the non-magnetic toner particle 7 was used in place of the toner particle 1, as apparent from Table 5, and that 1.0% by weight of an inorganic fine powder A-4 was used in place of the inorganic fine powder A-1, in which the non-magnetic toner particle 7 was obtained in the toner particles production example 7 and had 16.0% by number of particles having the particle diameter range of from 3.00 μm, inclusive, to 8.96 μm, exclusive, and 27.3% by number of particles having a particle diameter of 8.96 μm or larger, in number-based particle size distribution over the particle diameter range of from 0.60 μm, inclusive, to 159.21 μm, exclusive.

Table 5 below shows, for the above-mentioned developers 1 to 28, contents of the inorganic fine powder and the conductive fine powder; % by number of particles having the particle diameter range of from 1.00 μm, inclusive, to 2.00 μm, exclusive, % by number of particles having the particle diameter range of from 2.00 μm, inclusive, to 3.00 μm, exclusive, % by number of particles having the particle diameter range of from 3.00 μm, inclusive, to 8.96 μm, exclusive, and % by number of particles having particle diameters of 8.96 μm or larger which are obtained from the number-based particle size distribution over the particle diameter range of from 0.60 μm, inclusive, to 159.21 μm, exclusive; variation coefficients over the particle diameter range of from 3.00 μm, inclusive, to 15.04 μm, exclusive; % by number of particles having a circularity of 0.90 or more; standard deviation of circularity distribution; the number of conductive fine powder having a particle diameter of 0.6 to 3 μm; and triboelectric charge of the developers with respect to the iron powder.

TABLE 5

| | | | | | | | Particle size distribution | | | | | | | Conductive fine | |
|---|---|---|---|---|---|---|---|---|---|---|---|---|---|---|---|
| | | | An inorganic | | Conductive | | | | % by number of | | | Circularity | | powder number of | |
| | | | fine | | fine | | | % by number of | from 3.00 μm, | | Variation | distribution | | particles of 0.6 to | |
| | Developer | | powder | | powder | | % by number of from | from 2.00 μm, | inclusive, to | % by | coefficient of | % by | | 3 μm (in developer | |
| | production | Toner | | Content | | Content | 1.00 μm, inclusive, to | inclusive, to 3.00 | 8.96 μm, | number of | number-based | number of | Standard | per 100 toner | Charge |
| | example | particles | | vol. % | | vol. % | 2.00 μm, exclusive | μm, exclusive | exclusive | ≧8.96 μm | distribution | a ≧ 0.90 | deviation SD | particles) | μC/g |
| Example 1 | 1 | 1 | A-1 | 1.5 | B-1 | 2.0 | 17.4 | 4.7 | 56.5 | 3.6 | 22.8 | 87.5 | 0.044 | 11 | −35.3 |
| Example 2 | 2 | 1 | A-1 | 1.5 | B-1 | 5.0 | 20.1 | 6.4 | 45.3 | 2.9 | 23.0 | 86.4 | 0.045 | 20 | −30.3 |
| Example 3 | 3 | 1 | A-1 | 1.5 | B-1 | 8.0 | 23.6 | 7.3 | 35.6 | 1.7 | 23.2 | 84.6 | 0.047 | 32 | −23.6 |
| Example 4 | 4 | 1 | A-1 | 1.5 | B-1 | 12.0 | 26.8 | 7.8 | 29.8 | 1.5 | 23.2 | 83.7 | 0.048 | 41 | −17.8 |
| Example 5 | 5 | 1 | A-1 | 1.5 | B-2 | 1.0 | 21.7 | 6.8 | 46.3 | 4.1 | 22.9 | 88.4 | 0.043 | 18 | −37.3 |
| Example 6 | 6 | 1 | A-1 | 1.5 | B-2 | 2.0 | 24.0 | 8.6 | 34.3 | 2.1 | 23.6 | 88.1 | 0.043 | 33 | −36.6 |
| Example 7 | 7 | 1 | A-1 | 1.5 | B-2 | 5.0 | 30.6 | 10.1 | 27.1 | 1.6 | 23.2 | 87.9 | 0.044 | 46 | −33.5 |
| Example 8 | 8 | 1 | A-1 | 1.5 | B-2 | 8.0 | 34.6 | 11.1 | 18.0 | 1.1 | 24.1 | 87.2 | 0.044 | 78 | −26.6 |
| Comparative | 9 | 1 | A-1 | 1.5 | B-2 | 12.0 | 35.7 | 11.9 | 14.8 | 0.7 | 23.2 | 86.0 | 0.045 | 112 | −22.2 |
| example 1 | | | | | | | | | | | | | | | |
| Example 9 | 10 | 1 | A-1 | 1.5 | B-3 | 2.0 | 25.1 | 9.2 | 24.5 | 1.5 | 23.7 | 88.4 | 0.043 | 51 | −34.0 |
| Example 10 | 11 | 1 | A-1 | 1.5 | 8-4 | 2.0 | 23.3 | 10.6 | 39.7 | 1.8 | 23.3 | 88.2 | 0.043 | 27 | −37.5 |
| Comparative | 12 | 1 | A-1 | 1.5 | B-5 | 1.0 | 13.0 | 14.1 | 60.9 | 4.8 | 23.2 | 88.0 | 0.044 | 6 | −34.1 |
| example 2 | | | | | | | | | | | | | | | |
| Comparative | 13 | 1 | A-1 | 1.5 | B-5 | 2.0 | 15.5 | 16.5 | 57.2 | 4.3 | 23.5 | 87.8 | 0.044 | 9 | −32.9 |
| example 3 | | | | | | | | | | | | | | | |
| Comparative | 14 | 1 | A-1 | 1.5 | B-5 | 5.0 | 21.3 | 21.9 | 46.7 | 3.6 | 23.9 | 87.0 | 0.045 | 18 | −27.8 |
| example 4 | | | | | | | | | | | | | | | |
| Comparative | 15 | 1 | A-1 | 1.5 | B-6 | 5.0 | 11.2 | 4.1 | 66.2 | 3.9 | 22.8 | 88.4 | 0.043 | 4 | −3.2 |
| example 5 | | | | | | | | | | | | | | | |
| Comparative | 16 | 1 | A-1 | 1.5 | B-7 | 2.0 | 9.6 | 3.3 | 68.8 | 4.2 | 22.9 | 88.6 | 0.043 | 2 | −6.7 |
| example 6 | | | | | | | | | | | | | | | |
| Comparative | 17 | 1 | A-1 | 1.5 | B-7 | 5.0 | 8.8 | 3.4 | 69.1 | 5.2 | 23.0 | 88.5 | 0.043 | 1 | −2.7 |
| example 7 | | | | | | | | | | | | | | | |
| Comparative | 18 | 1 | A-1 | 1.5 | — | — | 9.0 | 3.4 | 72.3 | 6.1 | 23.0 | 88.6 | 0.043 | 0 | −41.4 |
| example 8 | | | | | | | | | | | | | | | |
| Example 11 | 19 | 1 | A-2 | 1.0 | B-2 | 2.0 | 22.9 | 8.4 | 37.4 | 2.8 | 23.5 | 88.0 | 0.043 | 28 | −29.7 |
| Example 12 | 20 | 1 | A-2 | 1.5 | B-2 | 2.0 | 23.5 | 8.5 | 36.1 | 2.4 | 23.7 | 88.1 | 0.043 | 31 | −28.8 |
| Example 13 | 21 | 1 | A-3 | 1.2 | B-2 | 2.0 | 23.0 | 8.3 | 37.5 | 2.5 | 23.3 | 88.1 | 0.043 | 29 | −32.2 |
| Example 14 | 22 | 1 | A-4 | 1.0 | B-2 | 2.0 | 25.1 | 8.5 | 34.6 | 2.0 | 23.7 | 87.8 | 0.044 | 33 | −19.1 |
| Example 15 | 23 | 2 | A-1 | 1.5 | B-2 | 2.0 | 23.9 | 8.7 | 34.1 | 2.5 | 23.6 | 86.5 | 0.045 | 39 | −39.5 |
| Example 16 | 24 | 3 | A-1 | 1.5 | B-2 | 2.0 | 22.7 | 8.5 | 36.9 | 3.1 | 23.3 | 92.6 | 0.040 | 44 | −40.2 |
| Example 17 | 25 | 4 | A-4 | 1.2 | B-2 | 3.0 | 31.2 | 8.2 | 32.7 | 2.0 | 23.3 | 90.7 | 0.043 | 23 | −60.3 |
| Example 18 | 26 | 5 | A-4 | 1.2 | B-2 | 3.0 | 22.6 | 8.2 | 37.8 | 2.4 | 23.5 | 93.6 | 0.034 | 25 | −64.9 |
| Example 19 | 27 | 6 | A-4 | 1.2 | B-2 | 3.0 | 20.4 | 7.6 | 39.2 | 4.1 | 23.6 | 94.1 | 0.032 | 27 | −65.4 |
| Comparative | 28 | 7 | A-4 | 1.0 | B-2 | 3.0 | 35.3 | 9.1 | 16.0 | 27.3 | 41.2 | 84.7 | 0.063 | 23 | −23.6 |
| example 9 | | | | | | | | | | | | | | | |

### EXAMPLE 20

### EVALUATION OF IMAGE FORMING METHOD USING MAGNETIC DEVELOPER 1 AND CHARGING MEMBER 1

FIG. 1 is a schematic view of an image forming apparatus used in Examples of the present invention. The image forming apparatus is a laser printer (recording apparatus) that uses a cleaning-at-development process (cleanerless system) involving a transfer electrophotographic process. The image forming apparatus comprises a process cartridge with no cleaning unit having a cleaning member such as a cleaning blade. As the developer, a magnetic one-component developer 1 is used. This image forming apparatus achieves non-contact development in which the developer layer on the developer-carrying member is away from the image-bearing member without any contact.

(1) Configuration of Image Forming Apparatus

The image forming apparatus comprises a rotating drum-type OPC photosensitive member 1 (obtained in the photosensitive member production example 1) that serves as an image-bearing member. The photosensitive member 1 is rotation-driven in the clockwise (indicated by an arrow) direction at a peripheral velocity of 120 mm/sec (process speed).

A charge roller 2 (obtained in the charging member production example 1) that serves as a contact charging member is forced against the photosensitive member 1 at a predetermined pressing force in resistance to its elasticity. Between the photosensitive member 1 and the charge roller 2, a contact nip (charge abutting part) n is formed. In this embodiment, the charge roller 2 is rotated at a peripheral velocity of 120 mm/sec in an opposite direction (with respect to the surface movement direction of the photosensitive member 1) at the charge abutting part n. (This means that the charge roller 2 that serves as the contact charging member has a relative movement speed ratio of 200% to the surface of the photosensitive member 1.). The surface of the charge roller serving as the contact charging member is different in velocity from the surface of the photosensitive member 1. The conductive fine powder B-1 obtained by Example of conductive fine powder 1 is applied to the surface of the charge roller 2 to provide a generally uniform amount by a single layer.

The charge roller 2 has a core metal 2a to which a DC voltage of −700 V is applied as a charge bias from a charge bias voltage supply S1. In this embodiment, the surface of the photosensitive member 1 is uniformly charged at a potential (−680 V) that is almost equal to the voltage applied to the charge roller 2, by means of the direct injection-based charging.

The image forming apparatus also comprises a laser beam scanner 3 (exposing unit) including, for example, a laser diode and a polygon mirror. The laser beam scanner produces laser light beams whose intensity is modified corresponding to a time-series electrical digital pixel signal of desired image information and scanning-exposes (L) the uniform charged surface of the photosensitive member 1 with the laser beams. This scanning-exposure produces an electrostatic latent image corresponding to the desired image information on the rotating photosensitive member 1.

The image forming apparatus further comprises a developing device 4, by which the electrostatic latent image on the surface of the photosensitive member 1 is developed to form a toner image thereon.

The developing device 4 of this embodiment is a non-contact reversal developing device which comprises a negatively chargeable one-component insulating developer (i.e., the magnetic developer 1 obtained in the developer production example 1) as a developer 4d. The developer 4d includes toner particles 1(t) and conductive fine powder B-1 (m).

The developing device 4 has a 16 mm-diameter non-magnetic developing sleeve 4a that serves as a developer-carrying and transporting member enclosing a magnet roller 4b therein. The developing sleeve 4a is opposed to the photosensitive member 1 with a gap length of 320 μm. The developing sleeve 4a is rotated with a 110% speed difference relative to the peripheral speed of the photosensitive member 1 moving in an identical direction. In this event, the photosensitive member 1 moves in the same direction as the developing sleeve 4a moves in a developing part a (developing region) against the photosensitive member 1.

The developer 4d is applied as a thin coating layer on the developing sleeve 4a by means of an elastic blade 4c. The elastic blade 4c restricts the thickness of the layer of the developer 4d on the developing sleeve 4a and charges the developer 4d. The amount of the developer coated on the developing sleeve 4a was 16 g/m².

The developer 4d applied to the developing sleeve 4a is transported along with the rotation of the developing sleeve 4a to the developing unit a where the photosensitive member 1 and the developing sleeve 4a are opposite to each other.

The developing sleeve 4a is applied with a development bias voltage from a development bias voltage supply S2. The development bias voltage is a superposed voltage of −420 V DC voltage and a rectangular AC voltage having a frequency of 1,500 Hz and a peak-to-peak voltage of 1,600 V (electric field intensity of 5×10⁶ V/m) The development bias voltage is used to effect one-component jumping development between the developing sleeve 4a and the photosensitive member 1.

The image forming apparatus further comprises a medium resistivity transfer roller 5 that serves as a contact transferring means. The transfer roller 5 is forced against the photosensitive member 1 at a linear pressure of 98 N/m to form a transfer nip b. To the transfer nip b, a transfer material P as a recording medium is supplied from a paper supply section (not shown) at predetermined timing. A predetermined transfer bias voltage is applied to the transfer roller 5 from a transfer bias voltage supply S3, whereby toner images on the photosensitive member 1 are successively transferred onto the surface of the transfer material P supplied to the transfer nip b.

In this embodiment, the transfer roller 5 had a resistivity of 5×10⁸ Ωcm. A DC voltage of +2,000 V is applied for transfer. Thus, the transfer material P introduced to the transfer nip b is nipped and transported through the transfer nip b, and on its surface, the toner images formed on the surface of the photosensitive member 1 are successively transferred under the action of an electrostatic force and a pressing force.

A fixing device 6 of the heat fixing type is provided. The transfer material P having received a toner image from the photosensitive member 1 at the transfer nip b is separated from the surface of the photosensitive member 1 and introduced into the fixing device 6, where the toner image is fixed to provide an image product (print or copy). The transfer materials with the toner image is then conveyed out of the device.

The image forming apparatus in this embodiment has no cleaning unit. The developer (transfer-residual toner particle) remaining on the surface of the photosensitive member 1 after the transfer of the toner-based image onto the transfer material P is not removed by such a cleaner. It travels via the abutting part n and reaches the developing unit a along with the rotation of the photosensitive member 1. The developer is subjected to a cleaning-at-development operation (collection) in the developing device 4.

In the image forming apparatus according to this embodiment, three process components, i.e., the photosensitive member 1, the charge roller 2 and the developing device 4 are collectively supported to form a process cartridge 7 that is detachable from a main body of the image forming apparatus via a loading guide/retention member 8.

(2) Behavior of Conductive Fine Powder

Conductive fine powder m incorporated into the developer 4d in the developing device 4 is moved together with the toner particles t and transferred in an appropriate amount to the photosensitive member 1 at the time of developing the electrostatic latent image by the developing device 4.

The toner images, i.e., the toner particles t on the photosensitive member 1, are easily caused to be transferred to the transfer material P that serves as the recording medium under the influence of the transfer bias at the transfer unit b. However, the conductive fine powder m on the photosensitive member 1 is not easily caused to be transferred to the transfer material P because it is conductive. The conductive fine powder is substantially deposited and retained on the photosensitive member 1.

In the present invention, no cleaning unit is involved in the image forming apparatus. The transfer-residual toner particles t and the conductive fine powder m that are left on the photosensitive member 1 after the transfer are brought to the abutting part n between the photosensitive member 1 and the charge roller 2 that serves as the contact charging member, along with the rotation of the photosensitive member 1. They are then attached to the charge roller 2. As a result, the photosensitive member 1 is charged by the direct injection-based charging in the presence of the conductive fine powder m at the charge abutting part n between the photosensitive member 1 and the roller 2.

Because of the presence of the conductive fine powder m, very close contact and low contact resistivity can be provided between the charge roller 2 and the photosensitive member 1 even when the transfer-residual toner particles t are attached to the charge roller 2. Accordingly, the direct injection-based charging of the photosensitive member 1 can be performed by using the charge roller 2.

The charge roller 2 closely contacts with the photosensitive member 1 via the conductive fine powder m, and the conductive fine powder m rubs the surface of the photosensitive member 1 without discontinuity. As a result, the charging of the photosensitive member 1 by the charge roller 2 is performed not relying on the discharge-based mechanism but mainly relying on the stable and safe direct injection charging mechanism, to provide a high charging efficiency that has not been achieved by conventional roller charging. Thus, a potential almost identical to the voltage applied to the charge roller 2 can be imparted to the photosensitive member 1.

The transfer-residual toner particles t attached to the charge roller 2 are gradually released from the charge roller 2 to the photosensitive member 1 and reach the developing unit a along with the movement of the photosensitive member 1. The toner particles are subjected to the cleaning-at-development step (collection) in the developing device 4.

The cleaning-at-development step is a step of collecting the toner particles, which are left on the photosensitive member 1 after the transfer, at the time of developing after the formation of images (i.e., during development of a latent image formed through the charging and exposing steps after the previous development) under the action of a fog-removing bias of the developing device (Vback, i.e., a difference between a DC voltage applied to the developing device and a surface potential on the photosensitive member). In the image forming apparatus according to this embodiment adopting a reversal development method, the cleaning-at-development step is performed under the action of an electric field that collects the toner particles from a dark portion potential part onto the photosensitive member and an electric field that deposits the toner particles from the developing sleeve onto a light portion potential part of the photosensitive member (development), by the aid of the development bias.

As the image forming apparatus is operated, the conductive fine powder m contained in the developer in the developing device 4 is transferred to the surface of the photosensitive member 1 at the developing unit a, and moved via the transfer unit b to the charge unit n along with the movement of the surface of the photosensitive member 1, whereby the charging part n is successively supplied with fresh conductive fine powder m. As a result, even when the conductive fine powder m are reduced by falling or when the conductive fine powder m at the charging part n are deteriorated, the charging properties are kept constant and good charging properties of the photosensitive member 1 are stably retained.

In the image forming apparatus involving a contact charging method, a transfer method and a toner recycle process, the photosensitive member can be uniformly charged at a low application voltage by using a simple charge roller 2 as the contact charging member. Furthermore, ozone-free direct injection-based charging can be stably maintained for a long time to exhibit uniform charging properties even though the charge roller 2 is soiled with the transfer-residual toner particles. As a result, it is possible to provide a simple and cost-effective image forming apparatus without problems, such as generation of ozone products and faulty charging.

As described above, a non-contact developing device is used in this embodiment, so that good images can be formed without causing charge injection into the photosensitive member 1 by the development bias. Furthermore, no charge injection occurs to the photosensitive member 1 at the developing unit a. This means that it is possible to provide a large potential difference between the developing sleeve 4a and the photosensitive member 1 as an AC bias. Consequently, it becomes possible to uniformly apply the conductive fine powder m to the surface of the photosensitive member 1 to achieve uniform contact at the charging part and to obtain good images.

Owing to the lubricating effect (friction-reducing effect) of the conductive fine powder m present at the contact surface n between the charge roller 2 and the photosensitive member 1, it becomes possible to easily and effectively provide a speed difference between the charge roller 2 and the photosensitive member 1. Owing to this lubricating effect, the friction between the charge roller 2 and the photosensitive member 1 is reduced, the drive torque is reduced, and the surface abrasion or damage of the charge roller 2 and the photosensitive member 1 can be prevented. The speed difference makes it possible to remarkably increase chances for the conductive fine powder m to contact with the photosensitive member 1 at the mutually contacting surface part (abutting part) n between the charge roller 2 and the photosensitive member 1, thereby allowing good direct injection-based charging. As a result, good images can be obtained in a stable manner.

In this embodiment, the charge roller 2 is rotatively driven in the direction opposite to the moving direction of the surface of the photosensitive member 1. Consequently, the transfer-residual toner particles on the photosensitive member 1 that are brought to the charging part n are temporarily collected by the charge roller 2 to level or uniformize the density of the transfer-residual toner particles that are present at the charging part n. Thus, it becomes possible to prevent faulty charging due to localization of the transfer-residual toner particles at the charge abutting part. It is therefore possible to provide stabler charging properties.

By rotating the charge roller 2 in a reverse direction, the charging is performed while releasing the transfer-residual toner particles from the photosensitive member 1. This allows direct injection-based charging in an advantageous manner. Furthermore, deterioration in the charging properties of the image-bearing member due to excessive falling of the conductive fine powder m from the charge roller 2 can be prevented.

(3) Evaluations

In the Examples, formation of images was tested at 23° C,, 60% relative humidity.

More specifically, a toner cartridge was charged with 150 g of magnetic developer 1. Images were printed continuously on 5,000 sheets in which images account for 5% of the sheet until the amount of the developer in the toner cartridge became small. Copy paper (A4) of 75 g/m² was used as a transfer material.

No deterioration in developability was found.

After the 5,000-sheet continuous printing, the abutting parts n on the charge roller 2 contacting with the photosensitive member 1 were observed. As a result, the abutting parts were almost covered with the white conductive fine powder B-1 though a minute amount of transfer-residual toner particles were found. The amount of the particulates thereon was about 3×10⁵ particles/mm².

No defects of images due to the faulty charging were found even after the 5,000-sheet continuous printing, in the presence of the conductive fine powder B-1 at the abutting parts n between the photosensitive member 1 and the charge roller 2. Good direct injection charging properties were obtained. The reason is presumed to be that the conductive fine powder B-1 has a sufficiently low resistivity.

The potential of the photosensitive member after the 5,000-sheet continuous printing made by using the direct injection-based charging was −690 V relative to the applied charge bias of −700 V. Reduction in charging properties from the beginning was as small as −10 V. No degradation in image quality was found which otherwise would be caused by poor charging properties. A possible reason for this is considered to be for a successful direct injection-based charging that yields good charging properties after the 5,000-sheet continuous printing because a sharp and clear image can be achieved while maintaining an electrostatic latent image, owing to the photosensitive member as the image-bearing member whose outermost layer has a volume resistivity of 5×10¹² Ω·cm (obtained in the photosensitive member production example 1).

Furthermore, the transfer efficiency was significantly good even after the 5,000-sheet continuous printing. Taking into account the fact that only minute amount of transfer-residual toner particles were left on the photosensitive member after the transfer, it can be concluded that good collectability of the transfer-residual toner particles was obtained in the developing step, from less fog on the image and less transfer-residual toner particles on the charge roller 2 after the 5,000-sheet continuous printing. It is noted that the photosensitive member obtained in the photosensitive member production example 1 had a image-bearing member with a surface contact angle to water of 103 degrees, and this nature may partly be responsible for the above effects.

The photosensitive member received only slight damages in its surface even after the 5,000-sheet continuous printing. Defects of images corresponding to the damage of the photosensitive member was thus at a certain level that can be practically tolerated.

Evaluations were made for the printed images and the results are given in Table 6.

(a) Image Density.

After completing continuous printing on 5,000 sheets, the apparatus was left standing for 2 days and the power was then turned on, measuring the image density with respect to an image formed on a first sheet of printing. The image density was measured by using a Macbeth Reflection Densitometer as a relative image density to a white ground portion corresponding to an image density of 0.00 on the original. The results are given in Table 6 below. These results in Table 6 are recorded according to the following standard.

A: Very good. Sufficient for expressing even a graphic image at a high quality. (1.40 or more)

B: Good. Sufficient for expressing a non-graphic image at a high quality. (1.35 or more and less than 1.40)

C: Fair. Image density which is permissible as being sufficient to recognize character images. (1.20 or more and less than 1.35)

D: Image density generally not permissible because of low density. (1.20<)

(b) Fog

After completing continuous printing on 5,000 sheets, the whiteness of a white ground portion of a printed image on a transfer paper and the whiteness of the transfer paper before printing were measured by a reflectometer (available from Tokyo Denshoku). From the difference between the two whiteness values, fog (%) was calculated. The results are given in Table 6 below. These results in Table 6 are recorded according to the following standard.

A: Very good. Fog, if any, at a level generally not recognizable with naked eyes. (less than 1.5%)

B: Good. Fog at a level not recognized unless carefully observed. (1.5% or more and less than 2.5%)

C: Fair. Fog easily recognizable but generally permissible. (2.5% or more and less than 4.0%)

D: Poor. Fog generally recognized as stained images and not permissible. (4% or more)

(c) Transferability

After continuous printing on 5,000 sheets, transfer-residual toner particles on the photosensitive member were peeled off with a polyester adhesive tape (Mylar tape), and the tape was applied on a white paper. A polyester adhesive tape before use was applied on the white paper as a control. The transferability was evaluated based on the difference in Macbeth reflection density between the two adhesive tapes according to the following standard.

A: Very good (less than 0.05)

B: Good (0.05 or more and less than 0.1)

C: Fair (0.1 or more and less than 0.2)

D: Poor (0.2 or more)

(d) Charging Properties of Photosensitive Member

A sensor was disposed at a position of development to measure a surface potential on the photosensitive member after uniform charging at the initial stage and on completion of 5,000-sheet printing. The difference in the surface potential is calculated and listed in Table 6. The larger the negative value is, the larger the deterioration in charging properties is.

(e) Insufficient Pattern Collection

A vertical-line pattern (comprised of the repetition of a two-dot and 98-space vertical line) was continually printed. Then a halftone image (comprised of the repetition of a two-dot and three space lateral line) was printed. Thereafter, visual evaluation was made on whether shading corresponding to the vertical-line pattern occurred on the halftone image. The results are shown in Table 6 according to the following standard.

A: Very good (no occurrence).

B: Good (Slight shading occurred, but no effect on the halftone image).

C: Fair (shading occurred at a certain level which is practically permissible).

D: Poor (Conspicuous shading occurred at a non-permissible level).

(f) Stained Image

Fixed images were visually inspected and evaluated according to the following standard.

A: Not recognizable.

B: Slightly recognized but influence on the image is very slight.

C: Recognized to some extent but at a practically permissible level.

D: Conspicuously stained image, not permissible.

The results of evaluation on the above items are inclusively shown in Table 6 along with those of the following Examples.

### EXAMPLE 21

Evaluation was made in the same way as in Example 20 except that the movement speed of the surface of the image-bearing member (process speed) was increased from 120 mm/sec to 180 mm/sec and the movement speed of the surface of the charge roller 2 was decreased from 120 mm/sec to 90 mm/sec (i.e., a relative surface speed ratio with respect to the photosensitive member 1 was changed from −200% to −150%). The results are given in Table 6. Insufficient collection and stained images were slightly observed, which were not observed when the process speed was 120 mm/sec and the relative surface speed was −200%. Deterioration in the charging properties of the image-bearing member was varied from −20V to −30V, after the 5,000-sheet continuous printing. The charging properties tended to deteriorate under the conditions of the process speed of 180 mm/sec and the surface speed difference of −150% between the charge roller 2 and the photosensitive member 1, adversely affecting the collectability of the transfer-residual toner particles. This is presumed to result from the following.

A higher process speed is generally liable to result in deterioration in collectability of the transfer-residual toner particles in the cleaning-at-development step. The reason is deemed to be that since the process speed comes to be higher, the transfer-residual toner particles are liable to be unevenly charged in primary charging; it tends to become hard to eliminate the influence of the collected transfer-residual toner particles on the triboelectric charging properties of developer. This tendency is particularly noticeable in the non-contact developing system. The reason for this is presumed to be that in collection of the transfer-residual toner particles, electrostatic force more effectively acts because of the contact between the developer-carrying member and the image-bearing member, and physical force due to friction acts, so that deterioration in collectability of the transfer-residual toner particles caused by a process speed increase can be easily compensated for.

The charging properties of the direct injection-based charging may also be reduced at a higher process speed. This is presumably because of lowering in probability of the contact between the image-bearing member and the contact charging member via the conductive fine powder or reduction in charging time for charging the image-bearing member by charge injection. When the relative movement speed of the charging member is retained or increased in conjunction with an increased process speed so as to maintain the probability of contact, the torque is increased significantly. This results in increase in operation cost and other problems such as damages on the image-bearing member and the charging member, and pollution in the apparatus due to the scattering of the transfer-residual toner particles attached to the charging member.

### EXAMPLES 22 TO 24

### EVALUATION OF PHOTOSENSITIVE MEMBER

Example 21 was repeated for the evaluation of the photosensitive members, except that the photosensitive members, which were obtained in the photosensitive member production examples 2 to 4, were used in place of the photosensitive member of the Example 21 (obtained in the photosensitive member production example 1). The results are given in Table 6.

When compared with Example 21, in Example 22 using the photosensitive member produced in the photosensitive member production example 2, good images were obtained shile being a little inferior in transferability.

When compared with Example 21, in Example 23 using the photosensitive member produced in the photosensitive member production example 3, good properties and performances were shown while being a little inferior in sharpness of contour of the toner image.

When compared with Example 21, in Example 24 using the photosensitive member produced in the photosensitive member production example 4, charging efficiency was poor from the beginning, and the surface potential of the photosensitive member was reduced from −700V (applied charge bias) to −660 V (after the charging).

### EXAMPLES 25 AND 26

### EVALUATION OF CHARGING MEMBERS

Example 21 was repeated for the evaluation of the photosensitive members, except that the charging member, which was obtained in the charging member production example 2 or 3, was used in place of the charging member of the Example 21 (obtained in the charging member production example 1). The results are given in Table 6.

Example 25 using the charge roller produced in the charging member production example 2 produced good images though the amount of the conductive fine powder was slightly smaller at the abutting part between the photosensitive member and the contact charging member, and the charging properties of the image-bearing member was inferior, as compared with the Example 21.

In Example 26 using the charge roller produced in the charging member production example 3, a significantly smaller amount of the conductive fine powder was present at the abutting part between the photosensitive member and the contact charging member and the fog was increasingly produced as the charging properties of the image-bearing member deteriorated after continuous printing, as compared with the Example 22.

### EXAMPLE 27 TO 29

### EVALUATION OF MAGNETIC DEVELOPERS 2 TO 4

Example 21 was repeated for evaluation except that the magnetic developer 1 used in the Example 1 was replaced by the magnetic developers 2 to 4 shown in Table 5. The results are given in Table 6.

Example 27 using the magnetic developer 2 was superior in uniformity of charging of the image-bearing member as compared with the Example 22. No deterioration in image density was found, and no fog was found. Example 28 using the magnetic developer 3 was inferior in transferability and collectability of the transfer-residual toner particles as the charge of the developer decreased. A problem of pattern ghost was slightly observed.

Example 29 using the magnetic developer 4 was inferior to the Example 28 in transferability and collectability of the transfer-residual toner particles as the charge of the developer decreased. Pattern ghost was slightly cleared an allowable level due to the insufficient collection of the transfer-residual toner particles, after the 5,000-sheet printing. The charge roller after the 5,000-sheet printing had many toner particles attached thereon.

### EXAMPLES 30 to 33

### EVALUATION MAGNETIC DEVELOPERS 5 to 8

Example 21 was repeated for evaluation except that the magnetic developer 1 used in the Example 21 was replaced by the magnetic developers 5 to 8 shown in Table 5. The results are given in Table 6.

Example 30 using the magnetic developer 5 was inferior to the Example 21. It produced rather much fog from the initial step. The charging properties of the image-bearing member was deteriorated to a relatively larger degree after the 5,000-sheet continuous printing. However, the resulting images were good in general.

Examples 31 and 32 using the magnetic developers 6 and 7, respectively, provide good charging properties of the image-bearing member as well as good collectability of the transfer-residual toner particles.

Example 33 using the magnetic developer 8 produced slight fog due to the obstruction of the image exposure. Besides, the resulting images were good in general.

### COMPARATIVE EXAMPLE 10

### EVALUATION OF MAGNETIC DEVELOPER 9

Example 21 was repeated for evaluation except that the magnetic developer 1 used in the Example 21 was replaced by the magnetic developer 9 shown in Table 5. The results are given in Table 6.

Comparative example 10 using the magnetic developer 9 was inferior to the Example 21 in image density from the initial step. The image density was low after the 5,000-sheet printing and the image quality was intolerable.

### EXAMPLES 34 AND 35

### EVALUATION OF MAGNETIC DEVELOPERS 10 AND 11

Example 21 was repeated for evaluation except that the magnetic developer 1 used in the Example 21 was replaced by the magnetic developers 10 and 11 shown in Table 5. The results are given in Table 6.

Examples 34 and 35 using the magnetic developers 10 and 11, respectively, were superior to the Example 21 in charging properties of the image-bearing member as well as collectability of the transfer-residual toner particles. However, the Example 34 using the magnetic developer 10 produced slightly much fog after continuous printing of 100 sheets.

### COMPARATIVE EXAMPLE 11

### EVALUATION OF MAGNETIC DEVELOPER 12

Example 21 was repeated for evaluation except that the magnetic developer 1 used in the Example 21 was replaced by the magnetic developer 12 shown in Table 5. The results are given in Table 6.

Comparative example 11 using the magnetic developer 12 was suffered from remarkable deterioration in charging properties of the image-bearing member after the 5,000-sheet continuous printing, as compared with the Example 21. This example was inferior in collectability of the transfer-residual toner particles. The level of insufficient collection was unacceptable and the image quality was intolerable.

### COMPARATIVE EXAMPLES 12 AND 13

### EVALUATION OF MAGNETIC DEVELOPERS 13 AND 14

Example 21 was repeated for testing the formation of images, except that the magnetic developer 1 used in the Example 21 was replaced by the magnetic developers 13 and 14 shown in Table 5. The results are given in Table 6.

Comparative examples 12 and 13 using the magnetic developers 13 and 14 were inferior to the Example 21 as apparent from Table 6, in charging properties of the image-bearing member and collectability of the transfer-residual toner particles.

### COMPARATIVE EXAMPLES 14 TO 16

### EVALUATION OF MAGNETIC DEVELOPERS 15 TO 17

Example 21 was repeated for evaluation except that the magnetic developer 1 used in the Example 21 was replaced by the magnetic developers 15 to 17 shown in Table 5. The results are given in Table 6.

Comparative examples 14 and 15 using the magnetic developers 15 and 16 produced much fog from the initial step as compared with the Example 21. After completion of the 5,000-sheet continuous printing, the surface of the charging member had many transfer-residual toner particles attached thereon. There were noticeably smaller amount of the conductive fine powder at the abutting part between the charging member and the image-bearing member. The charging properties of the image-bearing member were deteriorated significantly.

Comparative example 16 using the magnetic developer 17 had a low image density from the initial step, was inferior in transferability, and had much fog. Faulty charging occurred in the image-bearing member at or around 1,000-sheet continuous printing. The printing operation was terminated.

### COMPARATIVE EXAMPLE 17

### EVALUATION OF MAGNETIC DEVELOPER 18

Example 21 was repeated for evaluation except that the magnetic developer 1 used in the Example 21 was replaced by the magnetic developer 18 shown in Table 5. The results are given in Table 6.

Comparative example 17 using the magnetic developer 18 was suffered from significant faulty charging of the image-bearing member at or around 100-sheet continuous printing. The transfer-residual toner particles were attached on the surface of the charging member. No further evaluation could be made.

### EXAMPLES 36 TO 39

### EVALUATION OF MAGNETIC DEVELOPERS 19 TO 22

Example 21 was repeated for evaluation except that the magnetic developer 1 used in the Example 21 was replaced by the magnetic developers 19 to 22 shown in Table 5. The results are given in Table 6.

Example 36 using the magnetic developer 19 was inferior in transferability from the initial step, and had much fog. The charging properties of the image-bearing member were slightly significantly deteriorated after the 5,000-sheet continuous printing. A large amount of transfer-residual toner particles were attached on the surface of the charging member. However, the resulting images were generally good.

Example 37 using the magnetic developer 20 was superior to the Example 36 in both transferability and fog. However, it was inferior to the Example 21 in deterioration of the charging properties of the image-bearing member and insufficient collection of patterns.

Examples 38 and 39 using the magnetic developers 21 and 22, respectively, was inferior to the Example 21 because of rather significant deterioration of the charging properties of the image-bearing member after the 5,000-sheet continuous printing. The surface of the charging member had a large amount of transfer-residual toner particles attached thereon. Besides, the resulting images were generally good.

### EXAMPLES 40 AND 41

### EVALUATION OF MAGNETIC DEVELOPERS 23 AND 24

Example 21 was repeated for evaluation except that the magnetic developer 1 used in the Example 21 was replaced by the magnetic developers 23 and 24 shown in Table 5. The results are given in Table 6.

Example 40 using the magnetic developer 23 had slightly less fog from the initial step, and had less or no deterioration in charging properties of the image-bearing member after the 5,000-sheet continuous printing. Good images were obtained accordingly.

Example 41 using the magnetic developer 24 had less fog from the initial step as compared with the Example 21, and had less or no deterioration in charging properties of the image-bearing member after the 5,000-sheet continuous printing. Good images were obtained accordingly. These images had good charging property and collectability of the transfer-residual toner particles.

### EXAMPLE 42

### EVALUATION OF IMAGE FORMING METHOD PERFORMED BY USING NON-MAGNETIC DEVELOPER 25 AND CHARGING BRUSH OBTAINED IN CHARGING MEMBER PRODUCTION EXAMPLE 4

FIG. 2 is a schematic view of another image forming apparatus used in Examples of the present invention.

This image forming apparatus is a laser printer (recording apparatus) that uses a cleaning-at-development process involving a transfer electrophotographic process. It comprises no cleaning unit. Instead, it comprises a small process cartridge achieved by using a drum-shaped photosensitive member having a small diameter. The process cartridge is detachably attachable on the image forming apparatus. As the developer, the non-magnetic one-component developer 25 is used. This image forming apparatus achieves non-contact development in which the developer layer on the developer-carrying member is away from the image-bearing member without any contact.

(1) Configuration of Image Forming Apparatus

The image forming apparatus comprises a rotating 24-mm diameter drum-type OPC photosensitive member 21 (obtained in the photosensitive member production example 1) that serves as an image-bearing member. The photosensitive member 21 is rotation-driven in the clockwise direction indicated by an arrow at a peripheral velocity of 60 mm/sec (process speed is variable in the range of 60 to 150 mm/sec.).

A conductive brush roller 22 (obtained in the charge member production example 4 and hereinafter referred to as a “charging brush”) that serves as the contact charging member. The charging brush 22 is rotated at a peripheral speed rate of 150% relative to the surface speed of the photosensitive member at the charge abutting part n between the charging brush 22 and the photosensitive member 21. In this event, the charging brush 22 moves in the opposite direction to the photosensitive member 21. The charge brush 22 has a core metal 22a to which a DC voltage of −700 V is applied as a charge bias from a charge bias voltage supply S1 in the presence of the conductive fine powder (the conductive fine powder B-3 contained in the developer 7) at the charge abutting part n. The surface of the photosensitive member 21 is thus uniformly charged by means of the direct injection-based charging. The photosensitive member 21 has a surface potential of −680V after the uniform charging.

The image forming apparatus also comprises a laser beam scanner 23 that serves as the latent image forming means. The laser beam scanner produces laser light beams whose intensity is modified corresponding to a time-series electrical digital image signal of target image information and scanning-exposes the uniformly charged surface of the photosensitive member 21 with laser beams. This scanning-exposure forms an electrostatic latent image corresponding to the target image information on the surface of the photosensitive member 21.

The image forming apparatus further comprises a developing device 24, by which the electrostatic latent image on the surface of the photosensitive member 21 is developed to form a toner image thereon.

The developing device 24 is a non-contact reversal developing device which comprises a negatively chargeable one-component insulating developer using a non-magnetic developer 25 that is obtained by externally adding the inorganic fine powder A-4 and the conductive fine powder B-1 to the toner particles 4 obtained in the toner particles production example 4.

The developing device 24 has a developing roller 24a that serves as a developer carrying member. The developing roller is formed of a medium resistivity rubber roller having a diameter of 16 mm in which carbon black is dispersed. The developer-carrying member 24a is placed opposite to the photosensitive member 21 with a gap length of 300 μm.

The developer-carrying member 24a is rotated at a speed of 150% relative to the rotating surface speed of the photosensitive member 21 in the same direction as the developer-carrying member 24a moves. More specifically, the movement speed of the surface of the developer-carrying member 24a is 90 mm/s. The speed relative to the surface of the photosensitive member 21 is 30 mm/s.

A coating roller 24b is provided at a developing area to apply the developer to the developer-carrying member 24a. The coating roller 24b is abutted against the developer-carrying member 24a. At the contact point between the developer-carrying member 24a and the coating roller 24b, the surface of the coating roller 24b moves in the direction opposite to the moving direction (rotation direction) of the surface of the developer-carrying member 24a (the identical rotation direction). In this way, the developer is applied to the developer-carrying member 24a. The coating roller 24b is comprised of a core metal to which a bias is applied, and an elastic layer having a medium resistivity formed on the core metal, and has a resistivity of 10³ to 10⁸ Ω·cm. (The resistivity of the coating roller 24b can be measured as in the case of the charge roller.) The surface potential of the coating roller 24b is so controlled as to be −500V by applying the bias to the coating roller 24b, which is preferable to control the supply and removal of the developer.

In order to control a coat layer of the developer on the developer-carrying member 24a, a non-magnetic blade formed by bending SUS 316 (a developer restricting member 24c) into an L shape is abutted on the developer-carrying member 24a.

The developer that is housed in a developing device 24 is applied to the developing roller 24a that serves as the developer-carrying member by means of the developer coating roller 24b and a coating blade 24c. The developer receives charges accordingly. The amount of the developer coated on the developing roller 24a was 9 g/m².

The developer applied to the developing roller 24a is conveyed along with the rotation of the developing roller 24a to the developing unit where the photosensitive member 21 and the developing roller 24a are opposite to each other.

A development bias voltage is applied to the developing roller 24a from a development bias voltage source S2. The development bias voltage is produced by superposing −440 V DC voltage and a rectangular AC voltage having a frequency of 2,000 Hz and a peak-to-peak voltage of 1,800 V (electric field intensity of 6.0×10⁶ V/m). The development bias voltage is used to effect non-magnetic one-component jumping development between the developing roller 24a and the photosensitive member 21.

The image forming apparatus further comprises a medium resistivity transfer roller 25 (roller resistivity of 5×10⁸ Ω·cm) that serves as a contact transferring means. The transfer roller 25 is brought into pressure-contact with the photosensitive member 21 at a linear pressure of 98 N/m to form a transfer nip. To the transfer nip, a transfer material P as a recording medium is supplied. A DC voltage of 2,800 V is applied to the transfer roller 25 as a transfer bias voltage from a transfer bias voltage source S3, whereby toner images on the photosensitive member 21 are successively transferred onto the surface of the transfer material P supplied to the transfer nip. Thus, the transfer material P introduced to the transfer nip is nipped and conveyed through the transfer P, and on its surface, the toner images formed on the surface of the photosensitive member 21 are successively transferred by the aid of electrostatic force and pressing force.

A fixing device 26 of a heat fixing type is provided. In the fixing-device 26, a toner image on the transfer material is heated from a planar heat-generating member 26a via a heat-resistant endless belt 26b while receiving a pressure from a pressure roller 26c. The image is thus fixed under heat and pressure. The transfer material P having received a toner image from the photosensitive member 21 at the transfer nip is separated from the surface of the photosensitive member 21 and introduced into the fixing device 26, where the toner image is fixed and discharged out of the apparatus as an image product (print or copy). The transfer materials with the toner image is then conveyed out of the apparatus.

With the printer according to this embodiment, the transfer-residual toner particles remaining on the surface of the photosensitive member 21 after the transfer of the toner-based image onto the transfer material P are not removed by a cleaner. They travel via the charging part and reach the developing unit along with the rotation of the photosensitive member 21. The developer is subjected to a cleaning-at-development operation (collection) in the developing device 24.

The reference numeral 27 denotes a process cartridge that can be freely mounted on and detached from the printer. In the printer of this embodiment, three process components, i.e., the photosensitive member 21 (the image-bearing member), the charging brush 22 (the contact charging member), and the developing device 24 are integrally supported to form a process cartridge that can be freely mounted on and detached from the printer via a mounting-detaching guide/retention member 28.

(2) Evaluations

In the Examples, formation of images was conducted at 23° C., 60% relative humidity. More specifically, 100 g of non-magnetic developer 25 was replenished in a toner cartridge. Images with 5% coverage were printed continuously on 5,000 sheets until the developer was consumed in the toner cartridge.

No deterioration of image density was found both initially and after the 5,000-sheet continuous printing, on both the image of just after the printing and 2 days later.

After the 5,000-sheet continuous printing, abutting parts on the charging brush 22 with the photosensitive member 21 was observed. As a result, the abutting parts were covered with the conductive fine powder B-1 though a minute amount of transfer-residual toner particles was found.

No defect of images due to the faulty charging was found both initially and after the 5,000-sheet continuous printing, in the presence of the conductive fine powder B-1 at the abutting part between the photosensitive member 21 and the charging brush 22 because the conductive fine powder B-1 has a significantly low resistivity. Good direct injection charging properties were obtained.

Furthermore, since the photosensitive member obtained in the photosensitive member production example 1 was used, the transfer efficiency was significantly good both initially and after the 5,000-sheet continuous printing. Taking the fact into account that only small amount of transfer-residual toner particles was left on the photosensitive member after the transfer, it can be concluded that good collectability of the transfer-residual toner particles was obtained in the developing device because of less fog in the non-image area and less transfer-residual toner particles on the charging brush 22 after the 5,000-sheet continuous printing.

The results are given in Table 6.

### EXAMPLE 43

The evaluation of the Example 42 was repeated except that the movement speed of the surface of the image-bearing member (process speed) was increased from 60 mm/sec to 120 mm/sec and the peripheral speed ratio of the surface of the charging brush 22 with respect to the photosensitive member 21 was changed from −150% to −133%. The results are given in Table 6. As the movement speed of the image-bearing member was increased, the insufficient collection and the image staining were slightly observed, which were not observed when the process speed was 60 mm/sec and the relative peripheral speed was −150%. Deterioration of the charging properties of the image-bearing member was varied from −20V to −40V, after the 5,000-sheet continuous printing. The charging properties of the image-bearing member was deteriorated under the conditions that the process speed was increased and that the peripheral speed ratio was set at −133% between the charging brush 22 and the photosensitive member 21, and the collectability of the transfer-residual toner particles tended to lower.

### EXAMPLES 44 AND 45

### EVALUATION OF NON-MAGNETIC DEVELOPERS 26 AND 27

The Example 43 was repeated for the evaluation of the developers, except that the non-magnetic developer 26 or 27 in Table 5 was used in place of the non-magnetic developer 25. The results are given in Table 6.

Example 44 using the non-magnetic developer 26 provided good images without any defect. The charging properties of the image-bearing member and collectability of the transfer-residual toner particles were superior. The amount of the transfer-residual toner particles was smaller than that of the Example 43.

Example 45 using the non-magnetic developer 27 was much superior to the above-mentioned Example 43 in charging properties of the image-bearing member and collectability of the transfer-residual toner particles. Images obtained were good and had no defect.

### COMPARATIVE EXAMPLE 18

### EVALUATION OF NON-MAGNETIC DEVELOPER 28

The Example 43 was repeated for the evaluation of the developers, except that the non-magnetic developer 28 in Table 5 was used in place of the non-magnetic developer 25. The results are given in Table 6.

Comparative Example 18 using the non-magnetic developer 28 was slightly inferior to the Example 43 in image density from the initial stage. The image density was low after the 5,000-sheet continuous printing and fog was increased to a large extent, producing images with lower resolution.

TABLE 6

| | | | | | | | | | | | | Image |
|---|---|---|---|---|---|---|---|---|---|---|---|---|
| | | | | | | | | | | | Insufficient | staining |
| | | | | Image density | | Fog | | Transfer efficiency | | | pattern | after |
| | Image-Bearing member | | | Initial | after 5,000 | Initial | after 5,000 | Initial | after 5,000 | Charging properties | collection | 5,000 |
| | (photosensitive member) | Contact charging member | Developer | step | pages | step | pages | step | pages | ΔV after 5,000 pages | after 5,000 pages | pages |
| Example 20 | Production example 1 | Production example 1 | Production example 1 | A | A | A | A | B | B | −20 | A | A |
| Example 21 | Production example 1 | Production example 1 | Production example 1 | A | A | A | A | B | B | −30 | B | B |
| Example 22 | Production example 2 | Production example 1 | Production example 1 | A | A | A | B | C | C | −30 | C | C |
| Example 23 | Production example 3 | Production example 1 | Production example 1 | A | A | B | A | B | B | −30 | B | B |
| Example 24 | Production example 4 | Production example 1 | Production example 1 | A | A | B | C | C | C | −40 | C | C |
| Example 25 | Production example 1 | Production example 2 | Production example 1 | A | A | A | B | B | B | −40 | B | B |
| Example 26 | Production example 1 | Production example 3 | Production example 1 | A | A | B | C | B | B | −50 | C | C |
| Example 27 | Production example 1 | Production example 1 | Production example 2 | A | A | A | A | B | B | −20 | B | B |
| Example 28 | Production example 1 | Production example 1 | Production example 3 | B | A | A | A | B | B | −10 | B | C |
| Example 29 | Production example 1 | Production example 1 | Production example 4 | B | C | B | B | B | B | −20 | B | C |
| Example 30 | Production example 1 | Production example 1 | Production example 5 | A | A | A | A | B | B | −30 | B | B |
| Example 31 | Production example 1 | Production example 1 | Production example 6 | A | A | A | A | B | B | −10 | A | B |
| Example 32 | Production example 1 | Production example 1 | Production example 7 | A | A | A | A | B | B | −10 | A | B |
| Example 33 | Production example 1 | Production example 1 | Production example 8 | B | B | B | A | B | B | −20 | B | C |
| Example 34 | Production example 1 | Production example 1 | Production example 10 | B | A | B | C | B | B | −40 | B | B |
| Example 35 | Production example 1 | Production example 1 | Production example 11 | A | A | A | B | B | B | −10 | A | A |
| Example 36 | Production example 1 | Production example 1 | Production example 19 | B | C | A | A | C | C | −30 | B | B |
| Example 37 | Production example 1 | Production example 1 | Production example 20 | C | C | B | A | C | C | −30 | B | B |
| Example 38 | Production example 1 | Production example 1 | Production example 21 | A | A | A | A | B | B | −30 | B | B |
| Example 39 | Production example 1 | Production example 1 | Production example 22 | B | B | A | A | C | C | −30 | B | B |
| Example 40 | Production example 1 | Production example 1 | Production example 23 | A | A | A | B | A | A | −20 | A | B |
| Example 41 | Production example 1 | Production example 4 | Production example 24 | A | A | A | A | A | A | −10 | A | A |
| Example 42 | Production example 1 | Production example 4 | Production example 25 | B | B | A | A | B | B | −20 | A | A |
| Example 43 | Production example 1 | Production example 4 | Production example 25 | B | B | A | B | B | B | −40 | B | B |
| Example 44 | Production example 1 | Production example 4 | Production example 26 | A | A | A | B | A | A | −30 | A | B |
| Example 45 | Production example 1 | Production example 4 | Production example 27 | A | A | A | A | A | A | −20 | A | A |
| Comparative example 10 | Production example 1 | Production example 1 | Production example 9 | D | C | B | C | C | C | −70 | C | D |
| Comparative example 11 | Production example 1 | Production example 1 | Production example 12 | A | A | A | A | C | C | −120 | D | C |
| Comparative example 12 | Production example 1 | Production example 1 | Production example 13 | B | B | A | A | B | B | −70 | C | D |
| Comparative example 13 | Production example 1 | Production example 1 | Production example 14 | B | C | B | A | B | B | −60 | C | C |
| Comparative example 14 | Production example 1 | Production example 1 | Production example 15 | D | C | B | D | C | D | −30 | D | D |
| Comparative example 15 | Production example 1 | Production example 1 | Production example 16 | C | D | B | B | D | D | −60 | D | D |
| Comparative example 16 | Production example 1 | Production example 1 | Production example 17 | D | D | B | D | D | D | −40 | D | D |
| Comparative example 17 | Production example 1 | Production example 1 | Production example 18 | A | B | A | A | C | C | −150 | D | C |
| Comparative example 18 | Production example 1 | Production example 1 | Production example 28 | C | D | C | B | D | D | −60 | D | D |

What is claimed is:

1. A developer comprising at least:
(i) toner particles containing at least a binder resin and a colorant;
(ii) an inorganic fine powder whose primary particles have a number-average particle diameter of from 4 nm to 50 nm; and
(iii) a conductive fine powder whose primary particles have a number-average particle diameter of from 50 nm to 500 nm, the conductive fine powder containing an agglomerated matter of the primary particles,
wherein the developer comprises 15% to 60% by number of particles having particle diameters in the range of from 1.00 μm, inclusive, to 2.00 μm, exclusive, and comprises 15% to 70% by number of particles having particle diameters in the range of from 3.00 μm, inclusive, to 8.96 μm, exclusive, in number-based particle size distribution of particles having particle diameters in the range of from 0.60 μm, inclusive, to 159.21 μm, exclusive.

2. The developer according to claim 1, wherein the developer comprises 0% to 20% by number of particles having a particle diameter of 8.96 μm or larger.

3. The developer according to claim 1, wherein the developer comprises 20% to 40% by number of particles having particle diameters in the range of from 1.00 μm, inclusive, to 2.00 μm, exclusive.

4. The developer according to claim 1, wherein the developer satisfies the relationship: A>2B wherein A represents the amount in percent by number of particles having particle diameters in the range of from 1.00 μm, inclusive, to 2.00 μm, exclusive, that are contained in the developer, and B represents the amount in percent by number of particles having particle diameters in the range of from 2.00 μm, inclusive, to 3.00 μm, exclusive, that are contained in the developer.

5. The developer according to claim 1, wherein a variation coefficient of number distribution Kₙ is 5 to 40 over the particle diameter range of from 3.00 μm, inclusive, to 15.04 μm, exclusive, the variation coefficient of number distribution Kₙ being given by the following equation:
Kₙ=(Sₙ/D1)×100
wherein, Sₙ is a standard deviation of number distribution of particles having particle diameters in the range of from 3.00 μm, inclusive, to 15.04 μm, exclusive, and D1 is a number-based average circle-corresponding diameter (μm) of particles having particle diameters in the range of from 3.00 μm, inclusive, to 15.04 μm, exclusive.

6. The developer according to claim 1, wherein the developer comprises 90% to 100% by number of particles having a circularity (a) of at least 0.90 in the particle diameter range of from 3.00 μm, inclusive, to 15.04 μm, exclusive, the circularity (a) being given by the following equation:
(a)=L₀/L
wherein L₀ represents a circumferential length of a circle having an area identical to that of the particle projection image, and L represents a circumferential length of a particle projection image.

7. The developer according to claim 1, wherein the developer comprises 93% to 100% by number of particles having a circularity (a) of at least 0.90 in the particle diameter range of from 3.00 μm, inclusive, to 15.04 μm, exclusive.

8. The developer according to claim 1, wherein the developer has a standard deviation SD of circularity distribution of not larger than 0.045 in the particle diameter range of from 3.00 μm, inclusive, to 15.04 μm, exclusive, the standard deviation SD of circularity distribution being given by the following equation:
SD={Σ(a₁−aₘ)²/n}^{1/2}
wherein, aᵢ represents a circularity of each particle in the particle diameter range of from 3.00 μm, inclusive, to 15.04 μm, exclusive, aₘ represents an average circularity of the particles in the particle diameter range of from 3.00 μm, inclusive, to 15.04 μm, and n represents the number of total particles in the particle diameter range of from 3.00 μm, inclusive, to 15.04 μm, exclusive.

9. The developer according to claim 1, wherein the conductive fine powder having a particle diameter of 0.6 to 3 μm is contained in the number of 5 to 300 particles per 100 toner particles.

10. The developer according to claim 1, wherein the content of the conductive fine powder in the developer is 1% to 10% by weight, relative to the total components of the developer.

11. The developer according to claim 1, wherein the conductive fine powder has a resistivity of not higher than 10⁹ Ω·cm.

12. The developer according to claim 1, wherein the conductive fine powder has a resistivity of not higher than 10⁶ Ω·cm.

13. The developer according to claim 1, wherein the conductive fine powder is a non-magnetic conductive fine powder.

14. The developer according to claim 1, wherein the conductive fine powder contains at least one oxide selected from zinc oxide, tin oxide, and titanium oxide.

15. The developer according to claim 1, wherein the content of the inorganic fine powder in the developer is 0.1 to 3.0% by weight, relative to the total weight of the developer.

16. The developer according to claim 1, wherein the inorganic fine powder is treated with at least a silicone oil.

17. The developer according to claim 1, wherein the inorganic fine powder is treated with a silicone oil upon or after the treatment with at least a silane compound.

18. The developer according to claim 1, wherein the inorganic fine powder include at least one compound selected from silica, titania and alumina.

19. The developer according to claim 1, wherein the developer is a magnetic developer with magnetization intensity of 10 to 40 Am²/kg in the magnetic field of 79.6 kA/m.

20. An image forming method comprising a repeated cycle of the following steps to form an image:
a charging step for charging electrostatically an image-bearing member;
a latent image forming step for writing image information as an electrostatic latent image on a charged surface of the image-bearing member that is charged in the charging step;
a developing step for visualizing the electrostatic latent image as a toner image with a developer; and
a transferring step for transferring the toner image to a transfer material,
the developer comprising at least:
(i) toner particles containing at least a binder resin and a colorant;
(ii) an inorganic fine powder whose primary particles have a number-average particle diameter of from 4 nm to 50 nm; and
(iii) a conductive fine powder whose primary particles have a number-average particle diameter of from 50 nm to 500 nm, the conductive fine powder containing an agglomerated matter of the primary particles,
the developer comprising 15% to 60% by number of particles having particle diameters in the range of from 1.00 μm, inclusive, to 2.00 μm, exclusive, and comprising 15% to 70% by number of particles having particle diameters in the range of from 3.00 μm, inclusive, to 8.96 μm, exclusive, in number-based particle size distribution of particles having particle diameters in the range of from 0.60 μm, inclusive, to 159.21 μm, exclusive,
wherein the charging step is a step of charging electrostatically the image-bearing member by means of applying a voltage to a charging member in the presence of a component of the developer that contains at least the conductive fine powder at a position where the image-bearing member abuts the charging member that is in contact with the image-bearing member.

21. The image forming method according to claim 20, wherein a proportion of the conductive fine powder contained in the developer relative to the total components of the developer in the abutting part is higher than a proportion of the conductive fine powder contained in the developer, in the charging step.

22. The image forming method according to claim 20, wherein the developing step is a step of visualizing the electrostatic latent image and collecting the developer that remains on the surface of the image-bearing member after the transfer of the toner image to the transfer material.

23. The image forming method according to claim 20, wherein a relative speed difference is provided between a movement speed on the surface of the charging member and a movement speed on the surface of the image-bearing member.

24. The image forming method according to claim 20, wherein the charging member and the image-bearing member move in opposite directions on their opposing surfaces.

25. The image forming method according to claim 20, wherein the charging step is a step of charging electrostatically the image-bearing member by means of applying a voltage to a roller member at least the surface layer of which is formed of a foam material.

26. The image forming method according to claim 20, wherein the charging step is a step of charging electrostatically the image-bearing member by means of applying a voltage to a roller member having an Asker-C hardness of 25 to 50.

27. The image forming method according to claim 20, wherein the charging step is a step of charging electrostatically the image-bearing member by means of applying a voltage to a roller member having a volume-resistivity of 10³ to 10⁸ Ω·cm.

28. The image forming method according to claim 20, wherein the charging step is a step of charging electrostatically the image-bearing member by means of applying a voltage to a brush member having conductivity.

29. The image forming method according to claim 20, wherein the image-bearing member comprises an outermost layer whose volume resistivity is 1×10⁹ to 1×10¹⁴ Ω·cm.

30. The image forming method according to claim 20, wherein the image-bearing member has an outermost layer that is formed of a resin layer, the outermost layer having at least a metal oxide conductive fine particles dispersed therein.

31. The image forming method according to claim 20, wherein the surface of the image-bearing member has a contact angle to water of at least 85 degrees.

32. The image forming method according to claim 20, wherein the image-bearing member has an outermost layer, the outermost layer having at least lubricant fine particles that are formed of one or more materials selected from fluorine resins, silicone resins and polyolefin resins.

33. The image forming method according to claim 20, wherein the developing step is a step of developing an electrostatic latent image by means of causing the developer to move from a developer-carrying member that carries the developer to the image-bearing member, the developer-carrying member being opposed to the image-bearing member and being apart from the image-bearing member at a gap length of 100 to 1000 μm.

34. The image forming method according to claim 20, wherein the developing step is a step of developing an electrostatic latent image by means of making a developer-carrying member carry the developer at a density of 5 to 30 g/m² on the surface thereof to form a developer layer and causing the developer to move from a developer-carrying member that carries the developer to the image-bearing member.

35. The image forming method according to claim 20, wherein the developing step is a step of developing an electrostatic latent image by means of forming a developer layer on a developer-carrying member that carries the developer, and causing the developer to move electrically from the developer layer to the surface of the image-bearing member, the developer-carrying member being opposed to the image-bearing member and being apart from the image-bearing member at a predetermined gap length, the developer layer being formed of the developer and having a thickness smaller than the gap length.

36. The image forming method according to claim 20, wherein the developing step is a step of forming an alternating electric field by means of applying a development bias between a developer-carrying member that carries the developer and the image-bearing member to develop an electrostatic latent image of the image-bearing member with the developer, the alternating electric field having at least peak-to-peak electric field intensity of 3×10⁶ to 10×10⁶ V/m and a frequency of 100 to 5000 Hz.

37. The image forming method according to claim 20, wherein the transferring step is a step of re-transferring the toner image that is formed in the developing step to the transfer material after the transfer to an intermediate transfer member.

38. The image forming method according to claim 20, wherein the transferring step is a step of transferring the toner image that is formed in the developing step to the transfer material by means of a transfer member that abuts the image-bearing member through the transfer material.

39. The image forming method according to claim 20, wherein the developer is a developer as claimed in any one of claims 2 to 19.

40. An image forming method comprising a repeated cycle of the following steps to form an image:
a charging step for charging electrostatically an image-bearing member;
a latent image forming step for writing image information as an electrostatic latent image on a charged surface of the image-bearing member that is charged in the charging step;
a developing step for visualizing the electrostatic latent image as a toner image with a developer; and
a transferring step for transferring the toner image to a transfer material, the developer comprising at least:
(i) toner particles containing at least a binder resin and a colorant;
(ii) an inorganic fine powder whose primary particles have a number-average particle diameter of from 4 nm to 50 nm; and
(iii) a conductive fine powder whose primary particles have a number-average particle diameter of from 50 nm to 500 nm, the conductive fine powder containing an agglomerated matter of the primary particles,
the developer comprising 15% to 60% by number of particles having particle diameters in the range of from 1.00 μm, inclusive, to 2.00 μm, exclusive, and comprising 15% to 70% by number of particles having the particle diameter range of from 3.00 μm, inclusive, to 8.96 μm, exclusive, in number-based particle size distribution of particles having particle diameters in the range of from 0.60 μm, inclusive, to 159.21 μm, exclusive,
wherein the developing step is a step of visualizing the electrostatic latent image and collecting the developer that remains on the image-bearing member after the transfer of the toner image to the transfer material.

41. The image forming method according to claim 40, wherein the developer is a developer as claimed in any one of claims 2 to 19.

42. A process cartridge comprising at least:
an image-bearing member for bearing an electrostatic latent image;
charging means for charging electrostatically the image-bearing member; and
developing means for developing the electrostatic latent image formed on the image-bearing member with a developer to form a toner image, wherein
the process cartridge is adapted to be loaded into and unloaded from an image forming apparatus, the image forming apparatus is for visualizing the electrostatic latent image formed on the image-bearing member with a developer and transferring the visualized toner image to a transfer material to form an image,
the developer comprising at least:
(i) toner particles containing at least a binder resin and a colorant;
(ii) an inorganic fine powder whose primary particles have a number-average particle diameter of from 4 nm to 50 nm; and
(iii) a conductive fine powder whose primary particles have a number-average particle diameter of from 50 nm to 500 nm, the conductive fine powder containing an agglomerated matter of the primary particles,
the developer comprising 15% to 60% by number of particles having particle diameters in the range of from 1.00 μm, inclusive, to 2.00 μm, exclusive, and comprising 15% to 70% by number of particles having particle diameters in the range of from 3.00 μm, inclusive, to 8.96 μm, exclusive, in number-based particle size distribution over the particle diameter range of from 0.60 μm, inclusive, to 159.21 μm, exclusive, and
wherein the charging means is means for charging electrostatically the image-bearing member by means of applying a voltage to a charging member in the presence of a component of the developer that remains on the image-bearing member after the deposition on the image-bearing member by the developing means and the transfer by the transferring means and that contains at least the conductive fine powder at a position where the image-bearing member abuts the charging member that is in contact with the image-bearing member.

43. The process cartridge according to claim 42, wherein the charging member is a roller member at least the surface layer of which is formed of a foam material.

44. The process cartridge according to claim 42, wherein the charging member is a roller member having an Asker-C hardness of 25 to 50.

45. The process cartridge according to claim 42, wherein the charging member is a roller member having a volume-resistivity of 10³ to 10⁸ Ω·cm.

46. The process cartridge according to claim 42, wherein the image-bearing member comprises an outermost layer whose volume resistivity is 1×10⁹ to 1×10¹⁴ Ω·cm.

47. The process cartridge according to claim 42, wherein the image-bearing member has an outermost layer that is formed of a resin layer, the outermost layer having at least a metal oxide conductive fine particles dispersed therein.

48. The process cartridge according to claim 42, wherein the surface of the image-bearing member has a contact angle to water of at least 85 degrees.

49. The process cartridge according to claim 42, wherein the image-bearing member has an outermost layer, the outermost layer having at least lubricant fine particles that are formed of one or more materials selected from fluorine resins, silicone resins and polyolefin resins.

50. The process cartridge according to claim 42, wherein the developer is a developer as claimed in any one of claims 2 to 19.

51. A process cartridge comprising at least:
an image-bearing member for bearing an electrostatic latent image; and
developing means for developing the electrostatic latent image formed on the image-bearing member with a developer to form a toner image, wherein
the process cartridge is adapted to be loaded into and unloaded from an image forming apparatus, the image forming apparatus is for visualizing the electrostatic latent image formed on the image-bearing member with a developer and transferring the visualized toner image to a transfer material to form an image,
the developer comprising at least:
(i) toner particles containing at least a binder resin and a colorant;
(ii) an inorganic fine powder whose primary particles have a number-average particle diameter of from 4 nm to 50 nm;
(iii) a conductive fine powder whose primary particles have a number-average particle diameter of from 50 nm to 500 nm, the conductive fine powder containing an agglomerated matter of the primary particles,
the developer comprising 15% to 60% by number of particles having particle diameters in the range of from 1.00 μm, inclusive, to 2.00 μm, exclusive, and comprising 15% to 70% by number of particles having particle diameters in the range of from 3.00 μm, inclusive, to 8.96 μm, exclusive, in number-based particle size distribution of particles having particle diameters in the range of from 0.60 μm, inclusive, to 159.21 μm, exclusive, and
wherein the developing means is means for forming the toner image and for collecting the developer that remains on the image-bearing member after the toner image is transferred to the transfer material.

52. The process cartridge according to claim 51 wherein the developer is a developer as claimed in any one of claims 2 to 19.
